(19) United States
(12) Patent Application Publication
(10) Pub. No.: US 2011/0267705 A1
(43) Pub. Date: Nov. 3, 2011

(54) Image forming optical system and electronic image pickup apparatus equipped with same

(76) Inventors: Shinichi Mihara, Tokyo (JP); Kanato Adachi, Kawasaki-shi (JP)

(21) Appl. No.: 12/928,910

(22) Filed: Dec. 21, 2010

Related U.S. Application Data
(63) Continuation of application No. PCT/JP2009/055755, filed on Mar. 24, 2009.

(30) Foreign Application Priority Data
Jun. 24, 2008 (JP) 2008-164859
Jul. 22, 2008 (JP) 2008-188347

(51) Int. Cl. G02B 15/14; G02B 9/10

(52) U.S. Cl. 359/683; 359/793

(57) ABSTRACT

An image forming optical system has a positive lens group disposed closer to its object side than an aperture stop, and the values of θgF1 and other constants of at least one lens LA included in the positive lens group fall within three ranges including a range bounded by the straight lines given by the equation θgF1=α1×νd1+βgF1 (where α1=−0.00566) into which the lowest and highest values in the range given by a first conditional expression are substituted respectively, a range bounded by the straight lines given by the equation nd1=a1×νd1+b1 (where a1=−0.0267) into which the lowest and highest values in the range given by a second conditional expression are substituted respectively, and a range defined by a third conditional expression.

### CROSS-REFERENCE TO RELATED APPLICATION

This application is a continuation of PCT International Application No. PCT/JP2009/055755 filed on Mar. 24, 2009, which designates the United States. A claim of priority and benefit of the filing date under 35 U.S.C. §120 is hereby made to PCT International Application No. PCT/JP2009/055755 filed on Mar. 24, 2009, which in turn claims priority under 35 U.S.C. §119 to Japanese Application Nos. 2008-164859 filed on Jun. 24, 2008 and 2008-188347 filed on Jul. 22, 2008, each of which are expressly incorporated herein in its entirety by reference thereto.

### BACKGROUND OF THE INVENTION

1. Field of the Invention

The present invention relates to an image forming optical system (which is a zoom optical system) for use in an image pickup module and an electronic image pickup apparatus equipped with the image forming optical system.

2. Description of the Related Art

In recent years, digital cameras have become popular as next generation cameras replacing 35 mm film cameras. Firstly, compact type digital cameras had become popular, and recently the compact type digital cameras have been made increasingly smaller and slimmer. Cellular phones, which have also become popular, are equipped with a camera function. (In the following, the camera function will be referred to as an “image pickup module”). On the other hand, single lens reflex type digital cameras with interchangeable lenses have rapidly become popular in the market. In the case of this type of digital cameras also, good image quality and reduction in weight are required at the same time. A new technology that enables to achieve good image quality and reduction in size and weight at the same time at a higher level is demanded for both types of cameras.

Zoom lenses have been used in compact type digital cameras and optical systems for image pickup modules of cellular phones. Typical methods of reducing the size and depth of such zoom lenses include the following methods A and B.

A: Using a collapsible lens barrel to house the optical system in the camera body along the thickness (or depth) direction. The collapsible lens barrel has a structure that is adapted to extend the optical system out of the camera body when in use for shooting, and to house the optical system in the camera body when the camera is carried.

B: Using a folded optical system to house the optical system in the camera body along the width or height direction. The folded optical system has a structure in which the optical path (or optical axis) of the optical system is bent by a reflecting optical element such as a mirror or a prism.

A prior art adopting the above method A is described, for example, in Patent Document 1 specified below. A prior art adopting the above method B is described, for example, in Patent Document 2 specified below.

To achieve a reduction in the size, depth and weight of optical systems including interchangeable lenses for single lens reflex cameras, correction of chromatic aberration is an important issue. Transparent media having effective dispersion characteristics or partial dispersion characteristics that conventional glasses do not have are known from Patent Documents 3 and 4 specified below.

Furthermore, in electronic image pickup apparatus using an electronic image pickup element, flare tends to be caused by chromatic aberration at the h-line (404.66 nm). In connection with this, there is known Patent Document 6 specified below, which describes the importance of correction of chromatic aberration with respect to the h-line.

There are no optical media having desired partial dispersion characteristics that enables correction of chromatic aberration in the wavelength range near 400 nm. In connection with this, there is known Patent Document 7 specified below, which teaches to pick up an image with an intentionally decreased transmittance at 400 nm and adjusting color reproduction after picking up the image using an image processing function of the image pickup apparatus.

Furthermore, there are known Patent Documents 8 and 9, which teach to use image processing to correct color flare that cannot be corrected by the optical system because of unsatisfactory partial dispersion characteristics of optical materials particularly in the shorter wave length range.
Patent Document 1: Japanese Patent Application Laid-Open No. 2002-365545
Patent Document 2: Japanese Patent Application Laid-Open No. 2003-43354
Patent Document 3: Japanese Patent Application Laid-Open No. 2005-181392
Patent Document 4: Japanese Patent Application Laid-Open No. 2005-352265
Patent Document 5: Japanese Patent Application Laid-Open No. 2006-003544
Patent Document 6: Japanese Patent Application Laid-Open No. 2001-208964
Patent Document 7: Japanese Patent Application Laid-Open No. 2001-021805
Patent Document 8: Japanese Patent Application Laid-Open No. 2001-145117
Patent Document 9: Japanese Patent Application Laid-Open No. 2001-268583

### SUMMARY OF THE INVENTION

### Problem to be Solved by the Invention

In the design using the above-described method A described in Patent Document 1, the number of lenses or the number of moving lens groups that constitute the optical system is still large. Therefore, it is difficult to make the camera body small and slim.

In the design using the above-described method B described in Patent Document 2, slimming of the camera body can be achieved more easily than in the design using the method A. However, the amount of movement of movable lens groups during zooming and the number of lenses that constitute the optical system tend to be large. Therefore, this design is not advantageous for size reduction in terms of the volume.

Optical media described in Patent Documents 3 and 4 have dispersion characteristics that are very different from those of normal optical glasses. In cases where such optical media are used, particularly in cases where they are used in a zoom lens in which the number of lenses in each lens group is small or in a fixed focal length lens composed of a small total number of lenses, chromatic aberration will increase. Therefore, this design consequently leads to an increase in the number of lenses. This does not contribute to size reduction.

Patent Document 5 discloses optical media that are peculiar in the relative partial dispersion in lower dispersion and high dispersion.

Patent Documents 6, 7, 8, and 9 do not describe specific effective means for eliminating color flare in optical systems.

The present invention has been made in view of the above-described prior problems, and its object is to provide an image forming optical system in which size reduction, slimming and good aberration correction, particularly correction of chromatic aberration, are achieved. Another object is to sharpen images and to prevent the occurrence of color blur in an electronic image pickup apparatus.

### Means for Solving the Problem

To achieve the above object, an image forming optical system according to a first aspect of the present invention comprises:

a positive lens group;

a negative lens group; and

an aperture stop, wherein

the positive lens group is disposed closer to the object side than the aperture stop, and

the value of θgF1, the value of nd1, and the value of νd1 of at least one lens LA included in the positive lens group fall within the following three ranges: the range in an orthogonal coordinate system having a horizontal axis representing νd1 and a vertical axis representing θgF1 that is bounded by the straight line given by the equation θgF1=α1×νd1+βgF1 (where α1=−0.00566) into which the lowest value in the range defined by the following conditional expression (1-1) is substituted and the straight line given by the equation θgF1=α1×νd1+βgF1 (where α1=−0.00566) into which the highest value in the range defined by the following conditional expression (1-1) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (1-2) is substituted and the straight line given by the equation nd1=a1×νd1+b1 (where a1=−0.0267) into which the highest value in the range defined by the following conditional expression (1-2) is substituted; and the range defined by the following conditional expression (1-3):

0.6520<βgF1<0.7620 (1-1),

2.0<b1<2.4 (where nd1>1.3) (1-2),

10<νd1<35 (1-3),

where θgF1 is the relative partial dispersion (ng1−nF1)/(nF1−nC1) of the lens LA, and νd1 is the Abbe constant (nd1−1)/(nF1−nC1) of the lens LA, where nd1, nC1, nF1, and ng1 are refractive indices of the lens LA for the d-line, C-line, F-line, and g-line respectively.

According to a preferable mode of the present invention, it is preferred that the value of θhg1, the value of nd1, and the value of νd1 of the lens LA fall within the following three ranges: the range in an orthogonal coordinate system, which is different from the aforementioned orthogonal coordinate system, having a horizontal axis representing νd1 and a vertical axis representing θhg1 that is bounded by the straight line given by the equation θhg1=αhg1×νd1+βhg1 (where αhg1=−0.00834) into which the lowest value in the range defined by the following conditional expression (1-4) is substituted and the straight line given by the equation θhg1=αhg1×νd1+βhg1 (where αhg1=−0.00834) into which the highest value in the range defined by the following conditional expression (1-4) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (1-2) is substituted and the straight line given by the equation nd1=a1×νd1+b1 (where a1=−0.0267) into which the highest value in the range defined by the following conditional expression (1-2) is substituted; and the range defined by the following conditional expression (1-3):

0.6000<βhg1<0.7800 (1-4),

2.0<b1<2.4 (where nd1>1.3) (1-2),

10<νd1<35 (1-3),

where θhg1 is the relative partial dispersion (nh1−ng1)/(nF1−nC1) of the lens LA, and nh1 is the refractive index of the lens LA for the h-line.

According to a preferable mode of the present invention, it is preferred that the lens LA be a lens that makes up a cemented lens.

According to a preferable mode of the present invention, it is preferred that a cemented side surface (cemented surface) of the lens LA be an aspheric surface.

According to a preferable mode of the present invention, it is preferred that when a negative lens is defined to be a lens having a negative paraxial focal length, the lens LA be a negative lens.

According to a preferable mode of the present invention, it is preferred that when a positive lens is defined to be a lens having a positive paraxial focal length, a lens LB to which the lens LA is cemented be a positive lens and that the following condition be satisfied:

νd1−νd2≦−10 (1-5),

where νd1 is the Abbe constant (nd1−1)/(nF1−nC1) of the lens LA, and νd2 is the Abbe constant (nd2−1)/(nF2−nC2) of the lens LB.

According to a preferable mode of the present invention, it is preferred that when a positive lens is defined to be a lens having a positive paraxial focal length, a lens LB to which the lens LA is cemented be a positive lens and that the following condition be satisfied:

|θgF1−θgF2|≦0.150 (1-6),

where θgF1 is the relative partial dispersion (ng1−nF1)/(nF1−nC1) of the lens LA, and θgF2 is the relative partial dispersion (ng2−nF2)/(nF2−nC2) of the lens LB.

According to a preferable mode of the present invention, it is preferred that when a positive lens is defined to be a lens having a positive paraxial focal length, a lens LB to which the lens LA is cemented be a positive lens and that the following condition be satisfied:

|θhg1−θhg2|≦0.200 (1-7),

where θhg1 is the relative partial dispersion (nh1−ng1)/(nF1−nC1) of the lens LA, and θhg2 is the relative partial dispersion (nh2−ng2)/(nF2−nC2) of the lens LB.

In cases where the cemented lens is made up of three or more lenses, the lens LA should be the lens having the smallest value of βgF1 among the negative lenses, and the lens LB should be the lens having the largest value of βgF2 among the positive lenses.

It is preferred that the image forming optical system be a zoom lens consisting of four or five lens groups in total and that relative distances of the lens groups on the optical axis change during zooming.

According to a preferable mode of the present invention, it is preferred that the negative lens group be disposed closer to the object side than the aperture stop and that the value of θgF3, the value of nd3, and the value of νd3 of at least one lens LC included in the negative lens group fall within the following three ranges: the range in an orthogonal coordinate system having a horizontal axis representing νd3 and a vertical axis representing θgF3 that is bounded by the straight line given by the equation θgF3=α3×νd3+βgF3 (where α3=−0.00566) into which the lowest value in the range defined by the following conditional expression (1-8) is substituted and the straight line given by the equation θgF3=α3×νd3+βgF3 (where ∘3=−0.00566) into which the highest value in the range defined by the following conditional expression (1-8) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (1-9) is substituted and the straight line given by the equation nd3=a3×νd3+b3 (where a3=−0.0267) into which the highest value in the range defined by the following conditional expression (1-9) is substituted; and the range defined by the following conditional expression (1-10):

0.6520<βgF3<0.7620 (1-8),

2.0<b3<2.4 (where nd3>1.3) (1-9),

10<νd3<35 (1-10),

where θgF3 is the relative partial dispersion (ng3−nF3)/(nF3−nC3) of the lens LC, and νd3 is the Abbe constant (nd3−1)/(nF3−nC3) of the lens LC, where nd3, nC3, nF3, and ng3 are refractive indices of the lens LC for the d-line, C-line, F-line, and g-line respectively.

According to a preferable mode of the present invention, in the image forming optical system according to this mode, it is preferred that the value of θhg3, the value of nd3, and the value of νd3 of the lens LC fall within the following three ranges: the range in an orthogonal coordinate system, different from the aforementioned orthogonal coordinate system, having a horizontal axis representing νd3 and a vertical axis representing 74 hg3 that is bounded by the straight line given by the equation 74 hg3=αhg3×νd3+βhg3 (where αhg3=−0.00834) into which the lowest value in the range defined by the following conditional expression (1-11) is substituted and the straight line given by the equation 74 hg3=αhg3×νd3+βhg3 (where αhg3=−0.00834) into which the highest value in the range defined by the following conditional expression (1-11) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (1-9) is substituted and the straight line given by the equation nd3=a3×νd3+b3 (where a3=−0.0267) into which the highest value in the range defined by the following conditional expression (1-9) is substituted; and the range defined by the following conditional expression (1-10):

0.6000<βhg3<0.7800 (1-11),

2.0<b3<2.4 (where nd3>1.3) (1-9),

10<νd3<35 (1-10),

where θhg3 is the relative partial dispersion (nh3−ng3)/(nF3−nC3) of the lens LC, and nh3 is the refractive index of the lens LC for the h-line.

According to a preferable mode of the present invention, it is preferred that the lens LC be a lens that makes up a cemented lens.

According to a preferable mode of the present invention, it is preferred that a cemented side surface (cemented surface) of the lens LC be an aspheric surface.

According to a preferable mode of the present invention, it is preferred that when a positive lens is defined to be a lens having a positive paraxial focal length, the lens LC be a positive lens.

According to a preferable mode of the present invention, it is preferred that when a negative lens is defined to be a lens having a negative paraxial focal length, a lens LD to which the lens LC is cemented be a negative lens and that the following condition be satisfied:

νd3−νd4≦−15 (1-12),

where νd3 is the Abbe constant (nd3−1)/(nF3−nC3) of the lens LC, and νd4 is the Abbe constant (nd4−1)/(nF4−nC4) of the lens LD.

According to a preferable mode of the present invention, it is preferred that when a negative lens is defined to be a lens having a negative paraxial focal length, it is preferred that the lens LD to which the lens LC is cemented be a negative lens and that the following conditional expression (1-13) be satisfied:

|θgF3−θgF4|≦0.10 (1-13),

where θgF3 is the relative partial dispersion (ng3−nF3)/(nF3−nC3) of the lens LC, and θgF4 is the relative partial dispersion (ng4−nF4)/(nF4−nC4) of the lens LD.

According to a preferable mode of the present invention, it is preferred that when a negative lens is defined to be a lens having a negative paraxial focal length, a lens LD to which the lens LC is cemented be a negative lens and that the following condition be satisfied:

|θhg3−θhg4|≦0.20 (1-14),

where θhg3 is the relative partial dispersion (nh3−ng3)/(nF3−nC3) of the lens LC, and θhg4 is the relative partial dispersion (nh4−ng4)/(nF4−nC4) of the lens LD.

In cases where the cemented lens is made up of three or more lenses, the lens LC should be the lens having the smallest value of βgF3 among the positive lenses, and the lens LD should be the lens having the largest value of βgF3 among the negative lenses.

To reduce the depth of the image forming optical system (particularly in cases where the optical system is a zoom lens), it is preferred that the optical system have a prism for bending the optical path. In particular, it is preferred that the prism be provided in the first positive lens group closest to the object side.

To achieve the above object, an image forming optical system according to a second aspect of the present invention comprises:

a positive lens group;

a negative lens group; and

an aperture stop, wherein

the positive lens group is disposed closer to the object side than the aperture stop, and

the value of θgF1, the value of nd1, and the value of νd1 of at least one lens LA included in the positive lens group fall within the following three ranges: the range in an orthogonal coordinate system having a horizontal axis representing νd1 and a vertical axis representing θgF1 that is bounded by the straight line given by the equation θgF1=α1×νd1+βgF1 (where α1=−0.00264) into which the lowest value in the range defined by the following conditional expression (2-1) is substituted and the straight line given by the equation θgF1=α1×νd1+βgF1 (where α1=−0.00264) into which the highest value in the range defined by the following conditional expression (2-1) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (2-2) is substituted and the straight line given by the equation nd1=a1×νd1+b1 (where a1=−0.0267) into which the highest value in the range defined by the following conditional expression (2-2) is substituted; and the range defined by the following conditional expression (2-3):

0.6050<βgF1<0.7150 (2-1),

2.0<b1<2.4 (where nd1>1.3) (2-2),

10<νd1<28 (2-3),

where θgF1 is the relative partial dispersion (ng1−nF1)/(nF1−nC1) of the lens LA, and νd1 is the Abbe constant (nd1−1)/(nF1−nC1) of the lens LA, where nd1, nC1, nF1, and ng1 are refractive indices of the lens LA for the d-line, C-line, F-line, and g-line respectively.

According to a preferable mode of the present invention, it is preferred that the value of θhg1, the value of nd1, and the value of νd1 of the lens LA fall within the following three ranges: the range in an orthogonal coordinate system, which is different from the aforementioned orthogonal coordinate system, having a horizontal axis representing νd1 and a vertical axis representing θhg1 that is bounded by the straight line given by the equation θhg1=αhg1×νd1+βhg1 (where αhg1=−0.00388) into which the lowest value in the range defined by the following conditional expression (2-4) is substituted and the straight line given by the equation θhg1=αhg1×νd1+βhg1 (where αhg1=−0.00388) into which the highest value in the range defined by the following conditional expression (2-4) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (2-2) is substituted and the straight line given by the equation nd1=a1×νd1+b1 (where a1=−0.0267) into which the highest value in the range defined by the following conditional expression (2-2) is substituted; and the range defined by the following conditional expression (2-3):

0.5000<βhg1<0.6750 (2-4),

2.0<b1<2.4 (where nd1>1.3) (2-2),

10<νd1<28 (2-3),

where θhg1 is the relative partial dispersion (nh1−ng1)/(nF1−nC1) of the lens LA, and nh1 is the refractive index of the lens LA for the h-line.

According to a preferable mode of the present invention, it is preferred that the lens LA be a lens that makes up a cemented lens.

According to a preferable mode of the present invention, it is preferred that a cemented side surface (cemented surface) of the lens LA be an aspheric surface.

According to a preferable mode of the present invention, it is preferred that when a negative lens is defined to be a lens having a negative paraxial focal length, the lens LA be a negative lens.

According to a preferable mode of the present invention, it is preferred that when a positive lens is defined to be a lens having a positive paraxial focal length, a lens LB to which the lens LA is cemented be a positive lens and that the following condition be satisfied:

νd1−νd2≦−10 (2-5),

where νd1 is the Abbe constant (nd1−1)/(nF1−nC1) of the lens LA, and νd2 is the Abbe constant (nd2−1)/(nF2−nC2) of the lens LB.

According to a preferable mode of the present invention, it is preferred that when a positive lens is defined to be a lens having a positive paraxial focal length, a lens LB to which the lens LA is cemented be a positive lens and that the following condition be satisfied:

|θgF1−θgF2|≦0.150 (2-6),

where θgF1 is the relative partial dispersion (ng1−nF1)/(nF1−nC1) of the lens LA, and θgF2 is the relative partial dispersion (ng2−nF2)/(nF2−nC2) of the lens LB.

According to a preferable mode of the present invention, it is preferred that when a positive lens is defined to be a lens having a positive paraxial focal length, a lens LB to which the lens LA is cemented be a positive lens and that the following condition be satisfied:

|θhg1−θhg2|≦0.200 (2-7),

where θhg1 is the relative partial dispersion (nh1−ng1)/(nF1−nC1) of the lens LA, and θhg2 is the relative partial dispersion (nh2−ng2)/(nF2−nC2) of the lens LB.

In cases where the cemented lens is made up of three or more lenses, the lens LA should be the lens having the smallest value of βgF1 among the negative lenses, and the lens LB should be the lens having the largest value of βgF2 among the positive lenses.

It is preferred that the image forming optical system be a zoom lens consisting of four or five lens groups in total and that relative distances of the lens groups on the optical axis change during zooming.

According to a preferable mode of the present invention, it is preferred that the negative lens group be disposed closer to the object side than the aperture stop and that the value of θgF3, the value of nd3, and the value of νd3 of at least one lens LC included in the negative lens group fall within the following three ranges: the range in an orthogonal coordinate system having a horizontal axis representing νd3 and a vertical axis representing θgF3 that is bounded by the straight line given by the equation θgF3=α3×νd3+βgF3 (where α3=−0.00264) into which the lowest value in the range defined by the following conditional expression (2-8) is substituted and the straight line given by the equation θgF3=α3×νd3+βgF3 (where α3=−0.00264) into which the highest value in the range defined by the following conditional expression (2-8) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (2-9) is substituted and the straight line given by the equation nd3=a3×νd3+b3 (where a3=−0.0267) into which the highest value in the range defined by the following conditional expression (2-9) is substituted; and the range defined by the following conditional expression (2-10):

0.6050<βgF3<0.7150 (2-8),

2.0<b3<2.4 (where nd3>1.3) (2-9),

10<νd3<28 (2-10),

where θgF3 is the relative partial dispersion (ng3−nF3)/(nF3−nC3) of the lens LC, and νd3 is the Abbe constant (nd3−1)/(nF3−nC3) of the lens LC, where nd3, nC3, nF3, and ng3 are refractive indices of the lens LC for the d-line, C-line, F-line, and g-line respectively.

According to a preferable mode of the present invention, in the image forming optical system according to this mode, it is preferred that the value of θhg3, the value of nd3, and the value of νd3 of the lens LC fall within the following three ranges: the range in an orthogonal coordinate system, different from the aforementioned orthogonal coordinate system, having a horizontal axis representing νd3 and a vertical axis representing θhg3 that is bounded by the straight line given by the equation θhg3=αhg3×νd3+βhg3 (where αhg3=−0.00388) into which the lowest value in the range defined by the following conditional expression (2-11) is substituted and the straight line given by the equation θhg3=αhg3×νd3+βhg3 (where αhg3=−0.00388) into which the highest value in the range defined by the following conditional expression (2-11) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (2-9) is substituted and the straight line given by the equation nd3=a3×νd3+b3 (where a3=−0.0267) into which the highest value in the range defined by the following conditional expression (2-9) is substituted; and the range defined by the following conditional expression (2-10):

0.5100<βhg3<0.6750 (2-11),

2.0<b3<2.4 (where nd3>1.3) (2-9),

10<νd3<35 (2-10),

where θhg3 is the relative partial dispersion (nh3−ng3)/(nF3−nC3) of the lens LC, and nh3 is the refractive index of the lens LC for the h-line.

According to a preferable mode of the present invention, it is preferred that the lens LA be a lens that makes up a cemented lens.

According to a preferable mode of the present invention, it is preferred that a cemented side surface (cemented surface) of the lens LC be an aspheric surface.

According to a preferable mode of the present invention, it is preferred that when a positive lens is defined to be a lens having a positive paraxial focal length, the lens LC be a positive lens.

According to a preferable mode of the present invention, it is preferred that when a negative lens is defined to be a lens having a negative paraxial focal length, a lens LD to which the lens LC is cemented be a negative lens and that the following condition be satisfied:

νd3−νd4≦−15 (2-12),

where νd3 is the Abbe constant (nd3−1)/(nF3−nC3) of the lens LC, and νd4 is the Abbe constant (nd4−1)/(nF4−nC4) of the lens LD.

According to a preferable mode of the present invention, it is preferred that when a negative lens is defined to be a lens having a negative paraxial focal length, the lens LD to which the lens LC is cemented be a negative lens and that the following conditional expression (2-13) be satisfied:

|θgF3−θgF4|≦0.10 (2-13),

where θgF3 is the relative partial dispersion (ng3−nF3)/(nF3−nC3) of the lens LC, and θgF4 is the relative partial dispersion (ng4−nF4)/(nF4−nC4) of the lens LD.

According to a preferable mode of the present invention, it is preferred that when a negative lens is defined to be a lens having a negative paraxial focal length, a lens LD to which the lens LC is cemented be a negative lens and that the following condition be satisfied:

|θhg3−θhg4|≦0.20 (2-14),

where θhg3 is the relative partial dispersion (nh3−ng3)/(nF3−nC3) of the lens LC, and θhg4 is the relative partial dispersion (nh4−ng4)/(nF4−nC4) of the lens LD.

In cases where the cemented lens is made up of three or more lenses, the lens LC should be the lens having the smallest value of βgF3 among the positive lenses, and the lens LD should be the lens having the largest value of βgF3 among the negative lenses.

To reduce the depth of the image forming optical system (particularly in cases where the optical system is a zoom lens), it is preferred that the optical system have a prism for bending the optical path. In particular, it is preferred that the prism be provided in the first positive lens group closest to the object side.

An image pickup apparatus according to the present invention comprises:

the image forming optical system described above;

an image pickup element; and

an image processing section that processes image data obtained by picking up an image formed through the image forming optical system by the electronic image pickup element and outputs image data in which the shape of the image is deformed, wherein

the image forming optical system is a zoom lens, and

the zoom lens satisfied the following conditional expression (3-1) in a state in which the zoom lens is focused on an object point at infinity:

0.7<y₀₇/(f_{W}·tan ω_{07w})<0.96 (3-1),

where y₀₇ is expressed by equation y₀₇=0.7y₁₀, y₁₀ being the distance from the center of an effective image pickup area (in which an image can be picked up) of the electronic image pickup element to the farthest point in the image pickup area (i.e. the maximum image height), ω_{07w} is the angle of the direction toward an object point corresponding to an image point formed at a position at distance y₀₇ from the center of the image pickup surface at the wide angle end with respect to the optical axis, and fw is the focal length of the entire image forming system at the wide angle end.

According to the present invention, there can be provided an image forming optical system in which size reduction, slimming, weight reduction, and good aberration correction, particularly correction of chromatic aberration, are achieved. Furthermore, by using such an image forming optical system in an electronic image pickup apparatus, it is possible to sharpen images and to prevent the occurrence of color blur.

### BRIEF DESCRIPTION OF THE DRAWINGS

FIGS. 1A, 1B, and 1C are cross sectional views taken along the optical axis showing the optical configuration of a zoom lens according to embodiment 1 of the present invention in the state in which the zoom lens is focused on an object point at infinity, respectively at the wide angle end, at an intermediate focal length, and at the telephoto end;

FIGS. 2A, 2B, 2C, 2D, 2E, 2F, 2G, 2H, 2I, 2J, 2K and 2L are diagrams showing spherical aberration, astigmatism, distortion, and chromatic aberration of magnification of the zoom lens according to embodiment 1 in the state in which the zoom lens is focused on an object point at infinity, where FIGS. 2A, 2B, 2C, 2D are for the wide angle end, FIGS. 2E, 2F, 2G, 2H are for the intermediate focal length, and FIGS. 2I, 2J, 2K, 2L are for the telephoto end;

FIGS. 3A, 3B, and 3C are cross sectional views taken along the optical axis showing the optical configuration of a zoom lens according to embodiment 2 of the present invention in the state in which the zoom lens is focused on an object point at infinity, respectively at the wide angle end, at an intermediate focal length, and at the telephoto end;

FIGS. 4A, 4B, 4C, 4D, 4E, 4F, 4G, 4H, 4I, 4J, 4K and 4L are diagrams showing spherical aberration, astigmatism, distortion, and chromatic aberration of magnification of the zoom lens according to embodiment 2 in the state in which the zoom lens is focused on an object point at infinity, where FIGS. 4A, 4B, 4C, 4D are for the wide angle end, FIGS. 4E, 4F, 4G, 4H are is for the intermediate focal length, and FIGS. 4I, 4J, 4K, 4L are for the telephoto end;

FIGS. 5A, 5B, and 5C are cross sectional views taken along the optical axis showing the optical configuration of a zoom lens according to embodiment 3 of the present invention in the state in which the zoom lens is focused on an object point at infinity, respectively at the wide angle end, at an intermediate focal length, and at the telephoto end;

FIGS. 6A, 6B, 6C, 6D, 6E, 6F, 6G, 6H, 6I, 6J, 6K and 6L are diagrams showing spherical aberration, astigmatism, distortion, and chromatic aberration of magnification of the zoom lens according to embodiment 3 in the state in which the zoom lens is focused on an object point at infinity, where FIGS. 6A, 6B, 6C, 6D are for the wide angle end, FIGS. 6E, 6F, 6G, 6H are for the intermediate focal length, and FIGS. 6I, 6J, 6K, 6L are for the telephoto end;

FIGS. 7A, 7B, and 7C are cross sectional views taken along the optical axis showing the optical configuration of a zoom lens according to embodiment 4 of the present invention in the state in which the zoom lens is focused on an object point at infinity, respectively at the wide angle end, at an intermediate focal length, and at the telephoto end;

FIGS. 8A, 8B, 8C, 8D, 8E, 8F, 8G, 8H, 8I, 8J, 8K and 8L are diagrams showing spherical aberration, astigmatism, distortion, and chromatic aberration of magnification of the zoom lens according to embodiment 4 in the state in which the zoom lens is focused on an object point at infinity, where FIGS. 8A, 8B, 8C, 8D are for the wide angle end, FIGS. 8E, 8F, 8G, 8H are for the intermediate focal length, and FIGS. 8I, 8J, 8K, 8L are for the telephoto end;

FIGS. 9A, 9B, and 9C are cross sectional views taken along the optical axis showing the optical configuration of a zoom lens according to embodiment 5 of the present invention in the state in which the zoom lens is focused on an object point at infinity, respectively at the wide angle end, at an intermediate focal length, and at the telephoto end;

FIGS. 10A, 10B, 10C, 10D, 10E, 10F, 10G, 10H, 10I, 10J, 10K and 10L are diagrams showing spherical aberration, astigmatism, distortion, and chromatic aberration of magnification of the zoom lens according to embodiment 5 in the state in which the zoom lens is focused on an object point at infinity, where FIGS. 10A, 10B, 10C, 10D are for the wide angle end, FIGS. 10E, 10F, 10G, 10H are for the intermediate focal length, and FIGS. 10I, 10J, 10K, 10L are for the telephoto end;

FIGS. 11A, 11B, and 11C are cross sectional views taken along the optical axis showing the optical configuration of a zoom lens according to embodiment 6 of the present invention in the state in which the zoom lens is focused on an object point at infinity, respectively at the wide angle end, at an intermediate focal length, and at the telephoto end;

FIGS. 12A, 12B, 12C, 12D, 12E, 12F, 12G, 12H, 12I, 12J, 12K and 12L are diagrams showing spherical aberration, astigmatism, distortion, and chromatic aberration of magnification of the zoom lens according to embodiment 6 in the state in which the zoom lens is focused on an object point at infinity, where FIGS. 12A, 12B, 12C, 12D are for the wide angle end, FIGS. 12E, 12F, 12G, 12H are for the intermediate focal length, and FIGS. 12I, 12J, 12K, 12L are for the telephoto end;

FIGS. 13A, 13B, and 13C are cross sectional views taken along the optical axis showing the optical configuration of a zoom lens according to embodiment 7 of the present invention in the state in which the zoom lens is focused on an object point at infinity, respectively at the wide angle end, at an intermediate focal length, and at the telephoto end;

FIGS. 14A, 14B, 14C, 14D, 14E, 14F, 14G, 14H, 14I, 14J, 14K and 14L are diagrams showing spherical aberration, astigmatism, distortion, and chromatic aberration of magnification of the zoom lens according to embodiment 7 in the state in which the zoom lens is focused on an object point at infinity, where FIGS. 14A, 14B, 14C, 14D are for the wide angle end, FIGS. 14E, 14F, 14G, 14H are for the intermediate focal length, and FIGS. 14I, 14J, 14K, 14L are for the telephoto end;

FIG. 15 is a cross sectional view taken along the optical axis showing the optical configuration of a lens according to embodiment 8 of the present invention in the state in which the zoom lens is focused on an object point at infinity;

FIGS. 16A, 16B, 16C, 16D are diagrams showing spherical aberration, astigmatism, distortion, and chromatic aberration of magnification of the zoom lens according to embodiment 8 in the state in which the zoom lens is focused on an object point at infinity;

FIGS. 17A, 17B, and 17C are cross sectional views taken along the optical axis showing the optical configuration of a zoom lens according to embodiment 9 of the present invention in the state in which the zoom lens is focused on an object point at infinity, respectively at the wide angle end, at an intermediate focal length, and at the telephoto end;

FIGS. 18A, 18B, 18C, 18D, 18E, 18F, 18G, 18H, 18I, 18J, 18K and 18L are diagrams showing spherical aberration, astigmatism, distortion, and chromatic aberration of magnification of the zoom lens according to embodiment 9 in the state in which the zoom lens is focused on an object point at infinity, where FIGS. 18A, 18B, 18C, 18D are for the wide angle end, FIGS. 18E, 18F, 18G, 18H are for the intermediate focal length, and FIGS. 18I, 18J, 18K, 18L are for the telephoto end;

FIGS. 19A, 19B, and 19C are cross sectional views taken along the optical axis showing the optical configuration of a zoom lens according to embodiment 10 of the present invention in the state in which the zoom lens is focused on an object point at infinity, respectively at the wide angle end, at an intermediate focal length, and at the telephoto end;

FIGS. 20A, 20B, 20C, 20D, 20E, 20F, 20G, 20H, 20I, 20J, 20K and 20L are diagrams showing spherical aberration, astigmatism, distortion, and chromatic aberration of magnification of the zoom lens according to embodiment 10 in the state in which the zoom lens is focused on an object point at infinity, where FIGS. 20A, 20B, 20C, 20D are for the wide angle end, FIGS. 20E, 20F, 20G, 20H are for the intermediate focal length, and FIGS. 20I, 20J, 20K, 20L are for the telephoto end;

FIGS. 21A, 21B, and 121 are cross sectional views taken along the optical axis showing the optical configuration of a zoom lens according to embodiment 11 of the present invention in the state in which the zoom lens is focused on an object point at infinity, respectively at the wide angle end, at an intermediate focal length, and at the telephoto end;

FIGS. 22A, 22B, 22C, 22D, 22E, 22F, 22G, 22H, 22I, 22J, 22K and 22L are diagrams showing spherical aberration, astigmatism, distortion, and chromatic aberration of magnification of the zoom lens according to embodiment 11 in the state in which the zoom lens is focused on an object point at infinity, where FIGS. 22A, 22B, 22C, 22D are for the wide angle end, FIGS. 22E, 22F, 22G, 22H are the intermediate focal length, and FIGS. 22I, 22J, 22K, 22L are for the telephoto end;

FIGS. 23A, 23B, and 23C are cross sectional views taken along the optical axis showing the optical configuration of a zoom lens according to embodiment 12 of the present invention in the state in which the zoom lens is focused on an object point at infinity, respectively at the wide angle end, at an intermediate focal length, and at the telephoto end;

FIGS. 24A, 24B, 24C, 24D, 24E, 24F, 24G, 24H, 24I, 24J, 24K and 24L are diagrams showing spherical aberration, astigmatism, distortion, and chromatic aberration of magnification of the zoom lens according to embodiment 12 in the state in which the zoom lens is focused on an object point at infinity, where FIGS. 24A, 24B, 24C, 24D are for the wide angle end, FIGS. 24E, 24F, 24G, 24H are for the intermediate focal length, and FIGS. 24I, 24J, 24K, 24L are for the telephoto end;

FIGS. 25A, 25B, and 25C are cross sectional views taken along the optical axis showing the optical configuration of a zoom lens according to embodiment 13 of the present invention in the state in which the zoom lens is focused on an object point at infinity, respectively at the wide angle end, at an intermediate focal length, and at the telephoto end;

FIGS. 26A, 26B, 26C, 26D, 26E, 26F, 26G, 26H, 26I, 26J, 26K and 26L are diagrams showing spherical aberration, astigmatism, distortion, and chromatic aberration of magnification of the zoom lens according to embodiment 13 in the state in which the zoom lens is focused on an object point at infinity, where FIGS. 26A, 26B, 26C, 2D are for the wide angle end, FIGS. 26E, 26F, 26G, 26H are for the intermediate focal length, and FIGS. 26I, 26J, 26K, 26L are for the telephoto end;

FIG. 27 is a front perspective view showing an outer appearance of a digital camera 40 equipped with a zoom optical system according to the present invention;

FIG. 28 is a rear perspective view of the digital camera 40;

FIG. 29 is a cross sectional view showing the optical construction of the digital camera 40;

FIG. 30 is a front perspective view showing a personal computer 300 as an example of an information processing apparatus in which a zoom optical system according to the present invention is provided as an objective optical system, in a state in which the cover is open;

FIG. 31 is a cross sectional view of a taking optical system 303 of the personal computer 300;

FIG. 32 is a side view of the personal computer 300; and

FIGS. 33A, 33B, and 33C show a cellular phone 400 as an example of an information processing apparatus in which a zoom optical system according to the present invention is provided as a taking optical system, where FIG. 33A is a front view of the cellular phone 400, FIG. 33B is a side view of the cellular phone 400, and FIG. 33C is a cross sectional view of the taking optical system 405.

### DESCRIPTION OF SYMBOLS

G1: first lens group
G2: second lens group
G3: third lens group
G4: fourth lens group
G5: fifth lens group
L1-L18: lens
LPF: low pass filter
CG: cover glass
I: image pickup surface
E: viewer's eye
40: digital camera
41: taking optical system
42: taking optical path
43: finder optical system
44: optical path for finder
45: shutter
46: flash
47: liquid crystal display monitor
48: zoom lens
49: CCD
50: image pickup surface
51: processing unit
53: objective optical system for finder
55: Porro prism
57: field frame
59: eyepiece optical system
66: focusing lens
67: image plane
100: objective optical system
102: cover glass
162: electronic image pickup element chip
166: terminal
300: personal computer
301: keyboard
302: monitor
303: taking optical system
304: taking optical path
305: image
400: cellular phone
401: microphone portion
402: speaker portion
403: input dial
404: monitor
405: taking optical system
406: antenna
407: taking optical path

### BEST MODE FOR CARRYING OUT THE INVENTION

Prior to the description of embodiments, operations and effects of an image forming optical system according to one mode will be described.

An image forming optical system according to this mode has a positive lens group, a negative lens group and a stop, and a lens made of a material having peculiar partial dispersion characteristics is used in the positive lens group disposed closer to the object side than the stop, or the lens made of a material having peculiar partial dispersion characteristics is cemented to another lens. With this design, variations of axial chromatic aberration and chromatic aberration of magnification during zooming can easily be made small over a wide wavelength range particularly in the case of a zoom lens or a telephoto lens.

Furthermore, even if the optical system is composed of a small number of lenses and has a slim lens configuration, color blur can be satisfactorily prevented from occurring throughout the entire zoom range and focusing range.

The positive lens group disposed closer to the object side than the stop tends to have a large thickness. Nonetheless, the positive lens group disposed closer to the object side than the stop in the image forming optical system according to this mode can be made thin. Therefore, the distance from the vertex of the surface closest to the object side to the entrance pupil can be made short. In addition, the lens group disposed closer to the object side than the stop can be made thin by a synergetic effect.

In the image forming optical system according to this mode, the value of θgF1, the value of nd1, and the value of νd1 of at least one lens LA included in the positive lens group fall within the following three ranges: the range in an orthogonal coordinate system having a horizontal axis representing νd1 and a vertical axis representing θgF1 that is bounded by the straight line given by the equation θgF1=α1×νd1+βgF1 (where α1=−0.00566) into which the lowest value of θgF1 in the range defined by the following conditional expression (1-1) is substituted and the straight line given by the equation θgF1=α1×νd1+βgF1 (where α1=−0.00566) into which the highest value of θgF1 in the range defined by the following conditional expression (1-1) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value of θgF1 in the range defined by the following conditional expression (1-2) is substituted and the straight line given by the equation nd1=a1×νd1+b1 (where a1=−0.0267) into which the highest value of θgF1 in the range defined by the following conditional expression (1-2) is substituted; and the range defined by the following conditional expression (1-3):

0.6520<βgF1<0.7620 (1-1),

2.0<b1<2.4 (where nd1>1.3) (1-2),

10<νd1<35 (1-3),

where θgF1 is the relative partial dispersion (ng1−nF1)/(nF1−nC1) of the lens LA, and νd1 is the Abbe constant (nd1−1)/(nF1−nC1) of the lens LA, where nd1, nC1, nF1, and ng1 are refractive indices of the lens LA for the d-line, C-line, F-line, and g-line respectively.

Conditional expression (1-1) concerns the relative partial dispersion θgF1 of the lens material of the lens LA. If a lens material that falls out of the range is used for the lens LA, correction of axial chromatic aberration and chromatic aberration of magnification by secondary spectrum, specifically, correction of axial chromatic aberration and chromatic aberration of magnification with respect to the g-line while achromatism is achieved with respect to the F-line and the C-line will be insufficient at telephoto focal lengths. Then, it will be difficult to achieve sharpness over the entire picture area in images picked up at telephoto focal lengths particularly. This is also the case with a fixed focal length lens.

Conditional expression (1-2) concerns the refractive index of the lens material of the lens LA. If a lens material having a refractive index exceeding the upper limit value of conditional expression (1-2) is used, the Petzval sum of the lens group including the lens LA will tend to be large. This will make it difficult to correct curvature of field of the overall image forming optical system. On the other hand, if a lens material having a refractive index exceeding the lower limit value of conditional expression (1-2) is used, spherical aberration of the lens group including the lens LA will tend to be large. This will make it difficult to correct spherical aberration of the overall image forming system.

Conditional expression (1-3) concerns the Abbe constant of the lens material of the lens LA. If a lens material having an Abbe constant exceeding the upper limit value of conditional expression (1-3) is used, achromatism with respect even to the F-line and the C-line will be difficult, undesirably. If a lens material having an Abbe constant exceeding the lower limit value of conditional expression (1-3) is used, the effect of correcting five Seidel aberrations will become smaller even if achromatism with respect to the F-line and the C-line can be achieved.

It is more preferred that the following conditional expression (1-1′) be satisfied instead of conditional expression (1-1):

0.6620<βgF1<0.7570 (1-1′).

It is still more preferred that the following conditional expression (1-1″) be satisfied instead of the above conditional expression (1-1):

0.6720<βgF1<0.7520 (1-1″).

It is most preferred that the following conditional expression (1-1″′) be satisfied instead of conditional expression (1-1):

0.6720<βgF1<0.7470 (1-1″′).

It is more preferred that the following conditional expression (1-2′) be satisfied instead of conditional expression (1-2):

2.06<b1<2.34 (where nd1>1.3) (1-2′).

It is still more preferred that the following conditional expression (1-2″) be satisfied instead of the above conditional expression (1-2):

2.11<b1<2.28 (where nd1>1.3) (1-2″).

It is more preferred that the following conditional expression (1-3′) be satisfied instead of conditional expression (1-3):

12.5<νd1<28 (1-3′).

It is still more preferred that the following conditional expression (1-3″) be satisfied instead of the above conditional expression (1-3):

14.8<νd1<25 (1-3″).

In the image forming optical system according to this mode, it is more preferred that the value of θhg1, the value of nd1, and the value of νd1 of the lens LA fall within the following three ranges: the range in an orthogonal coordinate system, which is different from the aforementioned orthogonal coordinate system, having a horizontal axis representing νd1 and a vertical axis representing θhg1 that is bounded by the straight line given by the equation θhg1=αhg1×νd1+βhg1 (where αhg1=−0.00834) into which the lowest value in the range defined by the following conditional expression (1-4) is substituted and the straight line given by the equation θhg1=αhg1×νd1+βhg1 (where αhg1=−0.00834) into which the highest value in the range defined by the following conditional expression (1-4) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (1-2) is substituted and the straight line given by the equation nd1=a1×νd1+b1 (where a1=−0.0267) into which the highest value in the range defined by the following conditional expression (1-2) is substituted; and the range defined by the following conditional expression (1-3):

0.6000<βhg1<0.7800 (1-4),

2.0<b1<2.4 (where nd1>1.3) (1-2),

10<νd1<35 (1-3),

where θhg1 is the relative partial dispersion (nh1−ng1)/(nF1−nC1) of the lens LA, and nh1 is the refractive index of the lens LA for the h-line.

Conditional expression (1-4) concerns the relative partial dispersion θhg1 of the lens material of the lens LA. If a lens material that falls out of the range is used for the lens LA, correction of axial chromatic aberration and chromatic aberration of magnification by secondary spectrum, specifically, correction of axial chromatic aberration and chromatic aberration of magnification with respect to the h-line while achromatism is achieved with respect to the F-line and the C-line will be insufficient at telephoto focal lengths. Therefore, purple color flare and color blur will tend to occur over the entire picture area in images picked up at telephoto focal lengths particularly.

It is more preferred that the following conditional expression (1-4′) be satisfied instead of conditional expression (1-4):

0.6200<βhg1<0.7700 (1-4′).

It is still more preferred that the following conditional expression (1-4″) be satisfied instead of the above conditional expression (1-4):

0.6380<βhg1<0.7600 (1-4″).

It is most preferred that the following conditional expression (1-4″′) be satisfied instead of conditional expression (1-4):

0.6380<βhg1<0.7534 (1-4″′).

It is preferred that the lens LA be used as a lens that makes up a cemented lens. If this is the case, the effect of correcting chromatic aberrations (specifically, chromatic aberration with respect to the C-line and the F-line, chromatic aberration caused by dispersion characteristics such as secondary spectrum, and high order aberration components of third and higher orders related to the aperture ratio and the image height, such as chromatic spherical aberration, color coma, and chromatic aberration of magnification) on the cementing interface (or cemented surface) will be enhanced. The correction effect will be conspicuous with respect particularly to chromatic aberration caused by dispersion characteristics when conditional expressions (1-1), (1-2), and (1-3) are satisfied.

It is preferred that the cemented surface of the lens LA be an aspheric surface. If this is the case, the effect of correcting high order chromatic aberration components of third and higher orders related to the aperture ratio and the image height will be conspicuously achieved.

It is preferred that the positive lens group disposed closer to the object side than the aperture stop in the image forming optical system be composed of a combination of a few positive lens elements having low dispersion and a few negative lens elements having high dispersion to correct first order chromatic aberration. Achromatism of the positive lens group with respect to the C-line and the F-line facilitates correction of first order chromatic aberration generated by the overall optical system. In the image forming optical system according to this mode, as the lens material of the lens LA satisfies conditional expression (1-3) concerning its Abbe constant, the lens LA is a negative lens. Here, the “positive lens” refers to a lens having a positive paraxial focal length, and the “negative lens” refers to a lens having a negative paraxial focal length.

It is preferred that a lens LB to which the lens LA is cemented be a positive lens and that the following conditional expression (1-5) be satisfied:

νd1−νd2≦−10 (1-5),

where νd1 is the Abbe constant (nd1−1)/(nF1−nC1) of the lens LA, and νd2 is the Abbe constant (nd2−1)/(nF2−nC2) of the lens LB.

In this case, since the lenses LA and LB that have refracting powers of opposite signs are used in combination, good correction of chromatic aberration can be achieved. In particular if conditional expression (1-5) is satisfied with this combination, achromatism of axial chromatic aberration and chromatic aberration of magnification with respect to the C-line and the F-line is facilitated.

It is more preferred that the following conditional expression (1-5′) be satisfied instead of conditional expression (1-5):

νd1−νd2≦−13 (1-5′).

It is most preferred that the following conditional expression (1-5″) be satisfied instead of conditional expression (1-5):

νd1−νd2≦−16 (1-5″).

High dispersion optical materials generally have higher relative partial dispersions θgF, θhg than low dispersion optical materials. In consequence, if axial chromatic aberration is corrected with respect to the C-line and the F-line, axial chromatic aberration with respect to the g-line and h-line will have a positive value. In other words, secondary spectrum will be generated. On the other hand, if chromatic aberration of magnification is corrected with respect to the C-line and the F-line, chromatic aberration of magnification with respect to the g-line and the h-line will have a negative value. Therefore, it is preferred that the difference in the relative partial dispersions θgF, θhg between the lens LA (high dispersion negative lens) and the lens LB (low dispersion positive lens) be made as small as possible so that achromatism with respect to the g-line and the h-light is accomplished. This consequently facilitates correction of chromatic aberration of the overall optical system.

Specifically, it is preferred that the lens LB to which the lens LA is cemented be a positive lens and that the following conditional expression (1-6) in terms of θgF be satisfied:

|θgF1−θgF2|≦0.150 (1-6),

where θgF1 is the relative partial dispersion (ng1−nF1)/(nF1−nC1) of the lens LA, and θgF2 is the relative partial dispersion (ng2−nF2)/(nF2−nC2) of the lens LB.

If conditional expression (1-6) is satisfied, the effect of correcting secondary spectrum (chromatic aberration) will be enhanced. Consequently, the sharpness of picked-up images will be increased. This will be conspicuously seen in the entire area of images picked up particularly at focal lengths near the telephoto end.

It is more preferred that the following conditional expression (1-6′) be satisfied instead of conditional expression (1-6):

|θgF1−θgF2|≦0.120 (1-6′).

It is most preferred that the following conditional expression (1-6″) be satisfied instead of conditional expression (1-6):

|θgF1−θgF2|≦0.105 (1-6″).

It is also preferred that the lens LB to which the lens LA is cemented be a positive lens, and the following conditional expression (1-7) be satisfied:

|θhg1−θhg2|≦0.200 (1-7),

where θhg1 is the relative partial dispersion (nh1−ng1)/(nF1−nC1) of the lens LA, and θhg2 is the relative partial dispersion (nh2−ng2)/(nF2−nC2) of the lens LB.

If conditional expression (1-7) is satisfied, the effect of correcting secondary spectrum (chromatic aberration) will be enhanced. Consequently, color flare and color blur in picked-up images can be decreased. This will be conspicuously seen in the entire area of images picked up particularly at focal lengths near the telephoto end.

It is more preferred that the following conditional expression (1-7′) be satisfied instead of conditional expression (1-7):

|θhg1−θhg2|≦0.180 (1-7′).

It is most preferred that the following conditional expression (1-7″) be satisfied instead of conditional expression (1-7):

|θhg1−θhg2|≦0.160 (1-7″).

In cases where the cemented lens is made up of three or more lenses, it is preferred that the lens LA be the lens having the smallest value of βgF1 or βhg1 among the lenses having a refracting power with the opposite sign to that of the positive lens group, namely among the negative lenses. Furthermore, it is preferred that the lens LB be the lens having the largest value of βgF2 or βhg2 among the lenses having a refracting power with the same sign as that of the positive lens group, namely among the positive lenses.

Here, a case in which the image forming optical system according to this mode is applied only to a zoom lens will be discussed. In the case of a fixed focal length lenses, it is sufficient that correction be achieved so that chromatic aberration does not vary over the focusing range in one focal length state. In contrast, in the case of zoom lenses, it is necessary that chromatic aberration be prevented from varying throughout the range of the change in the focal length. What is required to this end is that correction of chromatic aberration be achieved independently in each lens group.

If the range of the focal length change is small, the degree of independency of the correction is allowed to be low. Therefore, in cases where the range of the focal length change is small, there are many zoom solutions (i.e. specific zoom optical system configurations) with a small number of lens groups. On the other hand, in cases where the range of focal length change is large (i.e. in the case of zoom lenses with a high zoom ratio), the degree of independence must be high. In the case of the image forming optical system according to this mode, the zoom lens is designed to have a high zoom ratio, and at least the positive lens group is disposed closer to the object side than the aperture stop. It is preferred that this positive lens group be disposed closest to the object side. Furthermore, the image forming optical system according to this mode consists of four or five lens groups in total, and the relative distances between the lens groups on the optical axis change during zooming.

Furthermore, having the lens LA that satisfies conditional expressions (1-1), (1-2), and (1-3) enhances the degree of independence and decreases variations in chromatic aberration over the entire zoom range (i.e. the entire range of the focal length change). Typical zoom lenses having a high zoom ratio satisfy only conditional expression (1-3). Consequently, good achromatism with respect to the C-line and the F-line is achieved. However, they do not satisfy conditional expression (1-1) in particular. In consequence, they suffer from large chromatic aberration with respect to the g-line and the h-line generated with zooming, which deteriorates the sharpness of images and tends to generate purple color blur and flare.

Particularly, in optical systems in which a positive lens group is disposed closest to the object side, axial chromatic aberration and chromatic aberration of magnification have a higher sensitivity to dispersion characteristics at focal lengths near the telephoto end. Therefore, satisfying conditional expression (1-1) enables suppression of aberrations with respect not only to the C-line and the F-line but also to the g-line and the h-line generated with zooming. In particular, the higher the zoom ratio of the zoom optical system is, the more conspicuous the correction effect is.

Typically, zoom lenses with a high zoom ratio has a positive lens group and a negative lens group disposed closer to the object side than the aperture stop. The relative distance between the positive lens group and the negative lens group changes during zooming. Inmost cases, the negative lens group is disposed on the image side of the positive lens group to control the magnification change. In this negative lens group, chromatic aberration of magnification has a high sensitivity to dispersion characteristics at focal lengths near the wide angle end.

In view of this, in the image forming optical system according to this mode, it is preferred that the value of θgF3, the value of nd3, and the value of νd3 of at least one lens LC included in the negative lens group fall within the following three ranges: the range in an orthogonal coordinate system having a horizontal axis representing νd3 and a vertical axis representing θgF3 that is bounded by the straight line given by the equation θgF3=α3×νd3+βgF3 (where α3=−0.00566) into which the lowest value in the range defined by the following conditional expression (1-8) is substituted and the straight line given by the equation θgF3=α3×νd3+βgF3 (where α3=−0.00566) into which the highest value in the range defined by the following conditional expression (1-8) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (1-9) is substituted and the straight line given by the equation nd3=a3×νd3+b3 (where a3=−0.0267) into which the highest value in the range defined by the following conditional expression (1-9) is substituted; and the range defined by the following conditional expression (1-10):

0.6520<βgF3<0.7620 (1-8),

2.0<b3<2.4 (where nd3>1.3) (1-9),

10<νd3<35 (1-10),

where θgF3 is the relative partial dispersion (ng3−nF3)/(nF3−nC3) of the lens LC, and νd3 is the Abbe constant (nd3−1)/(nF3−nC3) of the lens LC, where nd3, nC3, nF3, and ng3 are refractive indices of the lens LC for the d-line, C-line, F-line, and g-line respectively.

Conditional expression (1-8) concerns the relative partial dispersion θgF of the lens material of the lens LC. If a lens material that falls out of the range is used for the lens LC, correction of chromatic aberration of magnification by secondary spectrum, specifically, correction of chromatic aberration of magnification with respect to the g-line while achromatism is achieved with respect to the F-line and the C-line will be insufficient at wide angle focal lengths. Then, it will be difficult to achieve sharpness in the peripheral region of images picked up at wide angle focal lengths particularly.

Conditional expression (1-9) concerns the refractive index of the lens material of the lens LC. If a lens material having a refractive index exceeding the upper limit value of conditional expression (1-9) is used, the Petzval sum of the lens group including the lens LC will tend to be large. This will make it difficult to correct curvature of field of the overall zoom lens. On the other hand, if a lens material having a refractive index exceeding the lower limit value of conditional expression (1-9) is used, spherical aberration of the lens group including the lens LC will tend to be large. This will make it difficult to correct spherical aberration of the overall zoom lens.

Conditional expression (1-10) concerns the Abbe constant of the lens material of the lens LC. If a lens material having an Abbe constant exceeding the upper limit value of conditional expression (1-10) is used, achromatism with respect even to the F-line and the C-line will be difficult, undesirably. If a lens material having an Abbe constant exceeding the lower limit value of conditional expression (1-10) is used, the effect of correcting five Seidel aberrations will become smaller even if achromatism with respect to the F-line and the C-line can be achieved.

It is more preferred that the following conditional expression (1-8′) be satisfied instead of conditional expression (1-8):

0.6620<βgF3<0.7570 (1-8′).

It is still more preferred that the following conditional expression (1-8″) be satisfied instead of the above conditional expression (1-8):

0.6720<βgF3<0.7520 (1-8″).

It is most preferred that the following conditional expression (1-8″′) be satisfied instead of conditional expression (1-8):

0.6720<βgF3<0.7445 (1-8″′).

It is more preferred that the following conditional expression (1-9′) be satisfied instead of conditional expression (1-9):

2.05<b3<2.34 (where nd3>1.3) (1-9′).

It is still more preferred that the following conditional expression (1-9″) be satisfied instead of the above conditional expression (1-9):

2.10<b3<2.27 (where nd3>1.3) (1-9″).

It is more preferred that the following conditional expression (1-10′) be satisfied instead of conditional expression (1-10):

12.5<νd3<27 (1-10′).

It is still more preferred that the following conditional expression (1-10″) be satisfied instead of the above conditional expression (1-10):

14.8<νd3<24 (1-10″).

In the case of zoom lenses with a high zoom ratio having a large angle of view at the wide angle end, it is preferred that a lens that satisfies conditional expressions (1-8), (1-9), and (1-10) be also used in the negative lens group. If these conditional expressions are satisfied, chromatic aberration of magnification at focal lengths near the wide angle end can be corrected excellently. The wider the angle of view is, the more conspicuous the correction effect will be.

In the image forming optical system according to this mode, it is more preferred that the value of θhg3, the value of nd3, and the value of νd3 of the lens LC fall within the following three ranges: the range in an orthogonal coordinate system, which is different from the aforementioned orthogonal coordinate system, having a horizontal axis representing νd3 and a vertical axis representing θhg3 that is bounded by the straight line given by the equation θhg3=αhg3×νd3+βhg3 (where αhg3=−0.00834) into which the lowest value in the range defined by the following conditional expression (1-11) is substituted and the straight line given by the equation θhg3=αhg3×νd3+βhg3 (where αhg3=−0.00834) into which the highest value in the range defined by the following conditional expression (1-11) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (1-9) is substituted and the straight line given by the equation nd3=a3×νd3+b3 (where a3=−0.0267) into which the highest value in the range defined by the following conditional expression (1-9) is substituted; and the range defined by the following conditional expression (1-10):

0.6000<βhg3<0.7800 (1-11),

2.0<b3<2.4 (where nd3>1.3) (1-9),

10<νd3<35 (1-10),

where θhg3 is the relative partial dispersion (nh3−ng3)/(nF3−nC3) of the lens LC, and nh3 is the refractive index of the lens LC for the h-line.

Conditional expression (1-11) concerns the relative partial dispersion θhg3 of the lens material. If a lens material that falls out of the range is used for the lens LC, correction of chromatic aberration of magnification by secondary spectrum, specifically, correction of chromatic aberration of magnification with respect to the h-line while achromatism is achieved with respect to the F-line and the C-line will be insufficient at focal lengths near the wide angle end. Therefore, purple color flare and color blur will tend to occur in the peripheral region of images picked up at focal lengths near the wide angle end particularly.

It is more preferred that the following conditional expression (1-11′) be satisfied instead of conditional expression (1-11):

0.6200<βhg3<0.7700 (1-11′).

It is still more preferred that the following conditional expression (1-11″) be satisfied instead of the above conditional expression (1-11):

0.6380<βhg3<0.7600 (1-11″).

It is most preferred that the following conditional expression (1-11″′) be satisfied instead of conditional expression (1-11):

0.6380<βhg3<0.7538 (1-11″′).

It is preferred that the lens LC be used as a lens that makes up a cemented lens. If this is the case, the effect of correcting chromatic aberrations (specifically, chromatic aberration with respect to the C-line and the F-line, chromatic aberration caused by dispersion characteristics such as secondary spectrum, and high order aberration components of third and higher orders related to the aperture ratio and the image height, such as chromatic spherical aberration, color coma, and chromatic aberration of magnification) on the cementing interface (or cemented surface) will be enhanced. The correction effect will be conspicuous with respect particularly to the aforementioned chromatic aberration caused by dispersion characteristics when conditional expressions (1-8), (1-9), and (1-10) are satisfied.

It is preferred that the cemented surface of the lens LC be an aspheric surface. If this is the case, the effect of correcting high order chromatic aberration components of third and higher orders related to the aperture ratio and the image height will be conspicuously achieved.

In the negative lens group disposed closer to the object side than the aperture stop in the image forming optical system, first order chromatic aberration is to be corrected firstly. To this end, it is preferred that this negative lens group be composed of a combination of a few negative lens elements having low dispersion and a few positive lens elements having high dispersion. Furthermore, it is preferred that the lens material of the lens LC satisfy conditional expression (1-10) concerning the Abbe constant. Therefore, it is preferred that the lens LC be a positive lens. Achromatism of the negative lens group with respect to the C-line and the F-line in this way facilitates correction of first order chromatic aberration generated by the overall optical system. As stated before, the “positive lens” refers to a lens having a positive paraxial focal length, and the “negative lens” refers to a lens having a negative paraxial focal length.

It is preferred that a lens LD to which the lens LC is cemented be a negative lens and that the following conditional expression (1-12) be satisfied:

νd3−νd4≦−15 (1-12),

where νd3 is the Abbe constant (nd3−1)/(nF3−nC3) of the lens LC, and νd4 is the Abbe constant (nd4−1)/(nF4−nC4) of the lens LD.

In this case, since the lenses LC and LD that have refracting powers of opposite signs are used in combination, good correction of chromatic aberration can be achieved. In particular, if conditional expression (1-12) is satisfied with this combination, achromatism of axial chromatic aberration and chromatic aberration of magnification with respect to the C-line and the F-line is facilitated.

It is more preferred that the following conditional expression (1-12′) be satisfied instead of conditional expression (1-12):

νd3−νd4≦−21 (1-12′).

It is most preferred that the following conditional expression (1-12″) be satisfied instead of conditional expression (1-12):

νd3−νd4≦−26 (1-12″).

High dispersion optical materials generally have higher relative partial dispersions θgF, θhg than low dispersion optical materials. In consequence, if axial chromatic aberration is corrected with respect to the C-line and the F-line, axial chromatic aberration with respect to the g-line and h-line will have a positive value. In other words, secondary spectrum will be generated. On the other hand, if chromatic aberration of magnification is corrected with respect to the C-line and the F-line, chromatic aberration of magnification with respect to the g-line and the h-line will have a positive value. Therefore, it is preferred that the difference in the relative partial dispersions θgF, θhg between the lens LC (high dispersion positive lens) and the lens LD (low dispersion negative lens) be made as small as possible so that achromatism with respect to the g-line and the h-light is accomplished. This consequently facilitates correction of chromatic aberration of the overall optical system.

Specifically, it is preferred that the lens LD to which the lens LC is cemented be a negative lens and that the following conditional expression (1-13) in terms of θgF be satisfied:

|θgF3−θgF4|≦0.100 (1-13),

where θgF3 is the relative partial dispersion (ng3−nF3)/(nF3−nC3) of the lens LC, and θgF4 is the relative partial dispersion (ng4−nF4)/(nF4−nC4) of the lens LD.

If conditional expression (1-13) is satisfied, the effect of correcting secondary spectrum (chromatic aberration) will be enhanced. Consequently, the sharpness of picked-up images will be increased. This will be conspicuously seen in the peripheral region of the image area in images picked up particularly at focal lengths near the wide angle end.

It is more preferred that the following conditional expression (1-13′) be satisfied instead of conditional expression (1-13):

|θgF3−θgF4|≦0.090 (1-13′).

It is most preferred that the following conditional expression (1-13″) be satisfied instead of conditional expression (1-13):

|θgF3−θgF4|≦0.085 (1-13″).

It is also preferred that the lens LD to which the lens LC is cemented be a negative lens, and the following conditional expression (1-14) be satisfied:

|θhg3−θhg4|≦0.200 (1-14),

where 74 hg3 is the relative partial dispersion (nh3−ng3)/(nF3−nC3) of the lens LC, and θhg4 is the relative partial dispersion (nh4−ng4)/(nF4−nC4) of the lens LD.

If conditional expression (1-14) is satisfied, the effect of correcting secondary spectrum (chromatic aberration) will be enhanced. Consequently, color flare and color blur in picked-up images can be decreased. This will be conspicuously seen in the peripheral region of the image area in images picked up particularly at focal lengths near the wide angle end.

It is more preferred that the following conditional expression (1-14′) be satisfied instead of conditional expression (1-14):

|θhg3−θhg4|≦0.160 (1-14′).

It is most preferred that the following conditional expression (1-14″) be satisfied instead of conditional expression (1-14):

|θhg3−θhg4|≦0.130 (1-14″).

In cases where the cemented lens is made up of three or more lenses, it is preferred that the lens LC be the lens having the smallest value of βgF3 among the lenses having a refracting power with the opposite sign to that of the negative lens group, namely among the positive lenses. Furthermore, it is preferred that the lens LD be the lens having the largest value of βgF4 among the lenses having a refracting power with the same sign as that of the negative lens group, namely among the negative lenses.

Here, the lens materials refer to the materials of lenses such as glasses and resins. Lenses made of materials selected from these lens materials are used in a cemented lens.

In particular, it is preferred that a cemented lens included in the positive lens group disposed closer to the object side than the aperture stop have a first lens having a small center thickness on the optical axis and a second lens. In addition, it is preferred that the first lens satisfy conditional expressions (1-1), (1-2), and (1-3) or conditional expressions (1-4), (1-2), and (1-3). If this cemented lens is designed in this way, a further enhancement of the effect of correcting aberrations and a further reduction in the thickness of the lens group can be expected. Furthermore, it is also preferred that a cemented lens included in the negative lens group disposed closer to the object side than the aperture stop have a first lens having a small center thickness on the optical axis and a second lens. In addition, it is preferred that the first lens satisfy conditional expressions (1-8), (1-9), and (1-10) or conditional expressions (1-11), (1-9), and (1-10). If this cemented lens is designed in this way, a further enhancement of the effect of correcting aberrations and a further reduction in the thickness of the lens group can be expected.

It is also preferred that the cemented lens be a compound lens. The compound lens can be made by closely attaching a resin on a surface of the second lens and curing it to form the first lens. Use of a compound lens as the cemented lens can improve manufacturing precision. One method of manufacturing a compound lens is molding. One method of molding is attaching a first lens material (e.g. energy curable transparent resin) to a second lens and directly molding the first lens material on one surface of the second lens. This method is very effective in making the lens element thin. An example of the energy curable transparent resin is an ultraviolet curable resin. Surface processing such as coating may be applied on the second lens in advance before molding the first lens. According to this method of manufacturing a compound lens, an aspheric cemented surface, which has been difficult to produce in the past, can easily be achieved by making at least the cemented surface of the second lens aspheric in advance.

When making the cemented lens as a compound lens, a glass may be attached to a surface of the second lens and molded to form the first lens. Glasses are advantageous over resins in terms of resistance properties such as light resistance and resistance to chemicals. In this case, it is necessary for the material of the first lens, characteristically, has a melting point and a transition point that are lower than those of the material of the second lens. One method of manufacturing compound lenses is molding. This method is very effective in making the lens element thin. Surface processing such as coating may be applied on the second lens in advance. According to this method of manufacturing a compound lens, an aspheric cemented surface, which has been difficult to produce in the past, can easily be achieved by making at least the cemented surface of the second lens aspheric in advance.

It is preferred that a prism is provided in the image forming optical system. The prism is used to bend the optical path of the optical system. In particular in the case where the image forming optical system is a zoom lens, the use of a prism enables a reduction in the depth (i.e. the overall length) of the optical system. It is particularly preferred that the prism be disposed in the first positive lens group closest to the object side or in the negative lens group.

Finally, details of construction of this image forming optical systems according to this mode will be described.

Among image forming optical systems according to this mode, in the case of a telephoto optical system having a fixed focal length, it is preferred that the optical system include, in order from its object side, a positive lens group, an aperture stop, and a negative lens group. The positive lens group has a lens LA having a negative refracting power, and the lens LA having a negative refracting power satisfies conditional expressions (1-1), (1-2), and (1-3). The lens LA may satisfy conditional expression (1-1′) or (1-1″) instead of conditional expression (1-1), conditional expression (1-2′) or (1-2″) instead of conditional expression (1-2), and/or conditional expression (1-3′) or (1-3″) instead of conditional expression (1-3).

The lens LA having a negative refracting power may be cemented to a lens LB having a positive refracting power. This cemented lens may further be cemented to another lens(es) to form a cemented lens made up of three or more lenses. The positive lens group may further include one or two lens component in addition to the cemented lens. On the other hand, the negative lens group includes one positive lens and one negative lens.

The image forming optical system according to this mode may be applied to a zoom lens. In the following, a zoom lens will be described by way of example. The zoom lens according to this mode has at least one positive lens group disposed closer to the object side than an aperture stop and consists of four or five lens groups in total. The relative distances between the lens groups on the optical axis change during zooming. The basic configurations (or refracting power arrangements) for such an image forming optical system include the following four types:

(A1) positive-negative-(S)-positive-positive;
(A2) positive-negative-(S)-positive-negative-positive;
(A3) positive-negative-(S)-positive-positive-positive; and
(A4) positive-negative-(S)-positive-positive-negative.
In the above, (S) represents an aperture stop. The aperture stop may be independent from the lens groups in some cases and not independent from the lens groups in other cases. The aperture stop may be provided in a lens group.

The zoom lens according to this mode has, as its basic configuration, the refracting power arrangement of (A1), that is, the positive-negative-(S)-positive-positive refracting power arrangement. Zoom lenses having other arrangements (A2), (A3), and (A4) can be regarded as modifications of a zoom lens having arrangement (A1). Specifically, an image forming optical system of (A2) is equivalent to an image forming optical system of (A1) to which a negative lens group is added between the two positive lens groups.

An image forming optical system of (A3) is equivalent to an image forming optical system of (A1) to which a positive lens group is added between the two positive lens groups or on the image side of the two positive lens groups.

An image forming optical system of (A4) is equivalent to an image forming optical system of (A1) to which a negative lens group is added on its image side.

In the aforementioned types (A1), (A2), (A3), and (A4), a positive lens group is disposed closest to the object side. This positive lens group has a lens LA having a negative refracting power. The lens LA having a negative refracting power satisfies conditional expressions (1-1), (1-2), and (1-3). This lens LA may satisfy conditional expressions (1-1′) or (1-1″) instead of conditional expression (1-1), conditional expression (1-2′) or (1-2″) instead of conditional expression (1-2), and/or conditional expression (1-3′) or (1-3″) instead of conditional expression (1-3). This lens LA may be cemented to a lens LB having a positive refracting power. This cemented lens may further cemented to another lens (es) to form a cemented lens made up of three or more lenses.

The positive lens group is disposed closest to the object side in the zoom lens and may have one or two lens component in addition to the cemented lens. The positive lens group may include a prism. If the positive lens group has a prism, it is preferred that it include one lens component, the prism, and the cemented lens arranged in order from its object side, one lens component, the prism, the cemented lens, and one lens component arranged in order from its object side, or one lens component, the prism, one lens component, and the cemented lens arranged in order from its object side.

The negative lens group disposed closer to the object side than the aperture stop is located on the image side of the positive lens group disposed closest to the object side and may have a lens LC having a positive refracting power that satisfies conditional expressions (1-8), (1-9), and (1-10), or alternatively (1-8′) or (1-8″) instead of conditional expression (1-8), conditional expression (1-9′) or (1-9″) in stead of conditional expression (1-9), and/or conditional expression (1-10′) or (1-10″) instead of conditional expression (1-10).

The lens LC having a positive refracting power may be cemented to a lens LD having a negative refracting power. Either of the positive lens and the negative lens may be disposed closer to the object side. This cemented lens may be cemented to another lens(es) to form a cemented lens made up of three or more lenses. The negative lens group may be composed of three or four lens components in total.

Subsequently to the first negative lens group, there are two or three positive lens groups, at least one of which is a positive lens group consisting of a single lens and a cemented lens component. This positive lens group is the second or third positive lens group.

In this zoom lens, a negative refracting power may be provided between the second and third positive lens groups disposed subsequent to the negative lens group so as to facilitate a reduction in the overall length. If this is the case, the negative refracting power may be provided by one lens component. This lens component may be a cemented lens component made up of a positive lens and a negative lens.

In this zoom lens, a negative refracting power may be provided on the image side of the second and third positive lens groups disposed subsequent to the negative lens group so as to facilitate a reduction in the overall length. If this is the case, the negative refracting power may be provided by one or two lens components. One of these lens components may be a cemented lens component made up of a positive lens and a negative lens.

In this zoom lens, a positive refracting power may be provided on the image side of the second and third positive lens groups disposed subsequent to the negative lens group so as to facilitate aberration correction. If this is the case, the positive refracting power may be provided by one lens component. This lens component may be a single lens.

The zoom lens according to this mode has the positive lens group, the negative lens group, and the aperture stop, and the positive lens group is disposed closer to the object side than the aperture stop. In addition, this positive lens group has the lens LA having a negative refracting power, which satisfies conditional expressions (1-1), (1-2), and (1-3). With this design, good correction of axial chromatic aberration and chromatic aberration of magnification is achieved. In particular, excellent correction of chromatic aberration at focal lengths near the telephoto end can be achieved.

In addition, the negative lens group is also disposed closer to the object side than the aperture stop. This negative lens group has the lens LC having a positive refracting power, which satisfies conditional expressions (1-8), (1-9), and (1-10). With this design, optimum correction of axial chromatic aberration and chromatic aberration of magnification can be achieved. In addition, chromatic aberration of magnification that remains at focal lengths near the wide angle end can be corrected excellently. Correction of this aberration can also be improved by other means. For example, the aberration can be improved by image processing.

In the image forming optical system according to another mode, the value of θgF1, the value of nd1, and the value of νd1 of at least one lens LA included in the positive lens group fall within the following three ranges: the range in an orthogonal coordinate system having a horizontal axis representing νd1 and a vertical axis representing θgF1 that is bounded by the straight line given by the equation θgF1=α1×νd1+βgF1 (where α1=−0.00264) into which the lowest value in the range defined by the following conditional expression (2-1) is substituted and the straight line given by the equation θgF1=α1×νd1+βgF1 (where α1=−0.00264) into which the highest value in the range defined by the following conditional expression (2-1) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (2-2) is substituted and the straight line given by the equation nd1=a1×νd1+b1 (where a1=−0.0267) into which the highest value in the range defined by the following conditional expression (2-2) is substituted; and the range defined by the following conditional expression (2-3):

0.6050<βgF1<0.7150 (2-1),

2.0<b1<2.4 (where nd1>1.3) (2-2),

10<νd1<28 (2-3),

where θgF1 is the relative partial dispersion (ng1−nF1)/(nF1−nC1) of the lens LA, and νd1 is the Abbe constant (nd1−1)/(nF1−nC1) of the lens LA, where nd1, nC1, nF1, and ng1 are refractive indices of the lens LA for the d-line, C-line, F-line, and g-line respectively.

Conditional expression (2-1) concerns the relative partial dispersion θgF1 of the lens material of the lens LA. If a lens material that falls out of the range is used for the lens LA, correction of axial chromatic aberration and chromatic aberration of magnification by secondary spectrum, specifically, correction of axial chromatic aberration and chromatic aberration of magnification with respect to the g-line while achromatism is achieved with respect to the F-line and the C-line will be insufficient at telephoto focal lengths. Then, it will be difficult to achieve sharpness over the entire picture area in images picked up at telephoto focal lengths particularly. This is also the case with a fixed focal length lens.

Conditional expression (2-2) concerns the refractive index of the lens material of the lens LA. If a lens material having a refractive index exceeding the upper limit value of conditional expression (2-2) is used, the Petzval sum of the lens group including the lens LA will tend to be large. This will make it difficult to correct curvature of field of the overall image forming optical system. On the other hand, if a lens material having a refractive index exceeding the lower limit value of conditional expression (2-2) is used, spherical aberration of the lens group including the lens LA will tend to be large. This will make it difficult to correct spherical aberration of the overall image forming system.

Conditional expression (2-3) concerns the Abbe constant of the lens material of the lens LA. If a lens material having an Abbe constant exceeding the upper limit value of conditional expression (2-3) is used, achromatism with respect even to the F-line and the C-line will be difficult, undesirably. If a lens material having an Abbe constant exceeding the lower limit value of conditional expression (2-3) is used, the effect of correcting five Seidel aberrations will become smaller even if achromatism with respect to the F-line and the C-line can be achieved.

It is more preferred that the following conditional expression (2-1′) be satisfied instead of conditional expression (2-1):

0.6050<βgF1<0.6950 (2-1′).

It is still more preferred that the following conditional expression (2-1″) be satisfied instead of the above conditional expression (2-1):

0.6050<βgF1<0.6903 (2-1″).

It is most preferred that the following conditional expression (2-1″′) be satisfied instead of conditional expression (2-1):

0.6732<βgF1<0.6820 (2-1″′).

It is more preferred that the following conditional expression (2-2′) be satisfied instead of conditional expression (2-2):

2.06<b1<2.34 (where nd1>1.3) (2-2′).

It is still more preferred that the following conditional expression (2-2″) be satisfied instead of the above conditional expression (2-2):

2.11<b1<2.28 (where nd1>1.3) (2-2″).

It is more preferred that the following conditional expression (2-3′) be satisfied instead of conditional expression (2-3):

12.5<νd1<26.3 (2-3′).

It is still more preferred that the following conditional expression (2-3″) be satisfied instead of the above conditional expression (2-3):

14.8<νd1<24.8 (2-3″).

It is most preferred that the following conditional expression (2-3″′) be satisfied instead of conditional expression (2-3):

14.8<νd1<23.3 (2-3″′).

In the image forming optical system according to this mode, it is more preferred that the value of θhg1, the value of nd1, and the value of νd1 of the lens LA fall within the following three ranges: the range in an orthogonal coordinate system, which is different from the aforementioned orthogonal coordinate system, having a horizontal axis representing νd1 and a vertical axis representing θhg1 that is bounded by the straight line given by the equation θhg1=αhg1×νd1+βhg1 (where αhg1=−0.00388) into which the lowest value in the range defined by the following conditional expression (2-4) is substituted and the straight line given by the equation θhg1=αhg1×νd1+βhg1 (where αhg1=−0.00388) into which the highest value in the range defined by the following conditional expression (2-4) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (2-2) is substituted and the straight line given by the equation nd1=a1×νd1+b1 (where a1=−0.0267) into which the highest value in the range defined by the following conditional expression (2-2) is substituted; and the range defined by the following conditional expression (2-3):

0.5000<βhg1<0.6750 (2-4),

2.0<b1<2.4 (where nd1>1.3) (2-2),

10<νd1<28 (2-3),

where θhg1 is the relative partial dispersion (nh1−ng1)/(nF1−nC1) of the lens LA, and nh1 is the refractive index of the lens LA for the h-line.

Conditional expression (2-4) concerns the relative partial dispersion θhg1 of the lens material of the lens LA. If a lens material that falls out of the range is used for the lens LA, correction of axial chromatic aberration and chromatic aberration of magnification by secondary spectrum, specifically, correction of axial chromatic aberration and chromatic aberration of magnification with respect to the h-line while achromatism is achieved with respect to the F-line and the C-line will be insufficient at telephoto focal lengths. Therefore, purple color flare and color blur will tend to occur over the entire picture area in images picked up at telephoto focal lengths particularly.

It is more preferred that the following conditional expression (2-4′) be satisfied instead of conditional expression (2-4):

0.5300<βhg1<0.6750 (2-4′).

It is still more preferred that the following conditional expression (2-4″) be satisfied instead of the above conditional expression (2-4):

0.5440<βhg1<0.6750 (2-4″).

It is most preferred that the following conditional expression (2-4″′) be satisfied instead of conditional expression (2-4):

0.5580<βhg1<0.6600 (2-4″′).

It is preferred that the lens LA be used as a lens that makes up a cemented lens. If this is the case, the effect of correcting chromatic aberrations (specifically, chromatic aberration with respect to the C-line and the F-line, chromatic aberration caused by dispersion characteristics such as secondary spectrum, and high order aberration components of third and higher orders related to the aperture ratio and the image height, such as chromatic spherical aberration, color coma, and chromatic aberration of magnification) on the cementing interface (or cemented surface) will be enhanced. The correction effect will be conspicuous with respect particularly to chromatic aberration caused by dispersion characteristics when conditional expressions (2-1), (2-2), and (2-3) are satisfied.

It is preferred that the cemented surface of the lens LA be an aspheric surface. If this is the case, the effect of correcting high order chromatic aberration components of third and higher orders related to the aperture ratio and the image height will be conspicuously achieved.

It is preferred that the positive lens group disposed closer to the object side than the aperture stop in the image forming optical system be composed of a combination of a few positive lens elements having low dispersion and a few negative lens elements having high dispersion to correct first order chromatic aberration. Achromatism of the positive lens group with respect to the C-line and the F-line facilitates correction of first order chromatic aberration generated by the overall optical system. In the image forming optical system according to this mode, as the lens material of the lens LA satisfies conditional expression (2-3) concerning its Abbe constant, the lens LA is a negative lens. Here, the “positive lens” refers to a lens having a positive paraxial focal length, and the “negative lens” refers to a lens having a negative paraxial focal length.

It is preferred that a lens LB to which the lens LA is cemented be a positive lens and that the following conditional expression (2-5) be satisfied:

νd1−νd2≦−10 (2-5),

where νd1 is the Abbe constant (nd1−1)/(nF1−nC1) of the lens LA, and νd2 is the Abbe constant (nd2−1)/(nF2−nC2) of the lens LB.

In this case, since the lenses LA and LB that have refracting powers of opposite signs are used in combination, good correction of chromatic aberration can be achieved. In particular if conditional expression (2-5) is satisfied with this combination, achromatism of axial chromatic aberration and chromatic aberration of magnification with respect to the C-line and the F-line is facilitated.

It is more preferred that the following conditional expression (2-5′) be satisfied instead of conditional expression (2-5):

νd1−νd2≦−13 (2-5′).

It is most preferred that the following conditional expression (2-5″) be satisfied instead of conditional expression (2-5):

νd1−νd2≦−16 (2-5″).

High dispersion optical materials generally have higher relative partial dispersions θgF, θhg than low dispersion optical materials. In consequence, if axial chromatic aberration is corrected with respect to the C-line and the F-line, axial chromatic aberration with respect to the g-line and h-line will have a positive value. In other words, secondary spectrum will be generated. On the other hand, if chromatic aberration of magnification is corrected with respect to the C-line and the F-line, chromatic aberration of magnification with respect to the g-line and the h-line will have a negative value. Therefore, it is preferred that the difference in the relative partial dispersions θgF, θhg between the lens LA (high dispersion negative lens) and the lens LB (low dispersion positive lens) be made as small as possible so that achromatism with respect to the g-line and the h-light is accomplished. This consequently facilitates correction of chromatic aberration of the overall optical system.

Specifically, it is preferred that the lens LB to which the lens LA is cemented be a positive lens and that the following conditional expression (2-6) in terms of θgF be satisfied:

|θgF1−θgF2|≦0.150 (2-6),

where θgF1 is the relative partial dispersion (ng1−nF1)/(nF1−nC1) of the lens LA, and θgF2 is the relative partial dispersion (ng2−nF2)/(nF2−nC2) of the lens LB.

If conditional expression (2-6) is satisfied, the effect of correcting secondary spectrum (chromatic aberration) will be enhanced. Consequently, the sharpness of picked-up images will be increased. This will be conspicuously seen in the entire area of images picked up particularly at focal lengths near the telephoto end.

It is more preferred that the following conditional expression (2-6′) be satisfied instead of conditional expression (2-6):

|θgF1−θgF2|≦0.120 (2-6′).

It is most preferred that the following conditional expression (2-6″) be satisfied instead of conditional expression (2-6):

|θgF1−θgF2|≦0.105 (2-6″).

It is also preferred that the lens LB to which the lens LA is cemented be a positive lens, and the following conditional expression (2-7) be satisfied:

|θhg1−θhg2|≦0.200 (2-7),

where θhg1 is the relative partial dispersion (nh1−ng1)/(nF1−nC1) of the lens LA, and θhg2 is the relative partial dispersion (nh2−ng2)/(nF2−nC2) of the lens LB.

If conditional expression (2-7) is satisfied, the effect of correcting secondary spectrum (chromatic aberration) will be enhanced. Consequently, color flare and color blur in picked-up images can be decreased. This will be conspicuously seen in the entire area of images picked up at focal lengths near the telephoto end.

It is more preferred that the following conditional expression (2-7′) be satisfied instead of conditional expression (2-7):

|θhg1−θhg2|≦0.180 (2-7′).

It is most preferred that the following conditional expression (2-7″) be satisfied instead of conditional expression (2-7):

|θhg1−θhg2|≦0.160 (2-7″).

In cases where the cemented lens is made up of three or more lenses, it is preferred that the lens LA be the lens having the smallest value of βgF1 or βhg1 among the lenses having a refracting power with the opposite sign to that of the positive lens group, namely among the negative lens elements. Furthermore, the lens LB should be the lens having the largest value of βgF2 or βhg2 among the lenses having a refracting power with the same sign as that of the positive lens group, namely among the positive lenses.

Here, a case in which the image forming optical system according to this mode is applied only to a zoom lens will be discussed. While in the case of fixed focal length lenses it is sufficient that correction be achieved so that chromatic aberration does not vary over the focusing range in one focal length state, in the case of zoom lenses it is necessary that chromatic aberration be prevented from varying throughout the range of change in the focal length. What is required to this end is that correction of chromatic aberration be achieved independently in each lens group.

If the range of the focal length change is small, the degree of independency of the correction allowed to be low. Therefore, in cases where the range of the focal length change is small, there are many zoom solutions (i.e. specific zoom optical system configurations) with a small number of lens groups. On the other hand, in cases where the range of focal length change is large (i.e. in the case of zoom lenses with a high zoom ratio), the degree of independence must be high. In the case of the image forming optical system according to this mode, the zoom lens is designed to have a high zoom ratio, and at least the positive lens group is disposed closer to the object side than the aperture stop. It is preferred that this positive lens group be disposed closest to the object side. Furthermore, the image forming optical system according to this mode consists of four or five lens groups in total, and the relative distances between the lens groups on the optical axis change during zooming.

Furthermore, having the lens LA that satisfies conditional expressions (2-1), (2-2), and (2-3) enhances the degree of independence and decreases variations in chromatic aberration over the entire zoom range (i.e. the entire range of the focal length change). Typical zoom lenses with a high zoom ratio satisfy only conditional expression (2-3). Consequently, good achromatism with respect to the C-line and the F-line is achieved. However, they do not satisfy conditional expression (2-1) in particular. In consequence, they suffer from large chromatic aberration with respect to the g-line and the h-line generated with zooming, which deteriorates the sharpness of images and tends to generate purple color blur and flare.

Particularly, in optical systems in which a positive lens group is disposed closest to the object side, axial chromatic aberration and chromatic aberration of magnification have a higher sensitivity to dispersion characteristics at focal lengths near the telephoto end. Therefore, satisfying conditional expression (2-1) enables suppression of aberrations with respect not only to the C-line and the F-line but also to the g-line and the h-line generated with zooming. In particular, the higher the zoom ratio of the zoom optical system is, the more conspicuous the correction effect is.

Typically, zoom lenses with a high zoom ratio has, as described above, a positive lens group and a negative lens group disposed closer to the object side than the aperture stop. The relative distance between the positive lens group and the negative lens group changes during zooming. Inmost cases, the negative lens group is disposed on the image side of the positive lens group to control the magnification change. In this negative lens group, chromatic aberration of magnification has a high sensitivity to dispersion characteristics at focal lengths near the wide angle end. Therefore, the wider the angle of view is, the more conspicuous the correction effect is. Therefore, in the case of zoom lenses with a high zoom ratio and a large angle of view at the wide angle end, it is preferred that a lens that satisfies like conditional expressions (2-8), (2-9), and (2-10) be used.

In view of this, in the image forming optical system according to this mode, it is preferred that the value of θgF3, the value of nd3, and the value of νd3 of at least one lens LC included in the negative lens group fall within the following three ranges: the range in an orthogonal coordinate system having a horizontal axis representing νd3 and a vertical axis representing θgF3 that is bounded by the straight line given by the equation θgF3=α3×νd3+βgF3 (where α3=−0.00264) into which the lowest value in the range defined by the following conditional expression (2-8) is substituted and the straight line given by the equation θgF3=α3×νd3+βgF3 (where α3=−0.00264) into which the highest value in the range defined by the following conditional expression (2-8) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (2-9) is substituted and the straight line given by the equation nd3=a3×νd3+b3 (where a3=−0.0267) into which the highest value in the range defined by the following conditional expression (2-9) is substituted; and the range defined by the following conditional expression (2-10):

0.6050<βgF3<0.7150 (2-8),

2.0<b3<2.4 (where nd3>1.3) (2-9),

10<νd3<28 (2-10),

where θgF3 is the relative partial dispersion (ng3−nF3)/(nF3−nC3) of the lens LC, and νd3 is the Abbe constant (nd3−1)/(nF3−nC3) of the lens LC, where nd3, nC3, nF3, and ng3 are refractive indices of the lens LC for the d-line, C-line, F-line, and g-line respectively.

Conditional expression (2-8) concerns the relative partial dispersion θgF of the lens material of the lens LC. If a lens material that falls out of the range is used for the lens LC, correction of chromatic aberration of magnification by secondary spectrum, specifically, correction of chromatic aberration of magnification with respect to the g-line while achromatism is achieved with respect to the F-line and the C-line will be insufficient at wide angle focal lengths. Then, it will be difficult to achieve sharpness in the peripheral region of images picked up at wide angle focal lengths particularly.

Conditional expression (2-9) concerns the refractive index of the lens material of the lens LC. If a lens material having a refractive index exceeding the upper limit value of conditional expression (2-9) is used, the Petzval sum of the lens group including the lens LC will tend to be large. This will make it difficult to correct curvature of field of the overall image forming optical system. On the other hand, if a lens material having a refractive index exceeding the lower limit value of conditional expression (2-9) is used, spherical aberration of the lens group including the lens LC will tend to be large. This will make it difficult to correct spherical aberration of the overall image forming system.

Conditional expression (2-10) concerns the Abbe constant of the lens material of the lens LC. If a lens material having an Abbe constant exceeding the upper limit value of conditional expression (2-10) is used, achromatism with respect even to the F-line and the C-line will be difficult, undesirably. If a lens material having an Abbe constant exceeding the lower limit value of conditional expression (2-10) is used, the effect of correcting five Seidel aberrations will become smaller even if achromatism with respect to the F-line and the C-line can be achieved.

It is more preferred that the following conditional expression (2-8′) be satisfied instead of conditional expression (2-8):

0.6050<βgF3<0.6950 (2-8′).

It is still more preferred that the following conditional expression (2-8″) be satisfied instead of the above conditional expression (2-8):

0.6250<βgF3<0.6903 (2-8″).

It is most preferred that the following conditional expression (2-8″′) be satisfied instead of conditional expression (2-8):

0.6250<βgF3<0.6820 (2-8″′).

It is more preferred that the following conditional expression (2-9′) be satisfied instead of conditional expression (2-9):

2.05<b3<2.34 (where nd3>1.3) (2-9′).

It is still more preferred that the following conditional expression (2-9″) be satisfied instead of the above conditional expression (2-9):

2.10<b3<2.27 (where nd3>1.3) (2-9″).

It is more preferred that the following conditional expression (2-10′) be satisfied instead of conditional expression (2-10):

12.5<νd3<25.0 (2-10′).

It is still more preferred that the following conditional expression (2-10″) be satisfied instead of the above conditional expression (2-10):

14.8<νd3<23.0 (2-10″).

It is most preferred that the following conditional expression (2-10″′) be satisfied instead of conditional expression (2-10):

14.8<νd3<22.5 (2-10″′).

In the case of high magnification zoom lenses having a large angle of view at the wide angle end, it is preferred that a lens that satisfies conditional expressions (2-8), (2-9), and (2-10) be also used in the negative lens group. If these conditional expressions are satisfied, chromatic aberration of magnification at focal lengths near the wide angle end can be corrected excellently. The wider the angle of view is, the more pronounced the correction effect will be.

In the image forming optical system according to this mode, it is more preferred that the value of θhg3, the value of nd3, and the value of νd3 of the lens LC fall within the following three ranges: the range in an orthogonal coordinate system, which is different from the aforementioned orthogonal coordinate system, having a horizontal axis representing νd3 and a vertical axis representing θhg3 that is bounded by the straight line given by the equation θhg3=αhg3×νd3+βhg3 (where αhg3=−0.00388) into which the lowest value in the range defined by the following conditional expression (2-11) is substituted and the straight line given by the equation θhg3=αhg3×νd3+βhg3 (where αhg3=−0.00388) into which the highest value in the range defined by the following conditional expression (2-11) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (2-9) is substituted and the straight line given by the equation nd3=a3×νd3+b3 (where a3=−0.0267) into which the highest value in the range defined by the following conditional expression (2-9) is substituted; and the range defined by the following conditional expression (2-10):

0.5100<βhg3<0.6750 (2-11),

2.0<b3<2.4 (where nd3>1.3) (2-9),

10<νd3<35 (2-10),

where θhg3 is the relative partial dispersion (nh3−ng3)/(nF3−nC3) of the lens LC, and nh3 is the refractive index of the lens LC for the h-line.

Conditional expression (2-11) concerns the relative partial dispersion θhg3 of the lens material of the lens LC. If a lens material that falls out of the range is used for the lens LC, correction of chromatic aberration of magnification by secondary spectrum, specifically, correction of chromatic aberration of magnification with respect to the h-line while achromatism is achieved with respect to the F-line and the C-line will be insufficient at focal lengths near the wide angle end. Therefore, purple color flare and color blur will tend to occur in the peripheral region of images picked up at focal lengths near the wide angle end particularly.

It is more preferred that the following conditional expression (2-11′) be satisfied instead of conditional expression (2-11):

0.5400<βhg1<0.6750 (2-11′).

It is still more preferred that the following conditional expression (2-11″) be satisfied instead of the above conditional expression (2-11):

0.5700<βhg1<0.6750 (2-11″).

It is most preferred that the following conditional expression (2-11″′) be satisfied instead of conditional expression (2-11):

0.5700<βhg1<0.6600 (2-11″′).

It is preferred that the lens LC be used as a lens that makes up a cemented lens. If this is the case, the effect of correcting chromatic aberrations (specifically, chromatic aberration with respect to the C-line and the F-line, chromatic aberration caused by dispersion characteristics such as secondary spectrum, and high order aberration components of third and higher orders related to the aperture ratio and the image height, such as chromatic spherical aberration, color coma, and chromatic aberration of magnification) on the cementing interface (or cemented surface) will be enhanced. The correction effect will be conspicuous with respect particularly to chromatic aberrations caused by dispersion characteristics when conditional expressions (2-8), (2-9), and (2-10) are satisfied.

It is preferred that the cemented surface of the lens LC be an aspheric surface. If this is the case, the effect of correcting high order chromatic aberration components of third and higher orders related to the aperture ratio and the image height will be pronouncedly achieved.

It is preferred that the negative lens group disposed closer to the object side than the aperture stop in the image forming optical system be composed of a combination of a few negative lens elements having low dispersion and a few positive lens elements having high dispersion in order to primarily correct first order chromatic aberration. Furthermore, it is preferred that the lens material of the lens LC satisfy conditional expression (2-10) concerning the Abbe constant. Therefore, it is preferred that the lens LC be a positive lens. Achromatism of the negative lens group with respect to the C-line and the F-line in this way facilitates correction of first order chromatic aberration generated by the overall optical system. As stated before, the “positive lens” refers to a lens having a positive paraxial focal length, and the “negative lens” refers to a lens having a negative paraxial focal length.

It is preferred that a lens LD to which the lens LC is cemented be a negative lens and that the following conditional expression (2-12) be satisfied:

νd3−νd4≦−15 (2-12),

where νd3 is the Abbe constant (nd3−1)/(nF3−nC3) of the lens LC, and νd4 is the Abbe constant (nd4−1)/(nF4−nC4) of the lens LD.

In this case, the lenses LC and LD that have refracting powers of opposite signs are used in combination, good correction of chromatic aberration can be achieved. In particular, if conditional expression (2-12) is satisfied with this combination, achromatism of axial chromatic aberration and chromatic aberration of magnification with respect to the C-line and the F-line is facilitated.

It is more preferred that the following conditional expression (2-12′) be satisfied instead of conditional expression (2-12):

νd3−νd4≦−21 (2-12′).

It is most preferred that the following conditional expression (2-12″) be satisfied instead of conditional expression (2-12):

νd3−νd4≦−26 (2-12″).

High dispersion optical materials generally have higher relative partial dispersions θgF, θhg than low dispersion optical materials. In consequence, if axial chromatic aberration is corrected with respect to the C-line and the F-line, axial chromatic aberration with respect to the g-line and h-line will have a positive value. In other words, secondary spectrum will be generated. On the other hand, if chromatic aberration of magnification is corrected with respect to the C-line and the F-line, chromatic aberration of magnification with respect to the g-line and the h-line will have a positive value. Therefore, it is preferred that the difference in the relative partial dispersions θgF, θhg between the lens LC (high dispersion positive lens) and the lens LD (low dispersion negative lens) be made as small as possible so that achromatism with respect to the g-line and the h-light is accomplished. This consequently facilitates correction of chromatic aberration of the overall optical system.

Specifically, it is preferred that the lens LD to which the lens LC is cemented be a negative lens and that the following conditional expression (2-13) in terms of θgF be satisfied:

|θgF3−θgF4|≦0.100 (2-13),

where θgF3 is the relative partial dispersion (ng3−nF3)/(nF3−nC3) of the lens LC, and θgF4 is the relative partial dispersion (ng4−nF4)/(nF4−nC4) of the lens LD.

If conditional expression (2-13) is satisfied, the effect of correcting secondary spectrum (chromatic aberration) will be enhanced. Consequently, sharpness of picked-up images will be increased. This will be pronouncedly seen in the peripheral region of the image area in images picked up particularly at focal lengths near the wide angle end.

It is more preferred that the following conditional expression (2-13′) be satisfied instead of conditional expression (2-13):

|θgF3−θgF4|≦0.090 (2-13′).

It is most preferred that the following conditional expression (2-13″) be satisfied instead of conditional expression (2-13):

|θgF3−θgF4|≦0.085 (2-13″).

It is also preferred that the lens LD to which the lens LC is cemented be a negative lens, and the following conditional expression (2-14) be satisfied:

|θhg3−θhg4|≦0.200 (2-14),

where 74 hg3 is the relative partial dispersion (nh3−ng3)/(nF3−nC3) of the lens LC, and θhg4 is the relative partial dispersion (nh4−ng4)/(nF4−nC4) of the lens LD.

If conditional expression (2-14) is satisfied, the effect of correcting secondary spectrum (chromatic aberration) will be enhanced. Consequently, color flare and color blur in picked-up images can be decreased. This will be pronouncedly seen in the peripheral region of the image area in images picked up particularly at focal lengths near the wide angle end.

It is more preferred that the following conditional expression (2-14′) be satisfied instead of conditional expression (2-14):

|θhg3−θhg4|≦0.160 (2-14′).

It is most preferred that the following conditional expression (2-14″) be satisfied instead of conditional expression (2-14):

|θhg3−θhg4|≦0.130 (2-14″).

In cases where the cemented lens is made up of three or more lenses, it is preferred that the lens LC be the lens having the smallest value of βgF3 among the lenses having a refracting power with the opposite sign to that of the negative lens group, namely among the positive lenses. Furthermore, it is preferred that the lens LD be the lens having the largest value of βgF4 among the lenses having a refracting power with the same sign as that of the negative lens group, namely among the negative lenses.

Here, the lens materials refer to the materials of lenses such as glasses and resins. Lenses made of materials selected from these lens materials are used in a cemented lens.

In particular, in is preferred that a cemented lens included in the positive lens group disposed closer to the object side than the aperture stop have a first lens having a small center thickness on the optical axis and a second lens. In addition, it is preferred that the first lens satisfy conditional expressions (2-1), (2-2), and (2-3) or conditional expressions (2-4), (2-2), and (2-3). If this cemented lens is designed in this way, a further enhancement of the effect of correcting aberrations and a further reduction in the thickness of the lens group can be expected. Furthermore, it is also preferred that a cemented lens included in the negative lens group disposed closer to the object side than the aperture stop have a first lens having a small center thickness on the optical axis and a second lens. In addition, it is preferred that the first lens satisfy conditional expressions (2-8), (2-9), and (2-10) or conditional expressions (2-11), (2-9), and (2-10). If this cemented lens is designed in this way, a further enhancement of the effect of correcting aberrations and a further reduction in the thickness of the lens group can be expected.

It is also preferred that the cemented lens be a compound lens. The cemented lens can be made by closely attaching a resin on a surface of the second lens and curing it to form the first lens. Use of a compound lens as the cemented lens can improve manufacturing precision. One method of manufacturing a compound lens is molding. One method of molding is attaching a first lens material (e.g. energy curable transparent resin) to a second lens and directly curing the first lens material on one surface of the second lens. This method is very effective in making the lens element thin. An example of the energy curable transparent resin is an ultraviolet curable resin. Surface processing such as coating may be applied on the second lens in advance before molding the first lens. According to this method of manufacturing a compound lens, an aspheric cemented surface, which has been difficult to produce in the past, can easily be achieved by making at least the cemented surface of the second lens aspheric in advance.

When making the cemented lens as a compound lens, a glass may be attached to a surface of the second lens and molded to form the first lens. Glasses are advantageous over resins in terms of resistance properties such as light resistance and resistance to chemicals. In this case, it is necessary for the material of the first lens, characteristically, has a melting point and a transition point that are lower than those of the material of the second lens. One method of manufacturing compound lenses is molding. This method is very effective in making the lens element thin. Surface processing such as coating may be applied on the second lens in advance. According to this method of manufacturing a compound lens, an aspheric cemented surface, which has been difficult to produce in the past, can easily be achieved by making at least the cemented surface of the second lens aspheric in advance.

It is preferred that a prism is provided in the image forming optical system. The prism is used to bend the optical path of the optical system. In particular in the case where the image forming optical system is a zoom lens, it is possible to reduce the depth (i.e. the overall length) of the optical system. It is particularly preferred that the prism be disposed in the first positive lens group closest to the object side or in the negative lens group.

Finally, image forming optical systems according to this mode will be described.

Among image forming optical systems according to this mode, in the case of a telephoto optical system having a fixed focal length, it is preferred that the optical system include, in order from its object side, a positive lens group, an aperture stop, and a negative lens group. The positive lens group has a lens LA having a negative refracting power, and the lens LA having a negative refracting power satisfies conditional expressions (2-1), (2-2), and (2-3). The lens LA may satisfy conditional expression (2-1′) or (2-1″) instead of conditional expression (2-1), conditional expression (2-2′) or (2-2″) instead of conditional expression (2-2), and/or conditional expression (2-3′) or (2-3″) instead of conditional expression (2-3).

The lens LA having a negative refracting power may be cemented to a lens LB having a positive refracting power. This cemented lens may further be cemented to another lens(es) to form a cemented lens made up of three or more lenses. The positive lens group may further has one or two lens component in addition to the cemented lens. On the other hand, the negative lens group includes one positive lens and one negative lens.

The image forming optical system according to this mode may be applied to a zoom lens. In the following, a zoom lens will be described by way of example. The zoom lens according to this mode has at least one positive lens group disposed closer to the object side than an aperture stop and consists of four or five lens groups. The relative distances between the lens groups on the optical axis change during zooming. The basic configurations (or refracting power arrangements) for such an image forming optical system include the following four types:

(A1) positive-negative-(S)-positive-positive;
(A2) positive-negative-(S)-positive-negative-positive;
(A3) positive-negative-(S)-positive-positive-positive; and
(A4) positive-negative-(S)-positive-positive-negative.
In the above, (S) represents an aperture stop. The aperture stop may be independent from the lens groups in some cases and not independent from the lens groups in other cases. The aperture stop may be provided in a lens group.

The basic configuration of the zoom lens according to this mode is the refracting power arrangement of (A1), that is, the positive-negative-(S)-positive-positive refracting power arrangement. Zoom lenses having other arrangements (A2), (A3), and (A4) can be regarded as modifications of a zoom lens having arrangement (A1). Specifically, an image forming optical system of (A2) is equivalent to an image forming optical system of (A1) to which a negative lens group is added between the two positive lens groups.

An image forming optical system of (A3) is equivalent to an image forming optical system of (A1) to which a positive lens group is added between the two positive lens groups or on the image side of the two positive lens groups.

An image forming optical system of (A4) is equivalent to an image forming optical system of (A1) to which a negative lens group is added on its image side.

In the aforementioned types (A1), (A2), (A3), and (A4), a positive lens group is disposed closest to the object side. This positive lens group has a lens LA having a negative refracting power. The lens LA having a negative refracting power satisfies conditional expressions (2-1), (2-2), and (2-3). This lens LA may satisfy conditional expressions (2-1′) or (2-1″) instead of conditional expression (2-1), conditional expression (2-2′) or (2-2″) instead of conditional expression (2-2), and conditional expression (2-3′) or (2-3″) instead of conditional expression (2-3). This lens LA may be cemented to a lens LB having a positive refracting power. This cemented lens may further cemented to another lens (es) to form a cemented lens made up of three or more lenses.

The positive lens group is disposed closest to the object side in the zoom lens and may have one or two lens component in addition to the cemented lens. The positive lens group may have a prism. If the positive lens has a prism, it is preferred that it include one lens component, the prism, and the lens component arranged in order from its object side, one lens component, the prism, the cemented lens, and one lens component arranged in order from its object side, or one lens component, the prism, one lens component, and the cemented lens arranged in order from its object side.

The negative lens group disposed closer to the object side than the aperture stop is located on the image side of the positive lens group disposed closest to the object side and has a lens LC having a positive refracting power that satisfies conditional expressions (2-8), (2-9), and (2-10), or alternatively (2-8′) or (2-8″) instead of conditional expression (2-8), conditional expression (2-9′) or (2-9″) in stead of conditional expression (2-9), and conditional expression (2-10′) or (2-10″) instead of conditional expression (2-10).

The lens LC having a positive refracting power may be cemented to a lens LD having a negative refracting power. Either of the positive lens and the negative lens may be disposed closer to the object side. This cemented lens may be cemented to another lens(es) to form a cemented lens made up of three or more lenses. The negative lens group may be composed of three or four lens components in total.

Subsequently to the first negative lens group, there are two or three positive lens groups, one of which is a positive lens group consisting of a single lens and a cemented lens component. This positive lens group is the second or third positive lens group.

In this zoom lens, a negative refracting power may be provided between the second and third positive lens groups disposed subsequent to the negative lens group so as to facilitate a reduction in the overall length. If this is the case, the negative refracting power may be provided by one lens component. This lens component may be a cemented lens component made up of a positive lens and a negative lens.

In this zoom lens, a negative refracting power may be provided on the image side of the second and third positive lens groups disposed subsequent to the negative lens group so as to facilitate a reduction in the overall length. If this is the case, the negative refracting power may be provided by one or two lens components. One of these lens components may be a cemented lens component made up of a positive lens and a negative lens.

In this zoom lens, a positive refracting power may be provided on the image side of the second and third positive lens groups disposed subsequent to the negative lens group so as to facilitate aberration correction. If this is the case, the positive refracting power may be provided by one lens component. This lens component may be a single lens.

The zoom lens according to this mode has the positive lens group, the negative lens group, and the aperture stop, and the positive lens group is disposed closer to the object side than the aperture stop. In addition, this positive lens group has the lens LA having a negative refracting power, which satisfies conditional expressions (2-1), (2-2), and (2-3). With this design, good correction of axial chromatic aberration and chromatic aberration of magnification is achieved. In particular, excellent correction of chromatic aberration at focal length near the telephoto end can be achieved.

In addition, the negative lens group is also disposed closer to the object side than the aperture stop. This negative lens group has the lens LC having a positive refracting power, which satisfies conditional expressions (2-8), (2-9), and (2-10). With this design, the best correction of axial chromatic aberration and chromatic aberration of magnification can be achieved. In addition, chromatic aberration of magnification that remains at focal lengths near the wide angle end can be corrected excellently. Correction of this aberration can also be improved by other means. For example, the aberration can be improved by image processing.

The image forming optical system according to this mode can be used in an electronic image pickup apparatus. The electronic image pickup apparatus comprises the above-described image forming optical system, an electronic image pickup element, and an image processing section. Image data processed by the image processing section is obtained by picking up an image formed by the image forming optical system by the electronic image pickup element. The image processing section processes the image data and outputs image data representing an image having a deformed shape.

The aforementioned image forming optical system in the electronic image pickup apparatus is a zoom lens, and it is preferred that the zoom lens satisfy the following conditional expression (3-1) in the state in which it is focused on an object point at infinity:

0.7<y₀₇/(f_{W}·tan ω_{07w})<0.96 (3-1),

where y₀₇ is expressed by equation y₀₇=0.7y₁₀, y₁₀ being the distance from the center of the effective image pickup area (in which images can be picked up) of the electronic image pickup element to the farthest point in the image pickup area (i.e. the maximum image height), ω_{07w} is the angle of the direction toward an object point corresponding to an image point formed at a position at distance y₀₇ from the center of the image pickup surface at the wide angle end with respect to the optical axis, and fw is the focal length of the entire image forming system (zoom lens) at the wide angle end.

As described above, the image processing unit (image processing section) can process image data and output image data representing an image having a deformed shape. An image of an object is picked up by the electronic image pickup apparatus. Image data obtained by picking up the image is separated into image data of respective colors through color-separation by the image processing unit. Then, the shape of the image (or the size of the object image) represented by each image data is changed, and composition of the image data is performed. By this process, deterioration of the sharpness in the peripheral region of the image due to chromatic aberration of magnification and color blur can be prevented from occurring.

This method is effective particularly for electronic image pickup apparatuses having an electronic image pickup element provided with a mosaic filter for color separation.

In the case of electronic image pickup apparatuses having a plurality of electronic image pickup elements (for respective colors), color-separation need not be performed for obtained image data.

In the color-separation process, separation into three colors including B (blue, approximately 400-500 nm), G (green, approximately 500-600 nm), and R (red, approximately 600-700 nm) is typically performed. Then, it is undesirable that there is chromatic aberration in each wavelength range (band). In particular in the B range, which is a short wavelength range, it is undesirable that there is chromatic aberration due to secondary spectrum. Therefore, if there remains a large amount of chromatic aberration of magnification in the B range due to secondary spectrum, it is preferred that aberration correction of the optical system and correction by image processing be achieved in combination.

As the image forming optical system according to this mode satisfies/has one of the above-described conditions/physical features, size reduction and slimming of the image forming optical system can both be achieved, and good aberration correction can be accomplished. The image forming optical system according to this mode may satisfy or have two or more of the above-described conditions and physical features in combination. If this is the case, further reduction and slimming of the image forming apparatus and better aberration correction can be achieved. As the electronic image pickup apparatus according to this mode is equipped with such an image forming optical system, improvement in the sharpness of picked-up images and elimination of color blur from picked-up images can be expected.

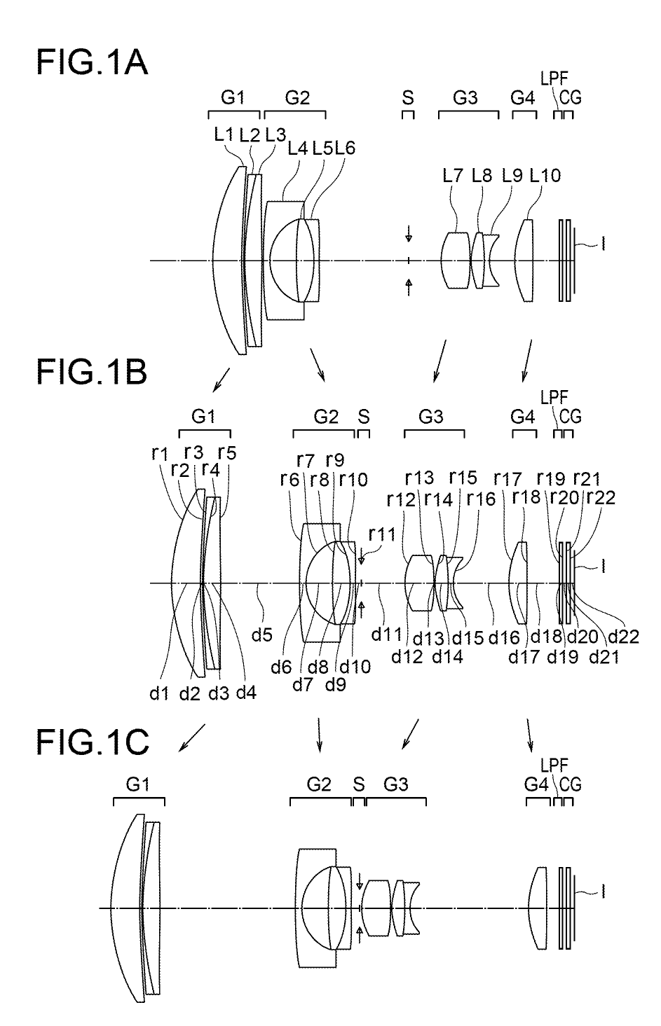

Now, a zoom lens according to embodiment 1 of the present invention will be described. FIGS. 1A, 1B, and 1C are cross sectional views taken along the optical axis showing the optical configuration of the zoom lens according to embodiment 1 of the present invention in the state in which the zoom lens is focused on an object point at infinity, where FIG. 1A is a cross sectional view of the zoom lens at the wide angle end, FIG. 1B is a cross sectional view of the zoom lens at an intermediate focal length position, and FIG. 1C is a cross sectional view of the zoom lens at the telephoto end.

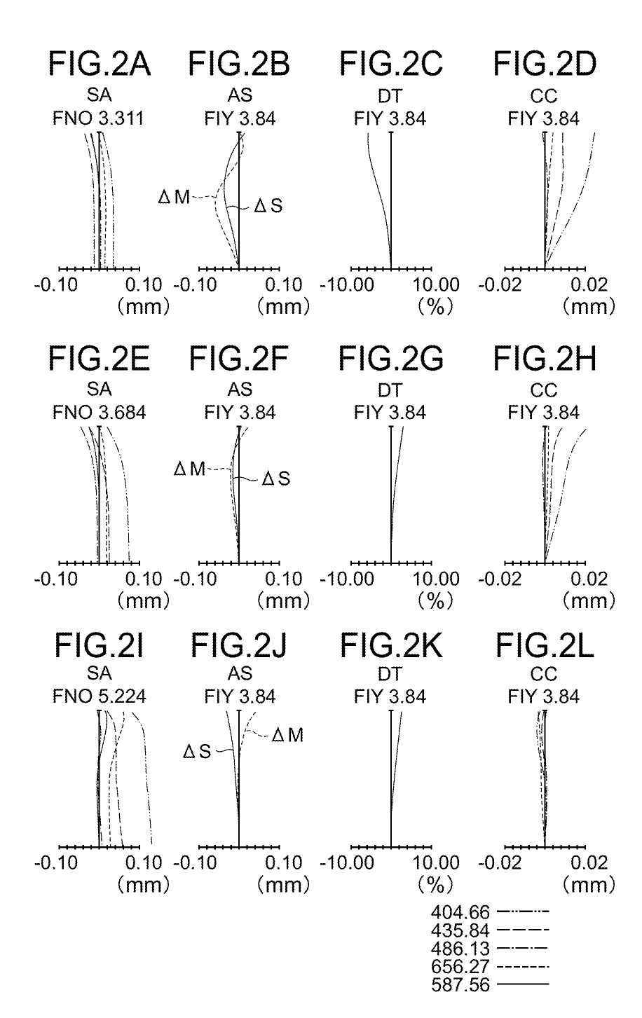

FIGS. 2A, 2B, 2C, 2D, 2E, 2F, 2G, 2H, 2I, 2J, 2K and 2L are diagrams showing spherical aberration (SA), astigmatism (AS), distortion (DT), and chromatic aberration of magnification (CC) of the zoom lens according to embodiment 1 in the state in which the zoom lens is focused on an object point at infinity, where FIGS. 2A, 2B, 2C, 2D are for the wide angle end, FIGS. 2E, 2F, 2G, 2H are for the intermediate focal length position, and FIGS. 2I, 2J, 2K, 2L are for the telephoto end. Sign “FIY” represents the image height. The signs in the aberration diagrams are commonly used also in the embodiments described in the following.

As shown in FIGS. 1A, 1B, and 1C, the zoom lens according to embodiment 1 includes, in order from its object side, a first lens group G1 having a positive refracting power, a second lens group G2 having a negative refracting power, an aperture stop S, a third lens group G3 having a positive refracting power, and a fourth lens group G4 having a positive refracting power. In the cross sectional views of the lenses according to this and all the embodiments described in the following, LPF denotes a low pass filter, CG denotes a cover glass, and I denotes the image pickup surface of an electronic image pickup element.

The first lens group G1 is composed of a positive meniscus lens L1 having a convex surface directed toward the object side, and a cemented lens made up of a negative meniscus lens L2 having a convex surface directed toward the object side and a biconvex positive lens L3. The first lens group G1 has a positive refracting power as a whole. In this configuration, the negative meniscus lens L2 having a convex surface directed toward the object side constitutes the lens LA, and the biconvex positive lens L3 constitutes the lens LB.

The second lens group G2 is composed of a negative meniscus lens L4 having a convex surface directed toward the object side, and a cemented lens made up of a biconvex positive lens L5 and a biconcave negative lens L6. The second lens group G2 has a negative refracting power as a whole.

The third lens group G3 is composed of a biconvex positive lens L7, and a cemented lens made up of a biconvex positive lens L8 and a biconcave negative lens L9. The third lens group G3 has a positive refracting power as a whole.

The fourth lens group G4 is composed of a positive meniscus lens L10 having a convex surface directed toward the object side. The fourth lens group G4 has a positive refracting power as a whole.

During zooming from the wide angle end to the telephoto end, the first lens group G1 moves toward the object side, the second lens group G2 moves toward the image side, the aperture stop S moves toward the object side, the third lens group G3 moves toward the object side, and the fourth lens group G4 moves toward the object side during zooming from the wide angle end to the intermediate focal length position and moves toward the image side during zooming from the intermediate focal length position to the telephoto end.

There are eight aspheric surfaces in total, which include both surfaces of the negative meniscus lens L2 having a convex surface directed toward the object side in the first lens group G1, the object side surface of the negative meniscus lens L4 having a convex surface directed toward the object side in the second lens group G2, the image side surface of the biconcave negative lens L6 in the second lens group G2, both surfaces of the biconvex positive lens L7 in the third lens group G3, and both surfaces of the positive meniscus lens L10 having a convex surface directed toward the object side in the fourth lens group G4.

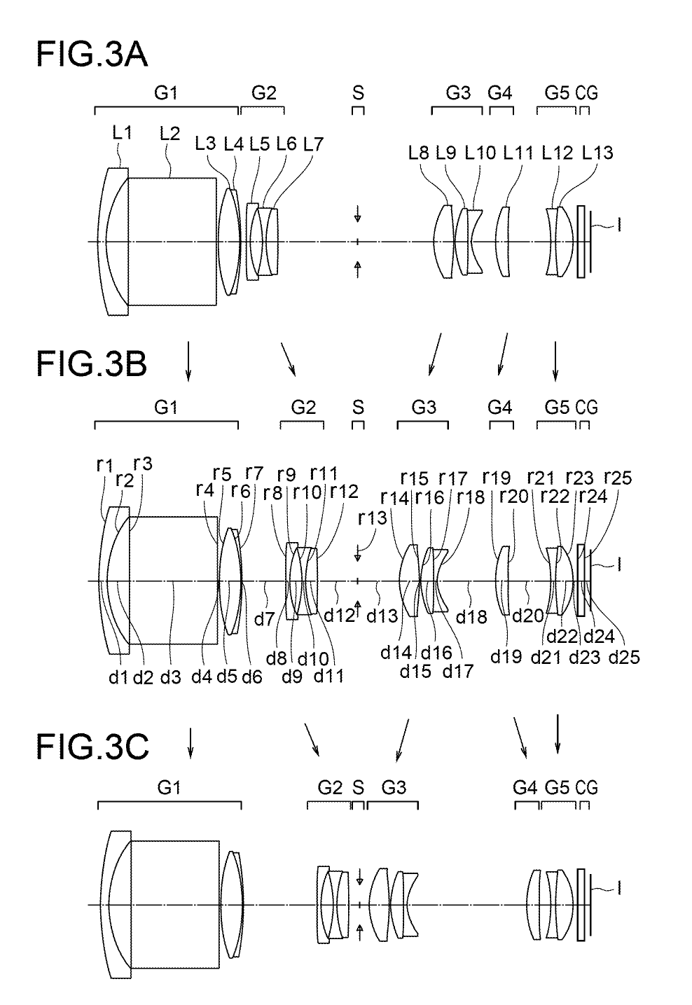

Next, a zoom lens according to embodiment 2 of the present invention will be described. FIGS. 3A, 3B, and 3C are cross sectional views taken along the optical axis showing the optical configuration of the zoom lens according to embodiment 2 of the present invention in the state in which the zoom lens is focused on an object point at infinity, where FIG. 3A is a cross sectional view of the zoom lens at the wide angle end, FIG. 3B is a cross sectional view of the zoom lens at an intermediate focal length position, and FIG. 3C is a cross sectional view of the zoom lens at the telephoto end.

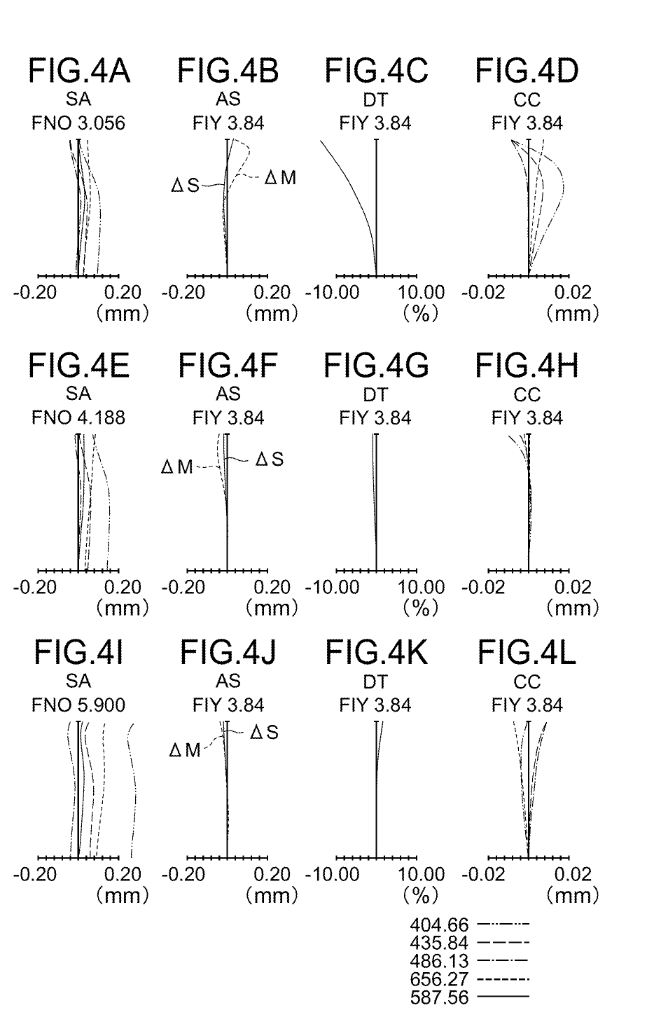

FIGS. 4A, 4B, 4C, 4D, 4E, 4F, 4G, 4H, 4I, 4J, 4K and 4L are diagrams showing spherical aberration (SA), astigmatism (AS), distortion (DT), and chromatic aberration of magnification (CC) of the zoom lens according to embodiment 2 in the state in which the zoom lens is focused on an object point at infinity, where FIGS. 4A, 4B, 4C, 4D are for the wide angle end, FIGS. 4E, 4F, 4G, 4H are for the intermediate focal length position, and FIGS. 4I, 4J, 4K, 4L are for the telephoto end.

As shown in FIGS. 3A, 3B, and 3C, the zoom lens according to embodiment 2 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a negative meniscus lens L1 having a convex surface directed toward the object side, a prism L2, and a cemented lens made up of a biconvex positive lens L3 and a negative meniscus lens L4 having a convex surface directed toward the image side. The first lens group G1 has a positive refracting power as a whole. In this configuration, the negative meniscus lens L4 having a convex surface directed toward the image side constitutes the lens LA, and the biconvex positive lens L3 constitutes the lens LB.

The second lens group G2 is composed of a negative meniscus lens L5 having a convex surface directed toward the object side, and a cemented lens made up of a biconcave negative lens L6 and a biconvex positive lens L7. The second lens group G2 has a negative refracting power as a whole.

The third lens group G3 is composed of a biconvex positive lens L8, and a cemented lens made up of a biconvex positive lens L9 and a biconcave negative lens L10 The third lens group G3 has a positive refracting power as a whole.

The fourth lens group G4 is composed of a positive meniscus lens L11 having a convex surface directed toward the object side. The fourth lens group G4 has a positive refracting power as a whole.

The fifth lens group G5 is composed of a cemented lens made up of a biconcave negative lens L12 and a biconvex positive lens L13 The fifth lens group G5 has a positive refracting power as a whole.

During zooming from the wide angle end to the telephoto end, the first lens group G1 is fixed, the second lens group G2 moves toward the image side, the aperture stop S is fixed, the third lens group G3 moves toward the object side, the fourth lens group G4 moves toward the object side during zooming from the wide angle end to the intermediate focal length position and moves toward the image side during zooming from the intermediate focal length position to the telephoto end, and the fifth lens group G5 is fixed.

There are eight aspheric surfaces in total, which include both surfaces of the biconvex positive lens L3 in the first lens group G1, the image side surface of the negative meniscus lens L4 having a convex surface directed toward the image side in the first lens group G1, the image side surface of the negative meniscus lens L5 having a convex surface directed toward the object side in the second lens group G2, both surfaces of the biconvex positive lens L8 in the third lens group G3, the object side surface of the positive meniscus lens L11 having a convex surface directed toward the object side in the fourth lens group G4, and the object side surface of the biconcave negative lens L12 in the fifth lens group G5.

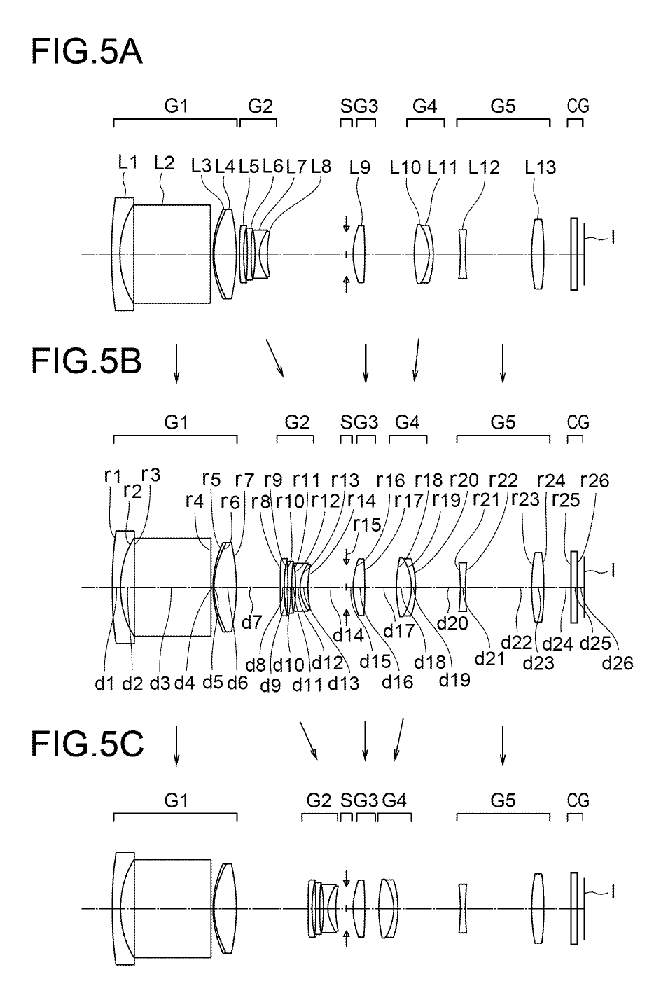

Next, a zoom lens according to embodiment 3 of the present invention will be described. FIGS. 5A, 5B, and 5C are cross sectional views taken along the optical axis showing the optical configuration of the zoom lens according to embodiment 3 of the present invention in the state in which the zoom lens is focused on an object point at infinity, where FIG. 5A is a cross sectional view of the zoom lens at the wide angle end, FIG. 5B is a cross sectional view of the zoom lens at an intermediate focal length position, and FIG. 5C is a cross sectional view of the zoom lens at the telephoto end.

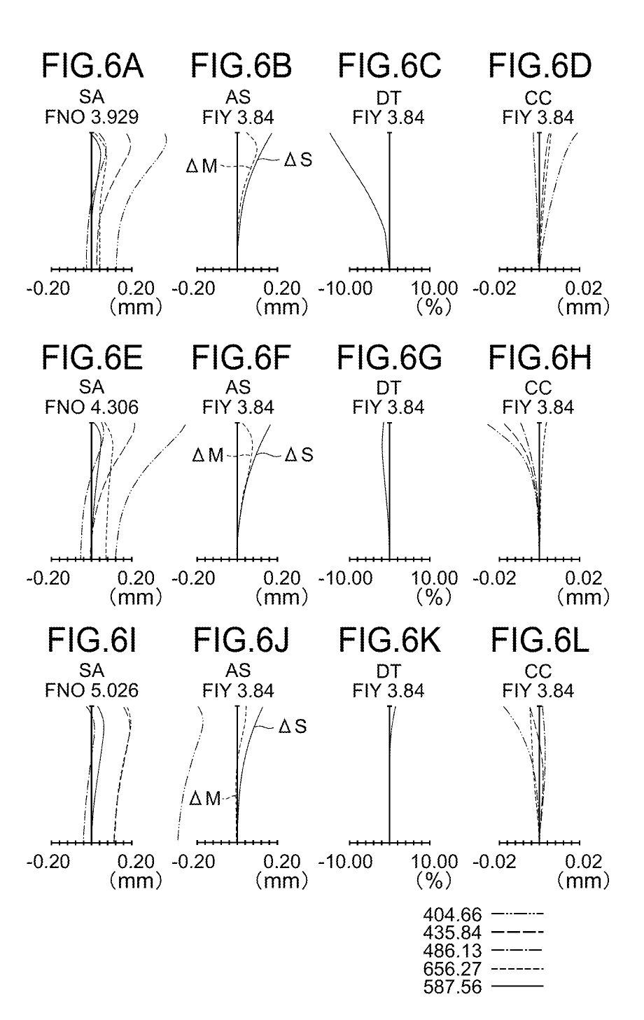

FIGS. 6A, 6B, 6C, 6D, 6E, 6F, 6G, 6H, 6I, 6J, 6K and 6L are diagrams showing spherical aberration (SA), astigmatism (AS), distortion (DT), and chromatic aberration of magnification (CC) of the zoom lens according to embodiment 3 in the state in which the zoom lens is focused on an object point at infinity, where FIGS. 6A, 6B, 6C, 6D are for the wide angle end, FIGS. 6E, 6F, 6G, 6H are for the intermediate focal length position, and FIGS. 6I, 6J, 6K, 6L are for the telephoto end.

As shown in FIGS. 5A, 5B, and 5C, the zoom lens according to embodiment 3 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a negative meniscus lens L1 having a convex surface directed toward the object side, a prism L2, and a cemented lens made up of a negative meniscus lens L3 having a convex surface directed toward the object side and a biconvex positive lens L4. The first lens group G1 has a positive refracting power as a whole. In this configuration, the negative meniscus lens L3 having a convex surface directed toward the object side constitutes the lens LA, and the biconvex positive lens L4 constitutes the lens LB.

The second lens group G2 is composed of a negative meniscus lens L5 having a convex surface directed toward the object side, a biconcave negative lens L6, and a cemented lens made up of a biconcave negative lens L7 and a positive meniscus lens L8 having a convex surface directed toward the object side. The second lens group G2 has a negative refracting power as a whole.

The third lens group G3 is composed of a biconvex positive lens L9. The third lens group G3 has a positive refracting power as a whole.

The fourth lens group G4 is composed of a biconvex positive lens L10 and a negative meniscus lens L11 having a convex surface directed toward the image side. The fourth lens group G4 has a positive refracting power as a whole.

The fifth lens group G5 is composed of a biconcave negative lens L12 and a biconvex positive lens L13. The fifth lens group G5 has a negative refracting power as a whole.

During zooming from the wide angle end to the telephoto end, the first lens group G1 is fixed, the second lens group G2 moves toward the image side, the aperture stop S is fixed, the third lens group G3 is fixed, the fourth lens group G4 moves toward the object side, and the fifth lens group G5 is fixed.

There are four aspheric surfaces in total, which include the object side surface of the negative meniscus lens L3 having a convex surface directed toward the object side in the first lens group G1, the object side surface of the biconvex positive lens L9 in the third lens group G3, the object side surface of the biconvex positive lens L10 in the fourth lens group G4, and the object side surface of the biconvex positive lens L13 in the fifth lens group G5.

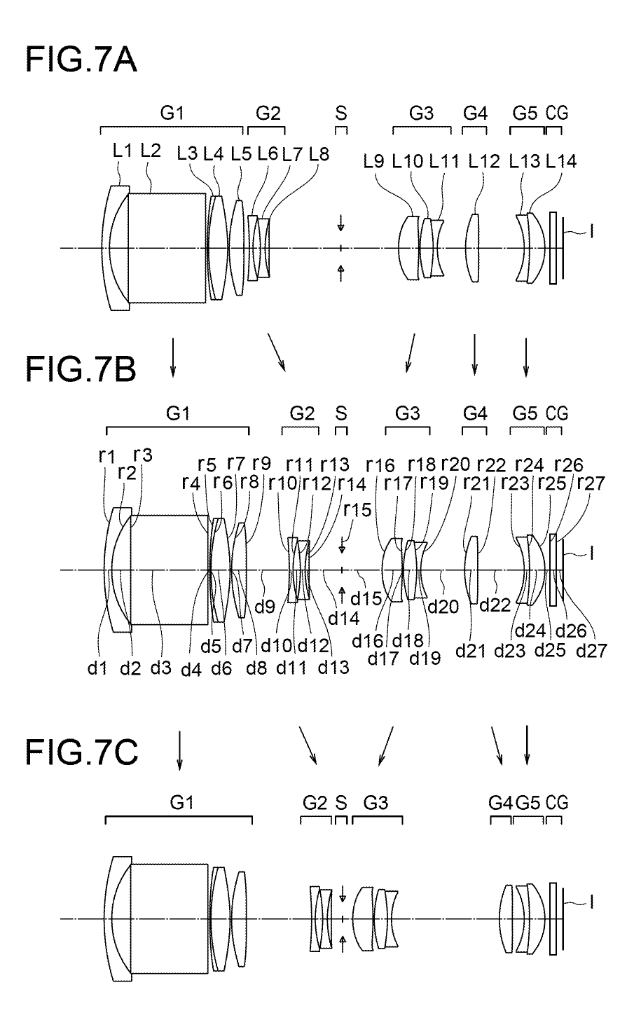

Next, a zoom lens according to embodiment 4 of the present invention will be described. FIGS. 7A, 7B, and 7C are cross sectional views taken along the optical axis showing the optical configuration of the zoom lens according to embodiment 4 of the present invention in the state in which the zoom lens is focused on an object point at infinity, where FIG. 7A is a cross sectional view of the zoom lens at the wide angle end, FIG. 7B is a cross sectional view of the zoom lens at an intermediate focal length position, and FIG. 7C is a cross sectional view of the zoom lens at the telephoto end.

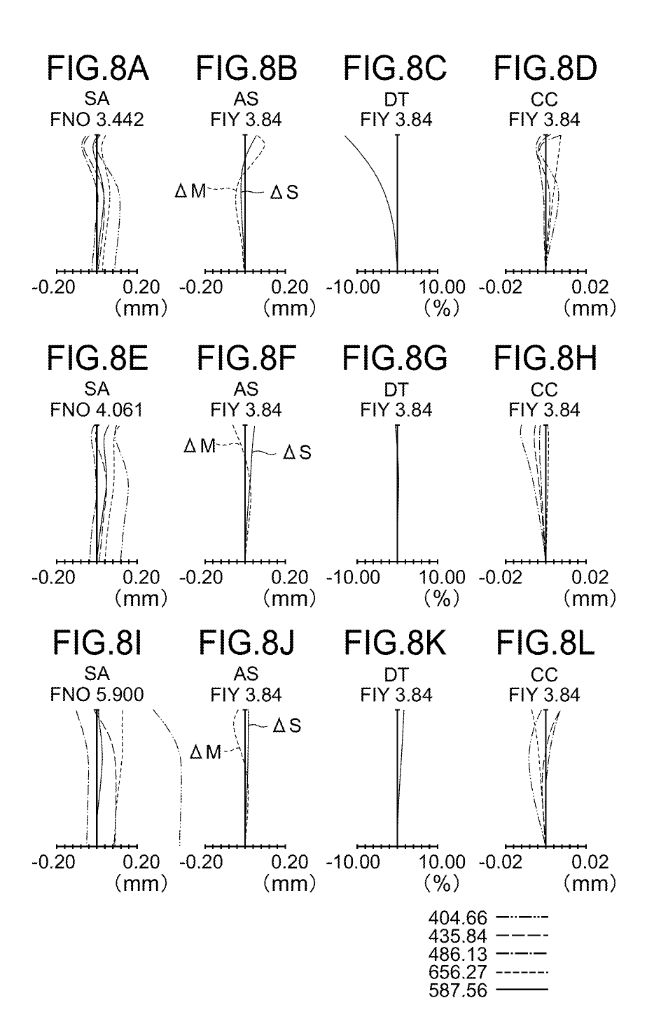

FIGS. 8A, 8B, 8C, 8D, 8E, 8F, 8G, 8H, 8I, 8J, 8K and 8L are diagrams showing spherical aberration (SA), astigmatism (AS), distortion (DT), and chromatic aberration of magnification (CC) of the zoom lens according to embodiment 4 in the state in which the zoom lens is focused on an object point at infinity, where FIGS. 8A, 8B, 8C, 8D are for the wide angle end, FIGS. 8E, 8F, 8G, 8H are for the intermediate focal length position, and FIGS. 8I, 8J, 8K, 8L are for the telephoto end.

As shown in FIGS. 7A, 7B, and 7C, the zoom lens according to embodiment 4 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a negative meniscus lens L1 having a convex surface directed toward the object side, a prism L2, a cemented lens made up of a negative meniscus lens L3 having a convex surface directed toward the object side and a biconvex positive lens L4, and a biconvex positive lens L5. The first lens group G1 has a positive refracting power as a whole. In this configuration, the negative meniscus lens L3 having a convex surface directed toward the object side constitutes the lens LA, and the biconvex positive lens L4 constitutes the lens LB.

The second lens group G2 is composed of a biconcave negative lens L6, and a cemented lens made up of a biconcave negative lens L7 and a positive meniscus lens L8 having a convex surface directed toward the object side. The second lens group G2 has a negative refracting power as a whole. In this configuration, the positive meniscus lens L8 having a convex surface directed toward the object side constitutes the lens LC, and the biconcave negative lens L7 constitutes the lens LD.

The third lens group G3 is composed of a biconvex positive lens L9, and a cemented lens made up of a biconvex positive lens L10 and a biconcave negative lens L11. The third lens group G3 has a positive refracting power as a whole.

The fourth lens group G4 is composed of a biconvex positive lens L12. The fourth lens group G4 has a positive refracting power as a whole.

The fifth lens group G5 is composed of a cemented lens made up of a negative meniscus lens L13 having a convex surface directed toward the image side and a positive meniscus lens L14 having a convex surface directed toward the image side. The fifth lens group G5 has a negative refracting power as a whole.

During zooming from the wide angle end to the telephoto end, the first lens group G1 is fixed, the second lens group G2 moves toward the image side, the aperture stop S is fixed, the third lens group G3 moves toward the object side, the fourth lens group G4 slightly moves toward the object side during zooming from the wide angle end to the intermediate focal length position and moves toward the image side during zooming from the intermediate focal length position to the telephoto end, and the fifth lens group G5 is fixed.

There are nine aspheric surfaces in total, which include the object side surface of the negative meniscus lens L3 having a convex surface directed toward the object side in the first lens group G1, both surfaces of the biconvex positive lens L4 in the first lens group G1, both surfaces of the biconcave negative lens L7 in the second lens group G2, the image side surface of the positive meniscus lens L8 having a convex surface directed toward the object side in the second lens group G2, both surfaces of the biconvex positive lens L9 in the third lens group G3, and the object side surface of the biconvex positive lens L12 in the fourth lens group G4.

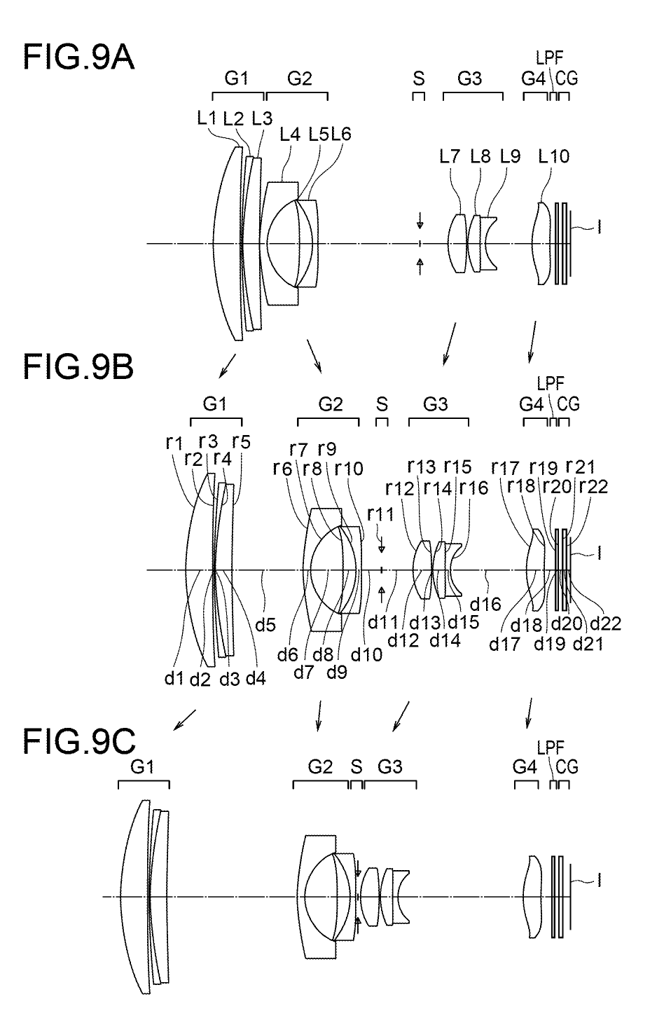

Next, a zoom lens according to embodiment 5 of the present invention will be described. FIGS. 9A, 9B, and 9C are cross sectional views taken along the optical axis showing the optical configuration of the zoom lens according to embodiment 5 of the present invention in the state in which the zoom lens is focused on an object point at infinity, where FIG. 9A is a cross sectional view of the zoom lens at the wide angle end, FIG. 9B is a cross sectional view of the zoom lens at an intermediate focal length position, and FIG. 9C is a cross sectional view of the zoom lens at the telephoto end.

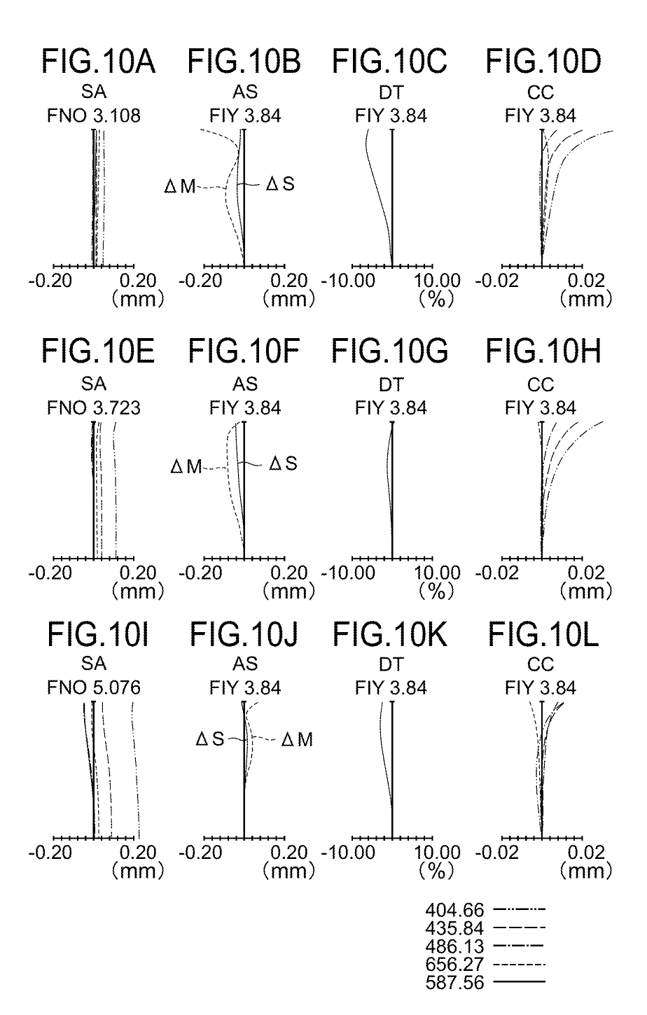

FIGS. 10A, 10B, 10C, 10D, 10E, 10F, 10G, 10H, 10I, 10J, 10K and 10L are diagrams showing spherical aberration (SA), astigmatism (AS), distortion (DT), and chromatic aberration of magnification (CC) of the zoom lens according to embodiment 5 in the state in which the zoom lens is focused on an object point at infinity, where FIGS. 10A, 10B, 10C, 10D are for the wide angle end, FIGS. 10E, 10F, 10G, 10H are for the intermediate focal length position, and FIGS. 10I, 10J, 10K, 10L are for the telephoto end.

As shown in FIGS. 9A, 9B, and 9C, the zoom lens according to embodiment 5 includes, in order from its object side, a first lens group G1 having a positive refracting power, a second lens group G2 having a negative refracting power, an aperture stop S, a third lens group G3 having a positive refracting power, and a fourth lens group G4 having a positive refracting power.

The first lens group G1 is composed of a positive meniscus lens L1 having a convex surface directed toward the object side, and a cemented lens made up of a negative meniscus lens L2 having a convex surface directed toward the object side and a positive meniscus lens L3 having a convex surface directed toward the object side. The first lens group G1 has a positive refracting power as a whole. In this configuration, the negative meniscus lens L2 having a convex surface directed toward the object side constitutes the lens LA, and the positive meniscus lens L3 having a convex surface directed toward the object side constitutes the lens LB.

The second lens group G2 is composed of a negative meniscus lens L4 having a convex surface directed toward the object side, and a cemented lens made up of a positive meniscus lens L5 having a convex surface directed toward the image side and a biconcave negative lens L6. The second lens group G2 has a negative refracting power as a whole. In this configuration, the positive meniscus lens L5 having a convex surface directed toward the image side constitutes the lens LC, and the biconcave negative lens L6 constitutes the lens LD.

The third lens group G3 is composed of a biconvex positive lens L7, and a cemented lens made up of a biconvex positive lens L8 and a biconcave negative lens L9. The third lens group G3 has a positive refracting power as a whole.

The fourth lens group G4 is composed of a positive meniscus lens L10 having a convex surface directed toward the object side. The fourth lens group G4 has a positive refracting power as a whole.

During zooming from the wide angle end to the telephoto end, the first lens group G1 moves toward the object side, the second lens group G2 moves toward the image side during zooming from the wide angle end to the intermediate focal length position and moves toward the object side during zooming from the intermediate focal length position to the telephoto end, the aperture stop S moves toward the object side, the third lens group G3 moves toward the object side, and the fourth lens group G4 moves toward the object side during zooming from the wide angle end to the intermediate focal length position and is substantially fixed during zooming from the intermediate focal length position to the telephoto end.

There are eight aspheric surfaces in total, which include the object side surface of the positive meniscus lens L3 having a convex surface directed toward the object side in the first lens group G1, the object side surface of the negative meniscus lens L4 having a convex surface directed toward the object side in the second lens G2, the object side surface of the positive meniscus lens L5 having a convex surface directed toward the image side in the second lens group G2, the image side surface of the biconcave negative lens L6 in the second lens group G2, both surfaces of the biconvex positive lens L7 in the third lens group G3, and both surfaces of the positive meniscus lens L10 having a convex surface directed toward the object side in the fourth lens group G4.

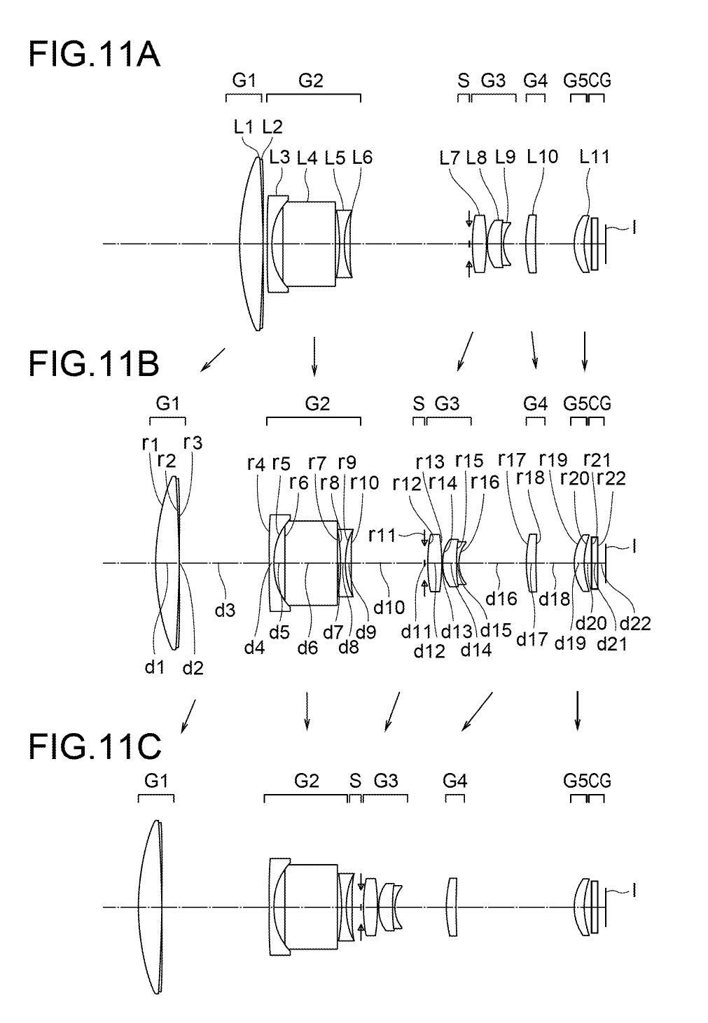

Next, a zoom lens according to embodiment 6 of the present invention will be described. FIGS. 11A, 11B, and 11C are cross sectional views taken along the optical axis showing the optical configuration of the zoom lens according to embodiment 6 of the present invention in the state in which the zoom lens is focused on an object point at infinity, where FIG. 11A is a cross sectional view of the zoom lens at the wide angle end, FIG. 11B is a cross sectional view of the zoom lens at an intermediate focal length position, and FIG. 11C is a cross sectional view of the zoom lens at the telephoto end.

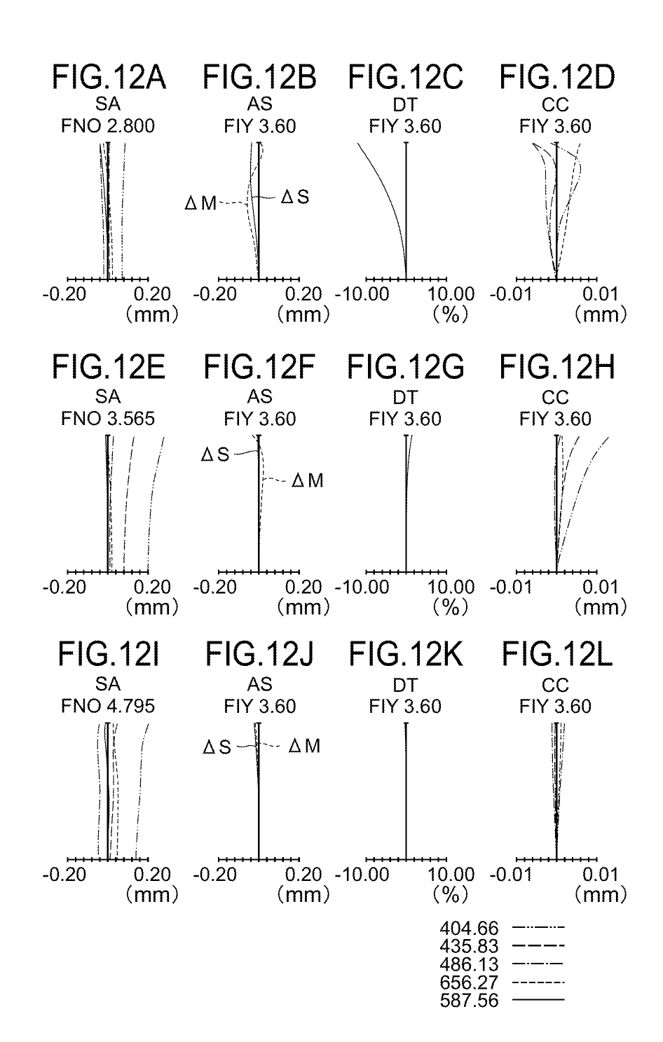

FIGS. 12A, 12B, 12C, 12D, 12E, 12F, 12G, 12H, 12I, 12J, 12K and 12L are diagrams showing spherical aberration (SA), astigmatism (AS), distortion (DT), and chromatic aberration of magnification (CC) of the zoom lens according to embodiment 6 in the state in which the zoom lens is focused on an object point at infinity, where FIGS. 12A, 12B, 12C, 12D are for the wide angle end, FIGS. 12E, 12F, 12G, 12H are for the intermediate focal length position, and FIGS. 12I, 12J, 12K, 12L are for the telephoto end.

As shown in FIGS. 11A, 11B, and 11C, the zoom lens according to embodiment 6 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a positive refracting power.

The first lens group G1 is composed of a cemented lens made up of a biconvex positive lens L1 and a negative meniscus lens L2 having a convex surface directed toward the image side. The first lens group G1 has a positive refracting power as a whole. In this configuration, the negative meniscus lens L2 having a convex surface directed toward the image side constitutes the lens LA, and the biconvex positive lens L1 constitutes the lens LB.

The second lens group G2 is composed of a negative meniscus lens L3 having a convex surface directed toward the object side, a prism L4, and a cemented lens made up of a biconcave negative lens L5 and a positive meniscus lens L6 having a convex surface directed toward the object side. The second lens group G2 has a negative refracting power as a whole. In this configuration, the positive meniscus lens L6 having a convex surface directed toward the object side constitutes the lens LC, and the biconcave negative lens L5 constitutes the lens LD.

The third lens group G3 is composed of a biconvex positive lens L7, and a cemented lens made up of a positive meniscus lens L8 having a convex surface directed toward the object side and a negative meniscus lens L9 having a convex surface directed toward the object side. The third lens group G3 has a positive refracting power as a whole.

The fourth lens group G4 is composed of a positive meniscus lens L10 having a convex surface directed toward the object side. The fourth lens group G4 has a positive refracting power as a whole.

The fifth lens group G5 is composed of a positive meniscus lens L11 having a convex surface directed toward the object side. The fifth lens group G5 has a positive refracting power as a whole.

During zooming from the wide angle end to the telephoto end, the first lens group G1 moves toward the object side, the second lens group G2 is fixed, the aperture stop S moves toward the object side together with the third lens group G3, the fourth lens group G4 moves slightly toward the image side during zooming from the wide angle end to the intermediate focal length position and moves toward the object side during zooming from the intermediate focal length position to the telephoto end, and the fifth lens group G5 is fixed.

There are five aspheric surfaces in total, which include the image side surface of the negative meniscus lens having a convex surface directed toward the object side in the first lens group G1, the object side surface of the biconcave negative lens L5 in the second lens group G2, the image side surface of the positive meniscus lens L6 having a convex surface directed toward the object side in the second lens group G2, the object side surface of the biconvex positive lens L7 in the third lens group G3, and the image side surface of the positive meniscus lens L11 having a convex surface directed toward the object side in the fifth lens group G5.

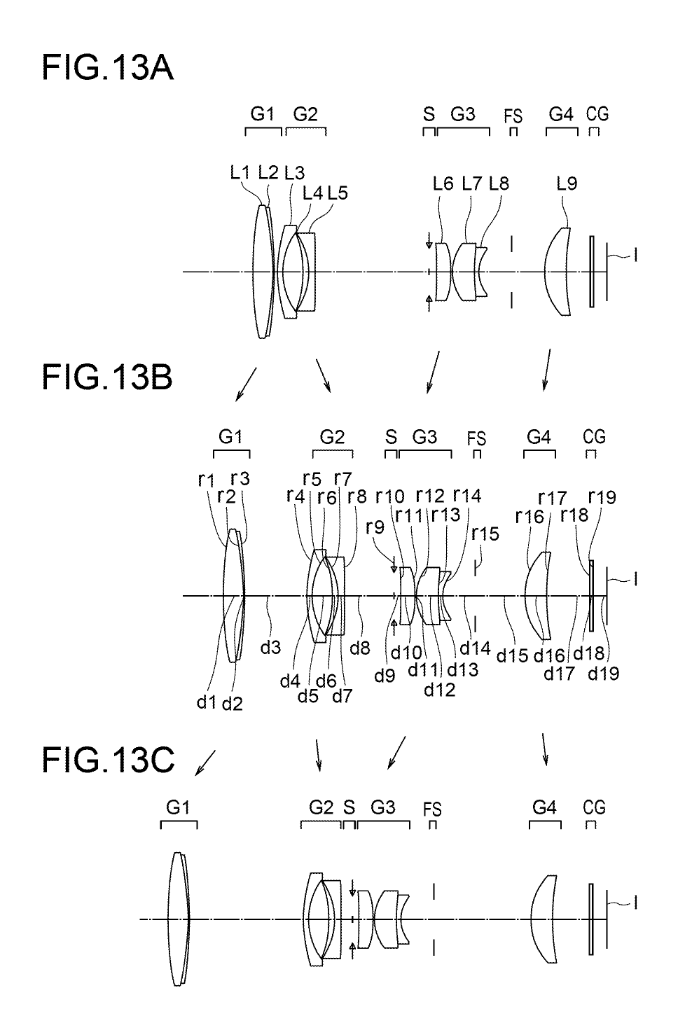

Next, a zoom lens according to embodiment 7 of the present invention will be described. FIGS. 13A, 13B, and 13C are cross sectional views taken along the optical axis showing the optical configuration of the zoom lens according to embodiment 7 of the present invention in the state in which the zoom lens is focused on an object point at infinity, where FIG. 13A is a cross sectional view of the zoom lens at the wide angle end, FIG. 13B is a cross sectional view of the zoom lens at an intermediate focal length position, and FIG. 13C is a cross sectional view of the zoom lens at the telephoto end.

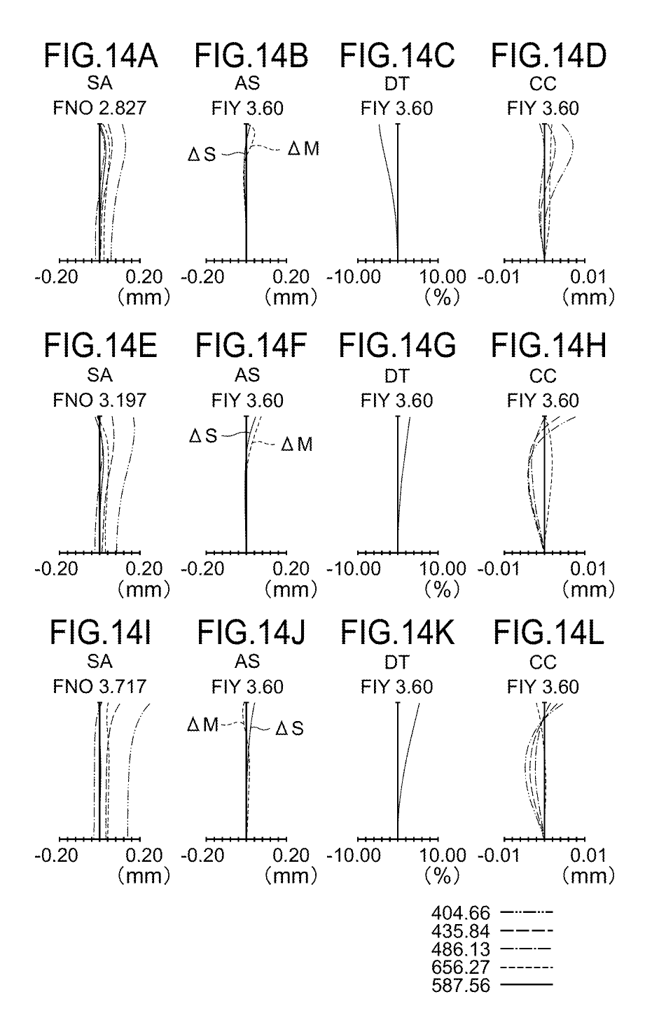

FIGS. 14A, 14B, 14C, 14D, 14E, 14F, 14G, 14H, 14I, 14J, 14K and 14L are diagrams showing spherical aberration (SA), astigmatism (AS), distortion (DT), and chromatic aberration of magnification (CC) of the zoom lens according to embodiment 7 in the state in which the zoom lens is focused on an object point at infinity, where FIGS. 14A, 14B, 14C, 14D are for the wide angle end, FIGS. 14E, 14F, 14G, 14H are for the intermediate focal length position, and FIGS. 14I, 14J, 14K, 14L are for the telephoto end.

As shown in FIGS. 13A, 13B, and 13C, the zoom lens according to embodiment 7 includes, in order from its object side, a first lens group G1 having a positive refracting power, a second lens group G2 having a negative refracting power, an aperture stop S, a third lens group G3 having a positive refracting power, a flare stop FS, and a fourth lens group G4 having a positive refracting power. The flare stop may be eliminated from the optical system.

The first lens group G1 is composed of a cemented lens made up of a biconvex positive lens L1 and a negative meniscus lens L2 having a convex surface directed toward the image side. The first lens group G1 has a positive refracting power as a whole. In this configuration, the negative meniscus lens L2 having a convex surface directed toward the image side constitutes the lens LA, and the biconvex positive lens L1 constitutes the lens LB.

The second lens group G2 is composed of a negative meniscus lens L3 having a convex surface directed toward the object side, and a cemented lens made up of a positive meniscus lens L4 having a convex surface directed toward the image side and a biconcave negative lens L5. The second lens group G2 has a negative refracting power as a whole. In this configuration, the positive meniscus lens L4 having a convex surface directed toward the image side constitutes the lens LC, and the biconcave negative lens L5 constitutes the lens LD.

The third lens group G3 is composed of a positive meniscus lens L6 having a convex surface directed toward the object side, and a cemented lens made up of a positive meniscus lens L7 having a convex surface directed toward the object side and a negative meniscus lens L8 having a convex surface directed toward the object side. The third lens group G3 has a positive refracting power as a whole.

The fourth lens group G4 is composed of a positive meniscus lens L9 having a convex surface directed toward the object side. The fourth lens group G4 has a positive refracting power as a whole.

During zooming from the wide angle end to the telephoto end, the first lens group G1 moves toward the object side, the second lens group G2 moves toward the image side during zooming from the wide angle end to the intermediate focal length position and moves slightly toward the object side during zooming from the intermediate focal length position to the telephoto end, the aperture stop S moves toward the object side, the third lens group G3 moves toward the object side, and the fourth lens group G4 moves toward the object side during zooming from the wide angle end to the intermediate focal length position and moves toward the image side during zooming from the intermediate focal length position to the telephoto end.

There are nine aspheric surfaces in total, which include both surfaces of the biconvex positive lens L1 in the first lens group G1, the image side surface of the negative meniscus lens L2 having a convex surface directed toward the image side in the first lens group G1, both surfaces of the positive meniscus lens L4 having a convex surface directed toward the image side in the second lens group G2, the image side surface of the biconcave negative lens L5 in the second lens group G2, both surfaces of the positive meniscus lens L6 having a convex surface directed toward the image side in the third lens group G3, and the object side surface of the positive meniscus lens L9 having a convex surface directed toward the object side in the fourth lens group G4.

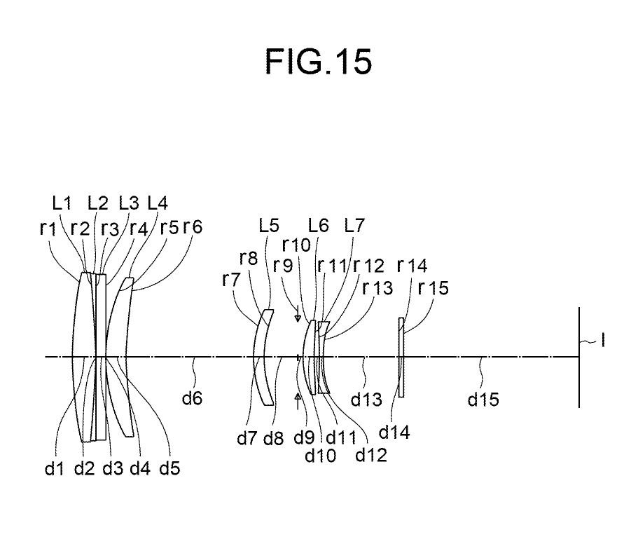

Next, a lens according to embodiment 8 of the present invention will be described. FIG. 15 is a cross sectional view taken along the optical axis showing the optical configuration of the lens according to embodiment 8 of the present invention in the state in which the lens is focused on an object point at infinity.

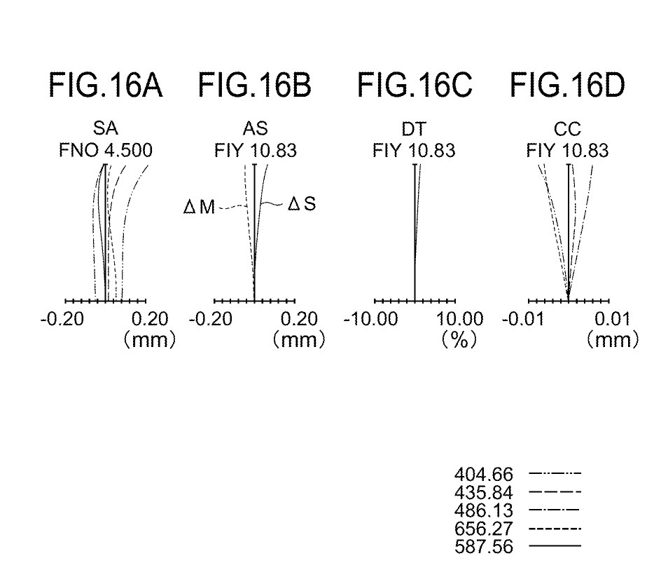

FIGS. 16A, 16B, 16C, 16D are a diagram showing spherical aberration (SA), astigmatism (AS), distortion (DT), and chromatic aberration of magnification (CC) of the lens according to embodiment 8 in the state in which the lens is focused on an object point at infinity.

As shown in FIG. 15, the lens according to embodiment 8 includes, in order from its object side, a cemented lens made up of a biconvex positive lens L1, a negative meniscus lens L2 having a convex surface directed toward the image side, and a biconcave negative lens L3, a positive meniscus lens L4 having a convex surface directed toward the object side, a positive meniscus lens L5 having a convex surface directed toward the object side, a positive meniscus lens L6 having a convex surface directed toward the object side, and a biconcave negative lens L7. In this configuration, the negative meniscus lens L2 having a convex surface directed toward the image side constitutes the lens LA, and the biconvex positive lens L1 constitutes the lens LB.

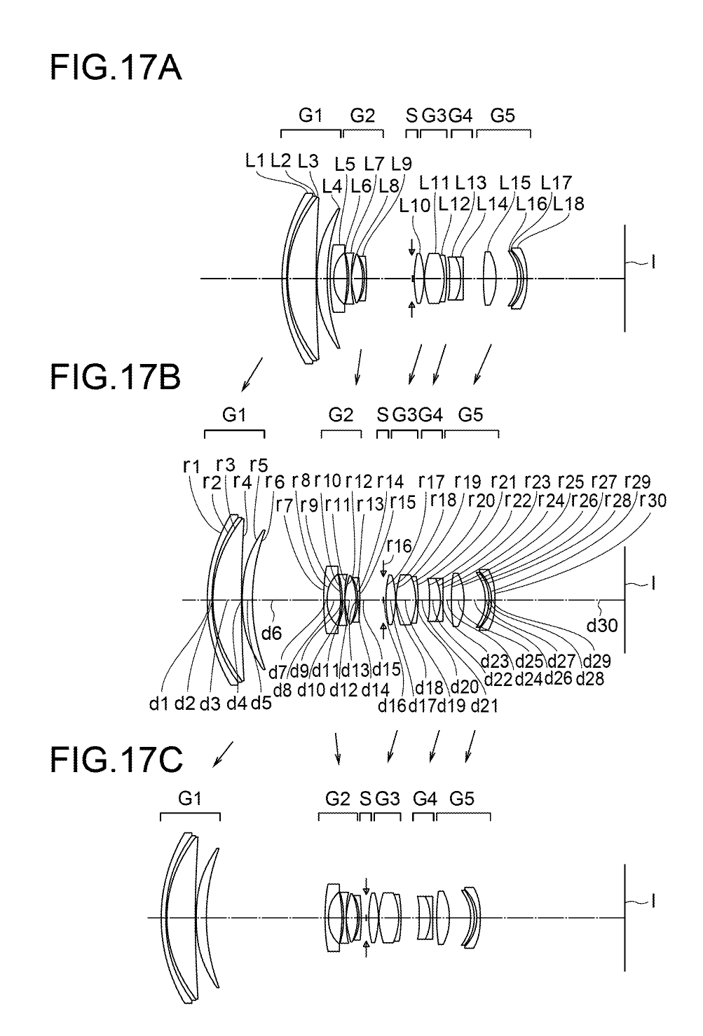

Next, a zoom lens according to embodiment 9 of the present invention will be described. FIGS. 17A, 17B, and 17C are cross sectional views taken along the optical axis showing the optical configuration of the zoom lens according to embodiment 9 of the present invention in the state in which the zoom lens is focused on an object point at infinity, where FIG. 17A is a cross sectional view of the zoom lens at the wide angle end, FIG. 17B is a cross sectional view of the zoom lens at an intermediate focal length position, and FIG. 17C is a cross sectional view of the zoom lens at the telephoto end.

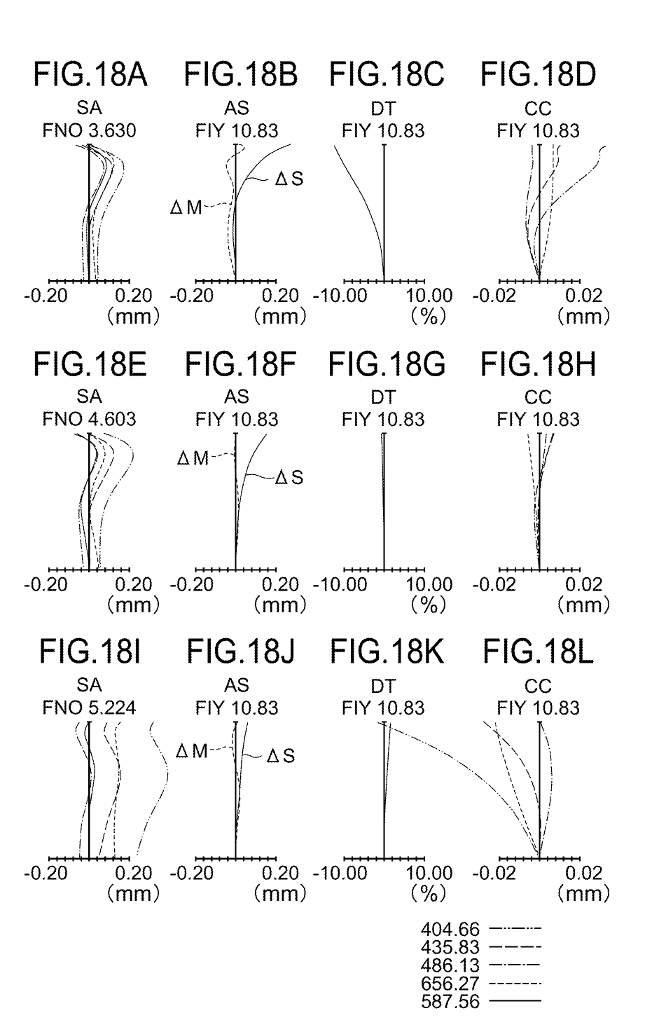

FIGS. 18, 18B, 18C, 18D, 18E, 18F, 18G, 18H, 18I, 18J, 18K and 18L are diagrams showing spherical aberration (SA), astigmatism (AS), distortion (DT), and chromatic aberration of magnification (CC) of the zoom lens according to embodiment 9 in the state in which the zoom lens is focused on an object point at infinity, where FIGS. 18A, 18B, 18C, 18D are for the wide angle end, FIGS. 18E, 18F, 18G, 18H are for the intermediate focal length position, and FIGS. 18I, 18J, 18K, 18L are for the telephoto end.

As shown in FIGS. 17A, 17B, and 17C, the zoom lens according to embodiment 9 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a positive refracting power.

The first lens group G1 is composed of a cemented lens made up of a negative meniscus lens L1 having a convex surface directed toward the object side, a negative meniscus lens L2 having a convex surface directed toward the object side, and a positive meniscus lens L3 having a convex surface directed toward the object side, and a positive meniscus lens L4 having a convex surface directed toward the object side. The first lens group G1 has a positive refracting power as a whole. In this configuration, the negative meniscus lens L2 having a convex surface directed toward the object side constitutes the lens LA, and the positive meniscus lens L3 having a convex surface directed toward the object side constitutes the lens LB.

The second lens group G2 is composed of a negative meniscus lens L5 having a convex surface directed toward the object side, a cemented lens made up of a positive meniscus lens L6 having a convex surface directed toward the image side and a biconcave negative lens L7, a biconvex positive lens L8, and a negative meniscus lens L9 having a convex surface directed toward the image side. The second lens group G2 has a negative refracting power as a whole. In this configuration, the positive meniscus lens L6 having a convex surface directed toward the image side constitutes the lens LC, and the biconcave negative lens L7 constitutes the lens LD.

The third lens group G3 is composed of a biconvex positive lens L10, and a cemented lens made up of a biconvex positive lens L11 and a negative meniscus lens L12 having a convex surface directed toward the image side. The third lens group G3 has a positive refracting power as a whole.

The fourth lens group G4 is composed of a cemented lens made up of a positive meniscus lens L13 having a convex surface directed toward the image side and a biconcave negative lens L14. The fourth lens group G4 has a negative refracting power as a whole.

The fifth lens group G5 is composed of a biconvex positive lens L15, and a cemented lens made up of a positive meniscus lens L16 having a convex surface directed toward the image side, a positive meniscus lens L17 having a convex surface directed toward the image side, and a negative meniscus lens L18 having a convex surface directed toward the image side. The fifth lens group G5 has a positive refracting power as a whole.

During zooming from the wide angle end to the telephoto end, the first lens group G1 moves toward the object side, the second lens group G2 moves toward the object side during zooming from the wide angle end to the intermediate focal length position and moves toward the image side during zooming from the intermediate focal length position to the telephoto end, the aperture stop S moves toward the object side, the third lens group G3 moves toward the object side, the fourth lens group G4 moves toward the object side, and the fifth lens group moves toward the object side.

There are nine aspheric surfaces in total, which include both surfaces of the positive meniscus lens L3 having a convex surface directed toward the object side in the first lens group G1, the object side surface of the negative meniscus lens L5 having a convex surface directed toward the object side in the second lens group G2, both surfaces of the negative meniscus lens L6 having a convex surface directed toward the image side in the second lens group G2, the image side surface of the biconcave negative lens L7 in the second lens group G2, the image side surface of the biconvex positive lens L15 in the fifth lens group G5, and both surfaces of the positive meniscus lens L16 having a convex surface directed toward the image side in the fifth lens group G5.

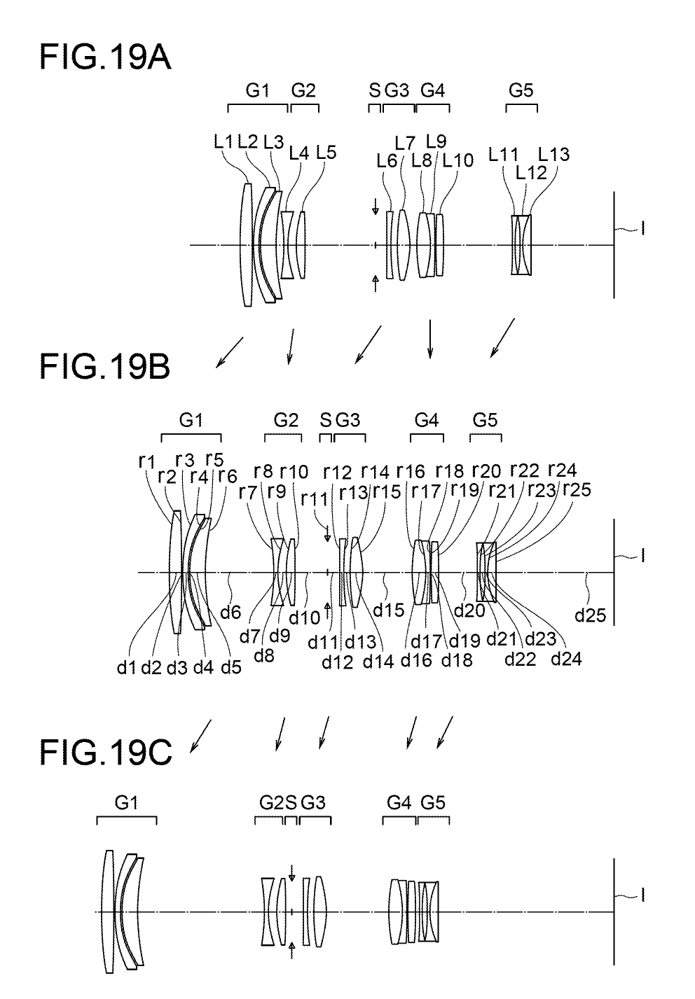

Next, a zoom lens according to embodiment 10 of the present invention will be described. FIGS. 19A, 19B, and 19C are cross sectional views taken along the optical axis showing the optical configuration of the zoom lens according to embodiment 10 of the present invention in the state in which the zoom lens is focused on an object point at infinity, where FIG. 19A is a cross sectional view of the zoom lens at the wide angle end, FIG. 19B is a cross sectional view of the zoom lens at an intermediate focal length position, and FIG. 19C is a cross sectional view of the zoom lens at the telephoto end.

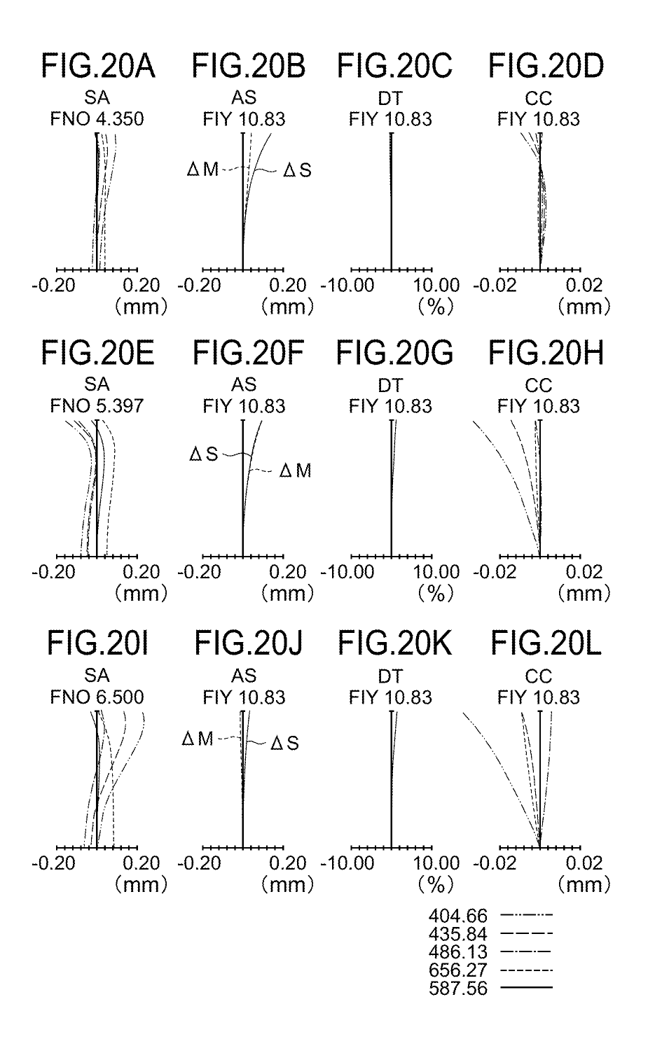

FIGS. 20A, 20B, 20C, 20D, 20E, 20F, 20G, 20H, 20I, 20J, 20K and 20L are diagrams showing spherical aberration (SA), astigmatism (AS), distortion (DT), and chromatic aberration of magnification (CC) of the zoom lens according to embodiment 10 in the state in which the zoom lens is focused on an object point at infinity, where FIGS. 20A, 20B, 20C, 20D are for the wide angle end, FIGS. 20E, 20F, 20G, 20H are for the intermediate focal length position, and FIGS. 20I, 20J, 20K, 20L are for the telephoto end.

As shown in FIGS. 19A, 19B, and 19C, the zoom lens according to embodiment 10 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a biconvex positive lens L1, a negative meniscus lens L2 having a convex surface directed toward the object side, and a positive meniscus lens L3 having a convex surface directed toward the object side. The first lens group G1 has a positive refracting power as a whole. In this configuration, the negative meniscus lens L2 having a convex surface directed toward the object side constitutes the lens LA.

The second lens group G2 is composed of a biconcave negative lens L4 and a biconvex positive lens L5. The second lens group G2 has a negative refracting power as a whole.

The third lens group G3 is composed of a biconcave negative lens L6 and a biconvex positive lens L7. The third lens group G3 has a positive refracting power as a whole.

The fourth lens group G4 is composed of a cemented lens made up of a biconvex positive lens L8 and a negative meniscus lens L9 having a convex surface directed toward the image side, and a biconvex positive lens L10. The fourth lens group G4 has a positive refracting power as a whole.

The fifth lens group G5 is composed of a biconcave negative lens L11, and a cemented lens made up of a biconcave negative lens L12 and a positive meniscus lens L13 having a convex surface directed toward the object side. The fifth lens group G5 has a negative refracting power as a whole.

During zooming from the wide angle end to the telephoto end, the first lens group G1 moves toward the object side, the second lens group G2 moves toward the object side, the aperture stop S moves toward the object side, the third lens group G3 moves toward the object side, the fourth lens group G4 moves toward the object side, and the fifth lens group G5 moves toward the object side.

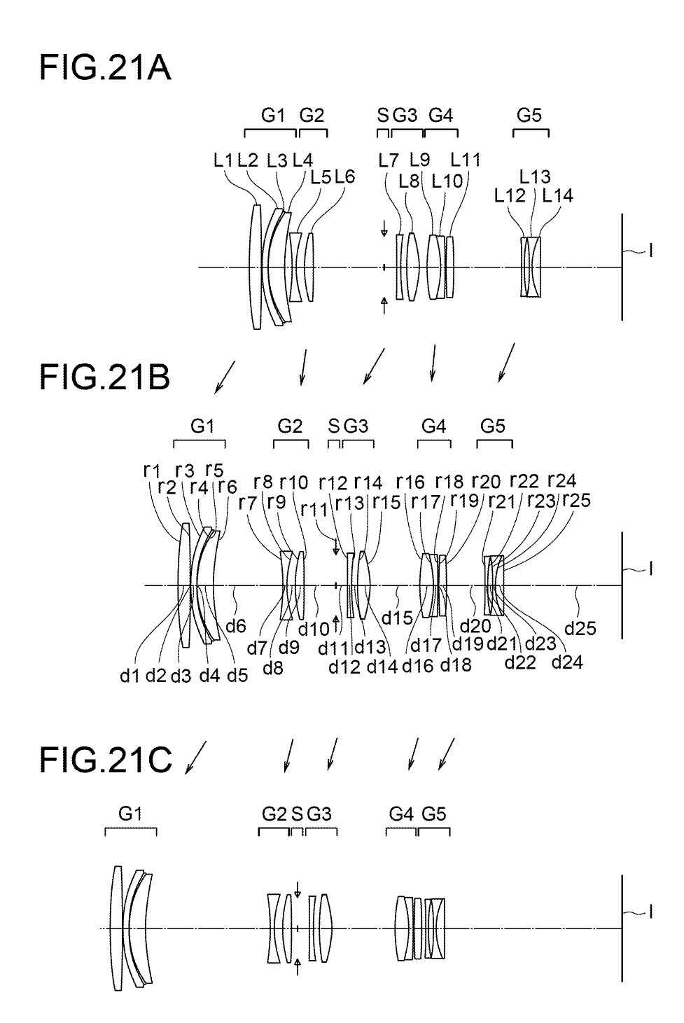

Next, a zoom lens according to embodiment 11 of the present invention will be described. FIGS. 21A, 21B, and 21C are cross sectional views taken along the optical axis showing the optical configuration of the zoom lens according to embodiment 11 of the present invention in the state in which the zoom lens is focused on an object point at infinity, where FIG. 21A is across sectional view of the zoom lens at the wide angle end, FIG. 21B is a cross sectional view of the zoom lens at an intermediate focal length position, and FIG. 21C is a cross sectional view of the zoom lens at the telephoto end.

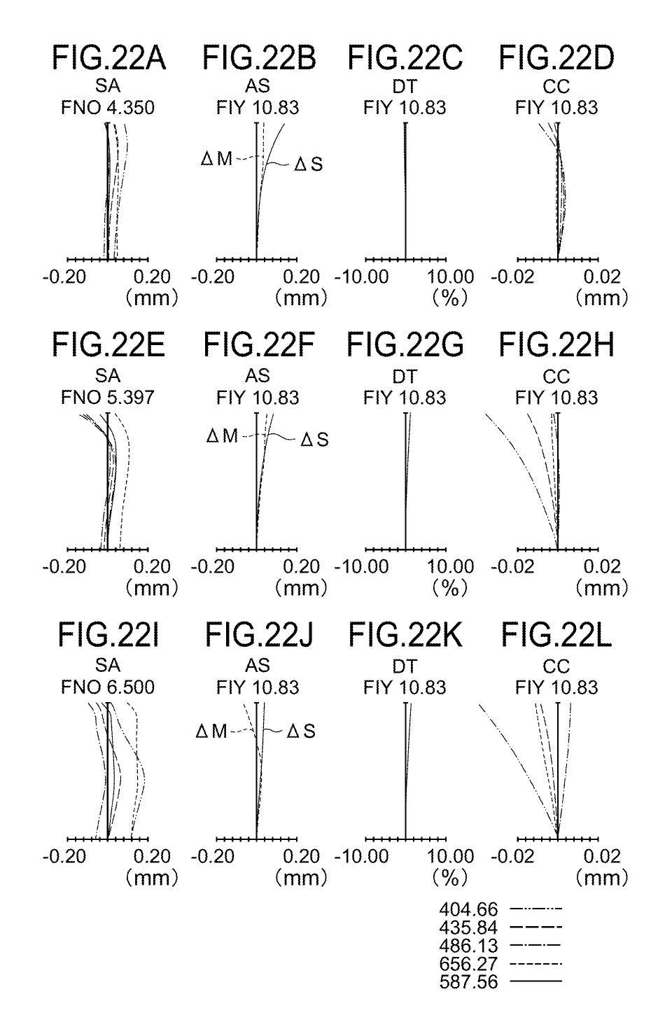

FIGS. 22A, 22B, 22C, 22D, 22E, 22F, 22G, 22H, 22I, 22J, 22K and 22L are diagrams showing spherical aberration (SA), astigmatism (AS), distortion (DT), and chromatic aberration of magnification (CC) of the zoom lens according to embodiment 11 in the state in which the zoom lens is focused on an object point at infinity, where FIGS. 22A, 22B, 22C, 22D are for the wide angle end, FIGS. 22E, 22F, 22G, 22H are for the intermediate focal length position, and FIGS. 22I, 22J, 22K, 22L are for the telephoto end.

As shown in FIGS. 21A, 21B, and 21C, the zoom lens according to embodiment 11 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a biconvex positive lens L1, and a cemented lens made up of a negative meniscus lens L2 having a convex surface directed toward the object side, a negative meniscus lens L3 having a convex surface directed toward the object side, and a positive meniscus lens L4 having a convex surface directed toward the object side. The first lens group G1 has a positive refracting power as a whole. In this configuration, the negative meniscus lens L3 having a convex surface directed toward the object side constitutes the lens LA, and a positive meniscus lens L4 having a convex surface directed toward the object side constitutes the lens LB.

The second lens group G2 is composed of a biconcave negative lens L5 and a biconvex positive lens L6. The second lens group G2 has a negative refracting power as a whole.

The third lens group G3 is composed of a biconcave negative lens L7 and a biconvex positive lens L8. The third lens group G3 has a positive refracting power as a whole.

The fourth lens group G4 is composed of a cemented lens made up a biconvex positive lens L9 and a negative meniscus lens L10 having a convex surface directed toward the image side, and a biconvex positive lens L11. The fourth lens group G4 has a positive refracting power as a whole.

The fifth lens group G5 is composed of a biconcave negative lens L12, and a cemented lens made up of a biconcave negative lens L13 and a positive meniscus lens L14 having a convex surface directed toward the object side. The fifth lens group G5 has a negative refracting power as a whole.

During zooming from the wide angle end to the telephoto end, the first lens group G1 moves toward the object side, the second lens group G2 moves toward the object side, the aperture stop S moves toward the object side, the third lens group G3 moves toward the object side, the fourth lens group G4 moves toward the object side, and the fifth lens group G5 moves toward the object side.

There are two aspheric surfaces in total, which include both surfaces of the positive meniscus lens L4 having a convex surface directed toward the object side in the first lens group G1.

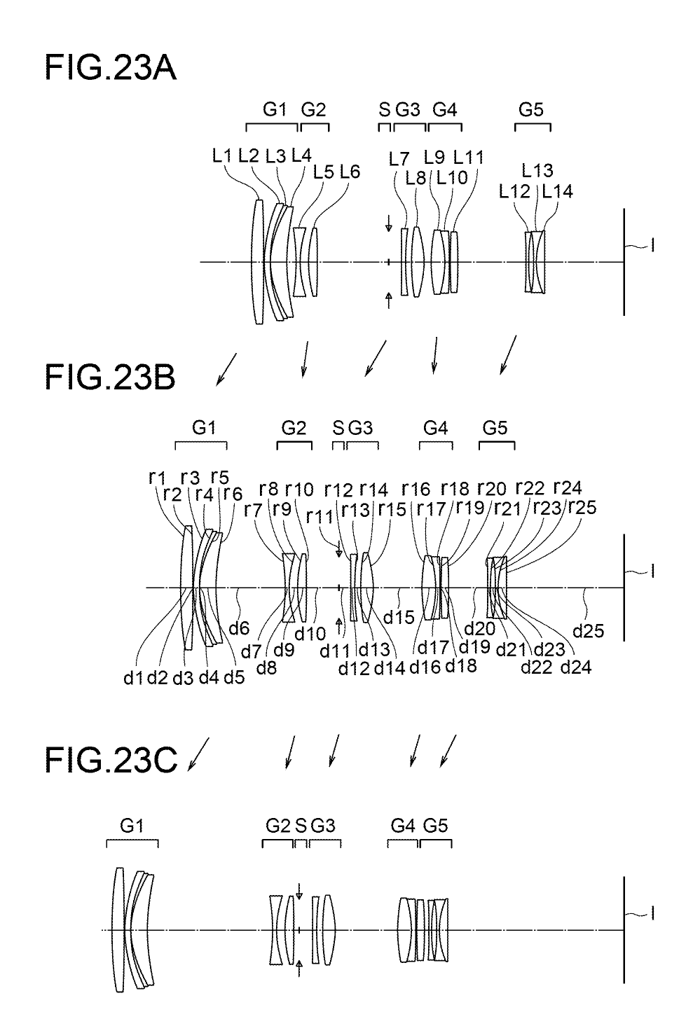

Next, a zoom lens according to embodiment 12 of the present invention will be described. FIGS. 23A, 23B, and 23C are cross sectional views taken along the optical axis showing the optical configuration of the zoom lens according to embodiment 12 of the present invention in the state in which the zoom lens is focused on an object point at infinity, where FIG. 23A is across sectional view of the zoom lens at the wide angle end, FIG. 23B is a cross sectional view of the zoom lens at an intermediate focal length position, and FIG. 23C is a cross sectional view of the zoom lens at the telephoto end.

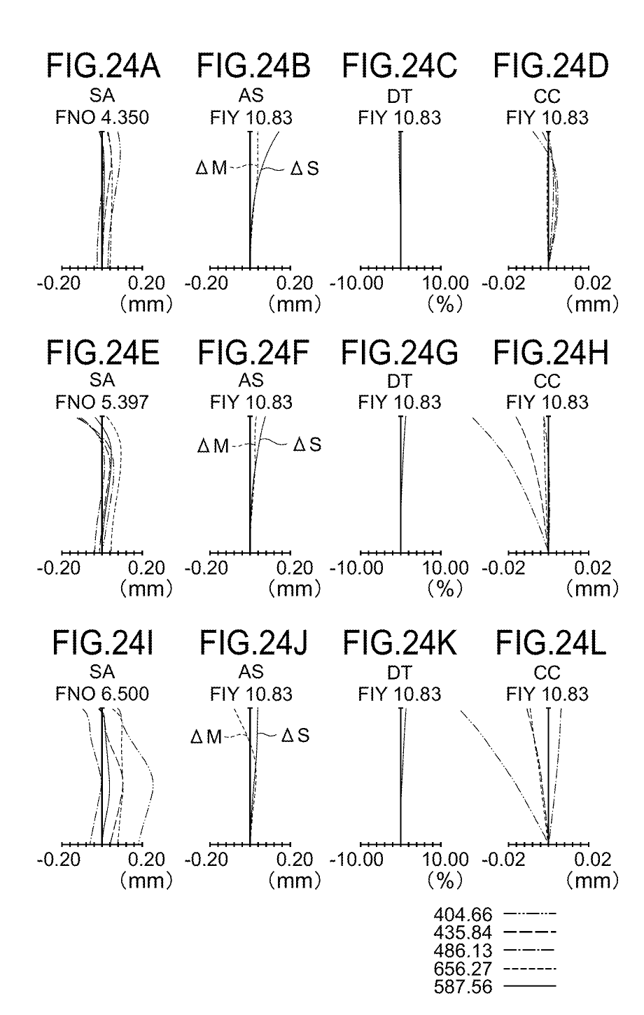

FIGS. 24A, 24B, 24C, 24D, 24E, 24F, 24G, 24H, 24I, 24J, 24K and 24L are diagrams showing spherical aberration (SA), astigmatism (AS), distortion (DT), and chromatic aberration of magnification (CC) of the zoom lens according to embodiment 12 in the state in which the zoom lens is focused on an object point at infinity, where FIGS. 24A, 24B, 24C, 24D are for the wide angle end, FIGS. 24E, 24F, 24G, 24H are for the intermediate focal length position, and FIGS. 24I, 24J, 24K, 24L are for the telephoto end.

As shown in FIGS. 23A, 23B, and 23C, the zoom lens according to embodiment 12 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a biconvex positive lens L1, and a cemented lens made up of a negative meniscus lens L2 having a convex surface directed toward the object side, a negative meniscus lens L3 having a convex surface directed toward the object side, and a positive meniscus lens L4 having a convex surface directed toward the object side. The first lens group G1 has a positive refracting power as a whole. In this configuration, the negative meniscus lens L3 having a convex surface directed toward the image side constitutes the lens LA, and the positive meniscus lens L4 having a convex surface directed toward the object side constitutes the lens LB.

The second lens group G2 is composed of a biconcave negative lens L5 and a biconvex positive lens L6. The second lens group G2 has a negative refracting power as a whole.

The third lens group G3 is composed of a biconcave negative lens L7 and a biconvex positive lens L8. The third lens group G3 has a positive refracting power as a whole.

The fourth lens group G4 is composed of a cemented lens made up of a biconvex positive lens L9 and a negative meniscus lens L10 having a convex surface directed toward the image side, and biconvex positive lens L11. The fourth lens group G4 has a positive refracting power as a whole.

The fifth lens group G5 is composed of a biconcave negative lens L12, and a cemented lens made up of a biconcave negative lens L13 and a positive meniscus lens L14 having a convex surface directed toward the object side. The fifth lens group G5 has a negative refracting power as a whole.

During zooming from the wide angle end to the telephoto end, the first lens group G1 moves toward the object side, the second lens group G2 moves toward the object side, the aperture stop S moves toward the object side, the third lens group G3 moves toward the object side, the fourth lens group G4 moves toward the object side, and the fifth lens group G5 moves toward the object side.

There are two aspheric surfaces in total, which include both surfaces of the positive meniscus lens L4 having a convex surface directed toward the object side in the first lens group G1.

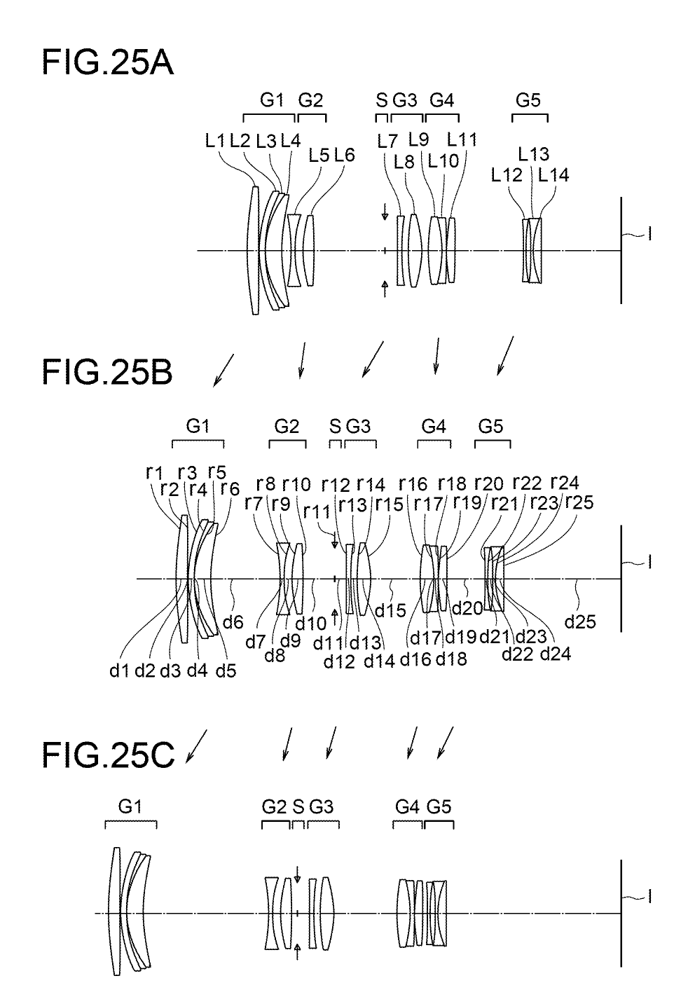

Next, a zoom lens according to embodiment 13 of the present invention will be described. FIGS. 25A, 25B, and 25C are cross sectional views taken along the optical axis showing the optical configuration of the zoom lens according to embodiment 13 of the present invention in the state in which the zoom lens is focused on an object point at infinity, where FIG. 25A is a cross sectional view of the zoom lens at the wide angle end, FIG. 25B is a cross sectional view of the zoom lens at an intermediate focal length position, and FIG. 25C is a cross sectional view of the zoom lens at the telephoto end.

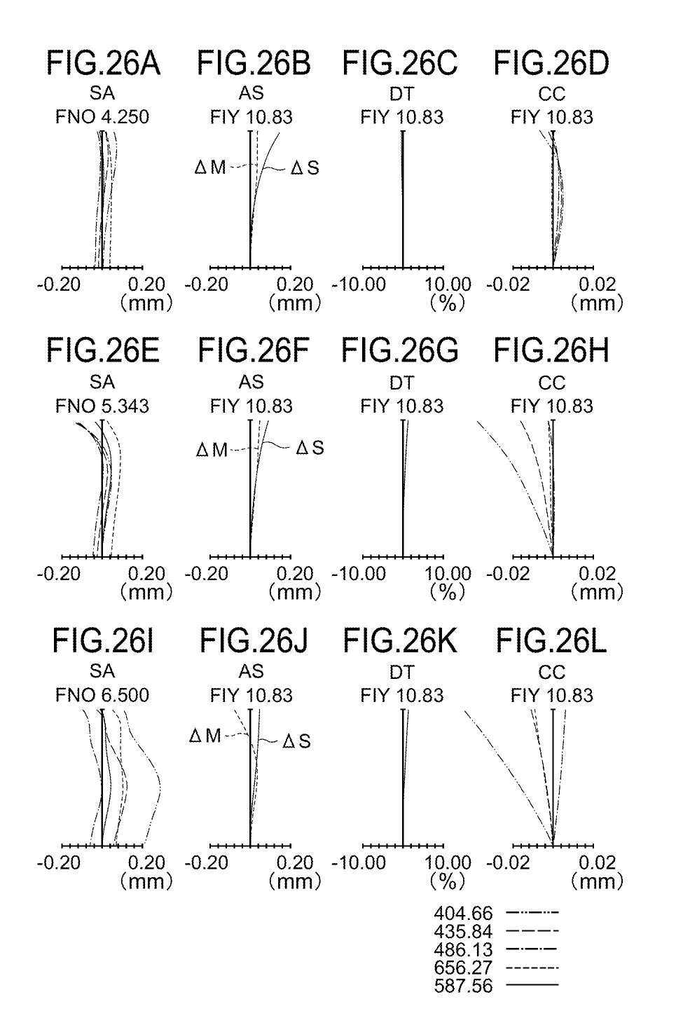

FIGS. 26A, 26B, 26C, 26D, 26E, 26F, 26G, 26H, 26I, 26J, 26K and 26L are diagrams showing spherical aberration (SA), astigmatism (AS), distortion (DT), and chromatic aberration of magnification (CC) of the zoom lens according to embodiment 13 in the state in which the zoom lens is focused on an object point at infinity, where FIGS. 26A, 26B, 26C, 2D are for the wide angle end, FIGS. 26E, 26F, 26G, 26H are for the intermediate focal length position, and FIGS. 26I, 26J, 26K, 26L are for the telephoto end.

As shown in FIGS. 25A, 25B, and 25C, the zoom lens according to embodiment 13 includes, in order from its object side, a first lens group G1 having a positive refracting power, a second lens group G2 having a negative refracting power, an aperture stop S, a third lens group G3 having a positive refracting power, a fourth lens group G4 having a positive refracting power, and a fifth lens group G5 having a negative refracting power.

The first lens group G1 is composed of a biconvex positive lens L1, and a cemented lens made up of a negative meniscus lens L2 having a convex surface directed toward the object side, a negative meniscus lens L3 having a convex surface directed toward the object side, and a positive meniscus lens L4 having a convex surface directed toward the object side. The first lens group G1 has a positive refracting power as a whole. In this configuration, the negative meniscus lens L3 having a convex surface directed toward the object side constitutes the lens LA, and the positive meniscus lens L4 having a convex surface directed toward the object side constitutes the lens LB.

The second lens group G2 is composed of a biconcave negative lens L5 and a biconvex positive lens L6. The second lens group G2 has a negative refracting power as a whole.

The third lens group G3 is composed of a biconcave negative lens L7 and a biconvex positive lens L8. The third lens group G3 has a positive refracting power as a whole.

The fourth lens group G4 is composed of a cemented lens made up of a biconvex positive lens L9 and a negative meniscus lens L10 having a convex surface directed toward the image side, and biconvex positive lens L11. The fourth lens group G4 has a positive refracting power as a whole.

The fifth lens group G5 is composed of a biconcave negative lens L12, and a cemented lens made up of a biconcave negative lens L13 and a positive meniscus lens L14 having a convex surface directed toward the object side. The fifth lens group G5 has a negative refracting power as a whole.

During zooming from the wide angle end to the telephoto end, the first lens group G1 moves toward the object side, the second lens group G2 moves toward the object side, the aperture stop S moves toward the object side, the third lens group G3 moves toward the object side, the fourth lens group G4 moves toward the object side, and the fifth lens group G5 moves toward the object side.

There are two aspheric surfaces in total, which include both surfaces of the positive meniscus lens L4 having a convex surface directed toward the object side in the first lens group G1.

Numerical data of each embodiment described above is shown below. Each of r1, r2, . . . denotes radius of curvature of each lens surface, each of d1, d2, . . . denotes a distance between two lenses, each of nd1, nd2, . . . denotes a refractive index of each lens for a d-line, and each of νd1, νd2. F_{NO} denotes an F number, f denotes a focal length of the entire zoom lens system, d0 denotes a distance between an object and a first surface of lens. Further, * denotes an aspheric surface.

When z is let to be an optical axis with a direction of traveling of light as a positive (direction), and y is let to be in a direction orthogonal to the optical axis, a shape of the aspheric surface is described by the following expression.

z=(y²/r)/[1+{1−(K+1)(y/r)²}^{1/2}]+A₄y⁴+A₆y⁶+A₈y⁸+A₁₀y¹⁰+A₁₂y¹²

where, r denotes a paraxial radius of curvature, K denotes a conical coefficient, A4, A6, A8, A10, and A₁₂ denote aspherical surface coefficients of a fourth order, a sixth order, an eight order, a tenth order, and a twelfth order respectively. Moreover, in the aspherical surface coefficients, ‘e−n’ (where, n is an integral number) indicates ‘10⁻ⁿ’.

Further, these symbols of lens data are common in later embodiments.

### Example 1

Unit mm
Surface data

| Surface no | r | d | nd | νd |
|---|---|---|---|---|
| Object plane | ∞ | ∞ | | |
| 1 | 23.1977 | 3.5207 | 1.49700 | 81.54 |
| 2 | 148.0579 | 0.2000 | | |
| 3* | 107.4659 | 0.1000 | 1.63494 | 23.22 |
| 4* | 35.0000 | 2.2000 | 1.69680 | 55.53 |
| 5 | −554.5214 | Variable | | |
| 6* | 59.5923 | 0.8400 | 1.83481 | 42.71 |
| 7 | 5.2158 | 3.2299 | | |
| 8 | 34.8347 | 2.2000 | 1.84666 | 23.78 |
| 9 | −12.2507 | 0.6000 | 1.77377 | 47.18 |
| 10* | 45.6624 | Variable | | |
| 11(Stop) | ∞ | Variable | | |
| 12* | 6.4156 | 3.6978 | 1.58913 | 61.14 |
| 13* | −12.9234 | 0.1000 | | |
| 14 | 9.5511 | 1.6000 | 1.80440 | 39.59 |
| 15 | −24.1977 | 0.6500 | 1.80518 | 25.42 |
| 16 | 4.4231 | Variable | | |
| 17* | 11.2945 | 2.2078 | 1.53071 | 55.69 |
| 18* | 1.855E+05 | Variable | | |
| 19 | ∞ | 0.4000 | 1.54771 | 62.84 |
| 20 | ∞ | 0.5000 | | |
| 21 | ∞ | 0.5000 | 1.51633 | 64.14 |
| 22 | ∞ | 0.4602 | | |
| Image plane | ∞ | | | |

Aspherical surface data

3rd surface
K = 0.,
A2 = 0.0000E+00, A4 = −7.3531E−06, A6 = 2.5064E−08, A8 = 0.0000E+00,
A10 = 0.0000E+00
4th surface
K = 0.,
A2 = 0.0000E+00, A4 = 1.9105E−05, A6 = −3.3995E−07, A8 = 0.0000E+00,
A10 = 0.0000E+00
6th surface
K = 0.,
A2 = 0.0000E+00, A4 = 2.9908E−05, A6 = −5.3522E−07, A8 = 0.0000E+00,
A10 = 0.0000E+00
10th surface
K = 0.,
A2 = 0.0000E+00, A4 = −3.6654E−04, A6 = 3.9815E−06, A8 = −5.6860E−07,
A10 = 0.0000E+00
12th surface
K = 0.,
A2 = 0.0000E+00, A4 = −6.0088E−04, A6 = 3.6948E−06, A8 = 0.0000E+00,
A10 = 0.0000E+00
13th surface
K = 0.,
A2 = 0.0000E+00, A4 = 3.9617E−04, A6 = 9.6988E−06, A8 = 0.0000E+00,
A10 = 0.0000E+00
17th surface
K = 0.,
A2 = 0.0000E+00, A4 = −1.4828E−04, A6 = 8.7116E−06, A8 = 0.0000E+00,
A10 = 0.0000E+00
18th surface
K = 0.,
A2 = 0.0000E+00, A4 = −2.4200E−04, A6 = 7.5175E−06, A8 = 0.0000E+00,
A10 = 0.0000E+00

Numerical data

| | Zoom ratio | | |
|---|---|---|---|
| | Wide angle | Inter mediate | Telephoto |
| Focal length | 4.96405 | 13.63292 | 35.47571 |
| Fno. | 3.3108 | 3.6838 | 5.2238 |
| Angle of field | 39.2° | 15.2° | 6.0° |
| Image height | | | |
| Lens total length | 44.7210 | 49.8650 | 57.4742 |
| BF | 0.46015 | 0.45212 | 0.46517 |
| d5 | 0.12244 | 9.68169 | 16.67182 |
| d10 | 11.13246 | 0.81368 | 1.12172 |
| d11 | 4.02245 | 5.38782 | 0.30000 |
| d16 | 3.15447 | 7.00336 | 14.85719 |
| d18 | 3.28282 | 3.98010 | 1.51215 |

Zoom lens group data

| Group | Initial | Focal length |
|---|---|---|
| 1 | 1 | 37.53685 |
| 2 | 6 | −7.83895 |
| 3 | 12 | 10.44420 |
| 4 | 17 | 21.28311 |

| Table of index | List of index per wavelength of medium | | | | |
|---|---|---|---|---|---|
| of glass material | used in the present embodiment | | | | |
| GLA | 587.56 | 656.27 | 486.13 | 435.84 | 404.66 |
| L11 | 1.547710 | 1.545046 | 1.553762 | 1.558427 | 1.562262 |
| L2 | 1.634940 | 1.627290 | 1.654640 | 1.671320 | 1.686320 |
| L10 | 1.530710 | 1.527870 | 1.537400 | 1.542740 | 1.547272 |
| L6 | 1.773770 | 1.768840 | 1.785240 | 1.794360 | 1.802020 |
| L7 | 1.589130 | 1.586188 | 1.595824 | 1.601033 | 1.605348 |
| L12 | 1.516330 | 1.513855 | 1.521905 | 1.526213 | 1.529768 |
| L1 | 1.496999 | 1.495136 | 1.501231 | 1.504506 | 1.507205 |
| L4 | 1.834807 | 1.828975 | 1.848520 | 1.859547 | 1.868911 |
| L8 | 1.804398 | 1.798376 | 1.818696 | 1.830336 | 1.840332 |
| L3 | 1.696797 | 1.692974 | 1.705522 | 1.712339 | 1.718005 |
| L5 | 1.846660 | 1.836488 | 1.872096 | 1.894186 | 1.914294 |
| L9 | 1.805181 | 1.796106 | 1.827775 | 1.847283 | 1.864939 |

### Example 2

Unit mm
Surface data

| Surface no | r | d | nd | νd |
|---|---|---|---|---|
| Object plane | ∞ | ∞ | | |
| 1 | 33.5302 | 1.0000 | 2.14352 | 17.77 |
| 2 | 13.0200 | 2.8000 | | |
| 3 | ∞ | 10.8000 | 1.80610 | 40.92 |
| 4 | ∞ | 0.2000 | | |
| 5* | 18.7896 | 2.8000 | 1.88300 | 40.76 |
| 6* | −20.0286 | 0.1000 | 1.70000 | 20.00 |
| 7* | −31.6031 | Variable | | |
| 8 | 75.8920 | 0.5000 | 1.83481 | 42.71 |
| 9* | 10.5641 | 1.5000 | | |
| 10 | −13.8038 | 0.5000 | 1.80610 | 40.92 |
| 11 | 13.4678 | 1.4000 | 1.94595 | 17.98 |
| 12 | −115.7257 | Variable | | |
| 13(Stop) | ∞ | Variable | | |
| 14* | 7.9429 | 2.5000 | 1.83481 | 42.71 |
| 15* | −30.4191 | 0.1500 | | |
| 16 | 9.6994 | 1.6000 | 1.69680 | 55.53 |
| 17 | −89.7038 | 0.5000 | 2.00069 | 25.46 |
| 18 | 5.4225 | Variable | | |
| 19* | 10.1594 | 1.6000 | 1.53071 | 55.69 |
| 20 | 54.6363 | Variable | | |
| 21* | −14.9981 | 0.6000 | 2.14352 | 17.77 |
| 22 | 29.2740 | 2.2000 | 1.48749 | 70.23 |
| 23 | −7.1550 | 0.6000 | | |
| 24 | ∞ | 0.8000 | 1.51633 | 64.14 |
| 25 | ∞ | 0.7510 | | |
| Image plane | ∞ | | | |

Aspherical surface data

5th surface
K = 0.0655,
A2 = 0.0000E+00, A4 = −9.2667E−06, A6 = 6.8548E−09, A8 = −8.0725E−09,
A10 = 0.0000E+00
6th surface
K = 0.0250,
A2 = 0.0000E+00, A4 = −2.7424E−05, A6 = 1.8361E−07, A8 = −4.4513E−08,
A10 = 0.0000E+00
7th surface
K = −0.0507,
A2 = 0.0000E+00, A4 = 4.8687E−05, A6 = −3.3335E−07, A8 = 7.0000E−09,
A10 = 0.0000E+00
5th surface
K = −0.9591,
A2 = 0.0000E+00, A4 = 1.3136E−04, A6 = 4.8185E−06, A8 = 1.9768E−07,
A10 = 0.0000E+00
14th surface
K = −0.6101,
A2 = 0.0000E+00, A4 = −1.0206E−04, A6 = 5.8873E−06, A8 = −1.2341E−08,
A10 = 0.0000E+00
15th surface
K = −0.2123,
A2 = 0.0000E+00, A4 = 6.9314E−05, A6 = 8.5602E−06, A8 = −1.0338E−07,
A10 = 0.0000E+00
19th surface
K = 0.0419,
A2 = 0.0000E+00, A4 = −2.5292E−04, A6 = 1.6702E−05, A8 = −6.5176E−07,
A10 = 0.0000E+00
21st surface
K = 0.2897,
A2 = 0.0000E+00, A4 = 1.6850E−04, A6 = −2.9538E−05, A8 = 9.8052E−07,
A10 = 0.0000E+00

Numerical data

| | Zoom ratio | | |
|---|---|---|---|
| | Wide angle | Inter mediate | Telephoto |
| Focal length | 6.02043 | 13.47021 | 29.88076 |
| Fno. | 3.0564 | 4.1881 | 5.9000 |
| Angle of field | 36.6° | 16.0° | 7.2° |
| Image height | | | |
| Lens total length | 60.9503 | 60.9503 | 60.9852 |
| BF | 0.75096 | 0.75706 | 0.78585 |
| d7 | 0.60013 | 5.32442 | 9.12354 |
| d12 | 9.92425 | 5.19928 | 1.40085 |
| d13 | 9.36213 | 5.00942 | 1.20080 |
| d18 | 2.93777 | 7.34651 | 14.82389 |
| d20 | 5.22509 | 5.16361 | 1.50028 |

Zoom lens group data

| Group | Initial | Focal length |
|---|---|---|
| 1 | 1 | 16.47210 |
| 2 | 8 | −9.07678 |
| 3 | 14 | 13.61576 |
| 4 | 19 | 23.22613 |
| 5 | 21 | −51.13295 |

| Table of index | List of index per wavelength of medium | | | | |
|---|---|---|---|---|---|
| of glass material | used in the present embodiment | | | | |
| GLA | 587.56 | 656.27 | 486.13 | 435.84 | 404.66 |
| L4 | 1.699997 | 1.690357 | 1.725353 | 1.747096 | 1.766956 |
| L11 | 1.530710 | 1.527870 | 1.537400 | 1.542740 | 1.547272 |
| L7 | 1.945950 | 1.931230 | 1.983830 | 2.018254 | 2.051060 |
| L1, L12 | 2.143520 | 2.125601 | 2.189954 | 2.232324 | 2.273184 |
| L14 | 1.516330 | 1.513855 | 1.521905 | 1.526213 | 1.529768 |
| L13 | 1.487490 | 1.485344 | 1.492285 | 1.495963 | 1.498983 |
| L2, L6 | 1.806098 | 1.800248 | 1.819945 | 1.831173 | 1.840781 |
| L5, L8 | 1.834807 | 1.828975 | 1.848520 | 1.859547 | 1.868911 |
| L3 | 1.882997 | 1.876560 | 1.898221 | 1.910495 | 1.920919 |
| L9 | 1.696797 | 1.692974 | 1.705522 | 1.712339 | 1.718005 |
| L10 | 2.000690 | 1.989410 | 2.028720 | 2.052834 | 2.074600 |

### Example 3

Unit mm
Surface data

| Surface no. | r | d | nd | νd |
|---|---|---|---|---|
| Object plane | ∞ | ∞ | | |
| 1 | 55.8091 | 1.0000 | 2.00069 | 25.46 |
| 2 | 11.8214 | 1.7000 | | |
| 3 | ∞ | 9.5000 | 2.14352 | 17.77 |
| 4 | ∞ | 0.2000 | | |
| 5* | 11.7283 | 0.1000 | 1.69000 | 21.70 |
| 6 | 10.3598 | 2.8000 | 1.74320 | 49.34 |
| 7 | −22.5466 | Variable | | |
| 8 | 67.1776 | 0.5000 | 1.80400 | 46.57 |
| 9 | 13.6832 | 0.4000 | | |
| 10 | −78.2389 | 0.5000 | 1.78800 | 47.37 |
| 11 | 29.6750 | 0.5000 | | |
| 12 | −12.3113 | 0.5000 | 1.77250 | 49.60 |
| 13 | 4.2337 | 1.0000 | 1.80810 | 22.76 |
| 14 | 11.2019 | Variable | | |
| 15(Stop) | ∞ | 0.8000 | | |
| 16* | 9.6468 | 1.5000 | 1.51633 | 64.14 |
| 17 | −36.8259 | Variable | | |
| 18* | 17.5174 | 1.8000 | 1.74320 | 49.34 |
| 19 | −6.8539 | 0.5000 | 1.80810 | 22.76 |
| 20 | −13.6328 | Variable | | |
| 21 | −22.6123 | 0.6000 | 2.09500 | 29.40 |
| 22 | 19.9180 | 8.2728 | | |
| 23* | 22.5151 | 1.5000 | 1.52540 | 56.25 |
| 24 | −33.8010 | 3.4713 | | |
| 25 | ∞ | 0.8000 | 1.51633 | 64.14 |
| 26 | ∞ | 0.7967 | | |
| Image plane | ∞ | | | |

Aspherical surface data

5th surface
K = −0.0305,
A2 = 0.0000E+00, A4 = −1.3222E−04, A6 = −4.8278E−07, A8 = −2.4643E−09,
A10 = 0.0000E+00
16th surface
K = 0.1581,
A2 = 0.0000E+00, A4 = −2.2541E−04, A6 = −8.4461E−06, A8 = 4.0248E−07,
A10 = 0.0000E+00
18th surface
K = −0.2366,
A2 = 0.0000E+00, A4 = −2.9206E−04, A6 = 2.7012E−06, A8 = −1.3860E−07,
A10 = 0.0000E+00
23rd surface
K = −0.2751,
A2 = 0.0000E+00, A4 = 8.7867E−05, A6 = −1.3933E−05, A8 = 1.1045E−07,
A10 = 0.0000E+00

Numerical data

| | Zoom ratio | | |
|---|---|---|---|
| | Wide angle | Inter mediate | Telephoto |
| Focal length | 6.05817 | 13.53337 | 29.95427 |
| Fno. | 3.9288 | 4.3062 | 5.0265 |
| Angle of field | 36.7° | 16.1° | 7.2° |
| Image height | | | |
| Lens total length | 58.4117 | 58.4150 | 58.4105 |
| BF | 0.79670 | 0.78036 | 0.79562 |
| d7 | 0.49323 | 5.39584 | 8.78313 |
| d14 | 9.67907 | 4.75700 | 1.38908 |
| d17 | 6.11543 | 3.87943 | 1.69497 |
| d20 | 3.38318 | 5.65823 | 7.80357 |

Zoom lens group data

| Group | Initial | Focal length |
|---|---|---|
| 1 | 1 | 14.43680 |
| 2 | 8 | −4.37921 |
| 3 | 16 | 14.96959 |
| 4 | 18 | 11.17264 |
| 5 | 21 | −32.98395 |

| Table of index | List of index per wavelength of medium | | | | |
|---|---|---|---|---|---|
| of glass material | used in the present embodiment | | | | |
| GLA | 587.56 | 656.27 | 486.13 | 435.84 | 404.66 |
| L13 | 1.525399 | 1.522577 | 1.531916 | 1.537043 | 1.541302 |
| L12 | 2.094997 | 2.084179 | 2.121419 | 2.143451 | 2.162626 |
| L3 | 1.689997 | 1.681152 | 1.712946 | 1.732792 | 1.750991 |
| L2 | 2.143520 | 2.125601 | 2.189954 | 2.232324 | 2.273184 |
| L9 | 1.516330 | 1.513855 | 1.521905 | 1.526213 | 1.529768 |
| L14 | 1.516330 | 1.513855 | 1.521905 | 1.526213 | 1.529768 |
| L6 | 1.788001 | 1.782998 | 1.799634 | 1.808881 | 1.816664 |
| L5 | 1.804000 | 1.798815 | 1.816080 | 1.825698 | 1.833800 |
| L7 | 1.772499 | 1.767798 | 1.783374 | 1.791971 | 1.799174 |
| L4, L10 | 1.743198 | 1.738653 | 1.753716 | 1.762046 | 1.769040 |
| L8, L11 | 1.808095 | 1.798009 | 1.833513 | 1.855902 | 1.876580 |
| L1 | 2.000690 | 1.989410 | 2.028720 | 2.052834 | 2.074600 |

### Example 4

Unit mm
Surface data

| Surface no. | r | d | nd | νd |
|---|---|---|---|---|
| Object plane | ∞ | ∞ | | |
| 1 | 27.0323 | 0.9000 | 2.14352 | 17.77 |
| 2 | 10.1288 | 2.3000 | | |
| 3 | ∞ | 9.6000 | 2.14352 | 17.77 |
| 4 | ∞ | 0.2000 | | |
| 5* | 68.3242 | 0.1000 | 1.62000 | 24.70 |
| 6* | 21.6875 | 2.4000 | 1.80610 | 40.92 |
| 7* | −25.9921 | 0.1500 | | |
| 8 | 20.0916 | 1.8000 | 1.80610 | 40.92 |
| 9 | −99.2426 | Variable | | |
| 10 | −45.2490 | 0.5000 | 1.81600 | 46.62 |
| 11 | 12.4776 | 0.9000 | | |
| 12* | −15.3468 | 0.6000 | 1.69350 | 53.21 |
| 13* | 10.2225 | 0.5000 | 1.73000 | 16.50 |
| 14* | 105.0869 | Variable | | |
| 15(Stop) | ∞ | Variable | | |
| 16* | 7.8328 | 2.5000 | 1.83481 | 42.71 |
| 17* | −24.1306 | 0.1500 | | |
| 18 | 14.5797 | 1.6000 | 1.69680 | 55.53 |
| 19 | −22.4539 | 0.5000 | 2.00069 | 25.46 |
| 20 | 6.9812 | Variable | | |
| 21* | 11.4268 | 1.6000 | 1.53071 | 55.69 |
| 22 | −121.9178 | Variable | | |
| 23 | −7.9628 | 0.6000 | 2.14352 | 17.77 |
| 24 | −28.2303 | 2.0000 | 1.51633 | 64.14 |
| 25 | −6.4685 | 0.6000 | | |
| 26 | ∞ | 0.8000 | 1.51633 | 64.14 |
| 27 | ∞ | 0.7391 | | |
| Image plane | ∞ | | | |

Aspherical surface data

5th surface
κ = −0.2528,
A2 = 0.0000E+00, A4 = 1.3586E−04, A6 = −4.6108E−06,
A8 = 7.7776E−08, A10 = 0.0000E+00
6th surface
κ = 0.1056,
A2 = 0.0000E+00, A4 = −1.1753E−04, A6 = 1.1368E−05,
A8 = −2.6623E−07, A10 = 0.0000E+00
7th surface
κ = −0.0828,
A2 = 0.0000E+00, A4 = 5.0201E−05, A6 = −8.4172E−07,
A8 = −4.5670E−09, A10 = 0.0000E+00
12th surface
κ = −0.3270,
A2 = 0.0000E+00, A4 = 9.9154E−04, A6 = −1.1128E−04,
A8 = 4.3826E−06, A10 = 0.0000E+00
13th surface
κ = −1.0000,
A2 = 0.0000E+00, A4 = 2.0000E−04, A6 = 0.0000E+00,
A8 = 0.0000E+00, A10 = 0.0000E+00
14th surface
κ = 2.8538,
A2 = 0.0000E+00, A4 = 7.4615E−04, A6 = −8.0973E−05,
A8 = 3.7632E−06, A10 = 0.0000E+00
16th surface
κ = −0.5905,
A2 = 0.0000E+00, A4 = 1.5723E−04, A6 = 1.2459E−05,
A8 = 1.3763E−06, A10 = 0.0000E+00
17th surface
κ = −0.7393,
A2 = 0.0000E+00, A4 = 5.4163E−04, A6 = 9.1504E−06,
A8 = 2.5518E−06, A10 = 0.0000E+00
21st surface
κ = −0.6972,
A2 = 0.0000E+00, A4 = −1.6296E−04, A6 = 2.1867E−05,
A8 = −7.9065E−07, A10 = 0.0000E+00

Numerical data

| | | |
|---|---|---|
| Wide angle | Inter mediate | Telephoto |

Zoom ratio

| | | | |
|---|---|---|---|
| Focal length | 6.01672 | 13.45101 | 29.87271 |
| Fno. | 3.4418 | 4.0614 | 5.9000 |
| Angle of field | 36.3° | 16.1° | 7.2° |

Image height

| | | | |
|---|---|---|---|
| Lens total length | 56.9073 | 56.9057 | 56.9538 |
| BF | 0.73909 | 0.74264 | 0.78558 |
| d9 | 0.59805 | 5.39530 | 8.12345 |
| d14 | 8.92039 | 4.13006 | 1.39503 |
| d15 | 7.09122 | 4.89476 | 1.19759 |
| d20 | 3.58210 | 5.44621 | 13.65163 |
| d22 | 5.67645 | 5.99669 | 1.50055 |

Zoom lens group data

| Group | Initial | Focal length |
|---|---|---|
| 1 | 1 | 12.94802 |
| 2 | 10 | −7.31853 |
| 3 | 16 | 12.96068 |
| 4 | 21 | 19.76830 |
| 5 | 23 | −40.35543 |

Table of index
List of index per wavelength of medium
of glass material used in the present embodiment

| GLA | 587.56 | 656.27 | 486.13 | 435.84 | 404.66 |
|---|---|---|---|---|---|
| L3 | 1.619998 | 1.612948 | 1.638046 | 1.651657 | 1.662921 |
| L8 | 1.729996 | 1.718099 | 1.762336 | 1.790236 | 1.816049 |
| L12 | 1.530710 | 1.527870 | 1.537400 | 1.542740 | 1.547272 |
| L1, L2, L13 | 2.143520 | 2.125601 | 2.189954 | 2.232324 | 2.273190 |
| L14 | 1.516330 | 1.513855 | 1.521905 | 1.526213 | 1.529768 |
| L15 | 1.516330 | 1.513855 | 1.521905 | 1.526213 | 1.529768 |
| L4, L5 | 1.806098 | 1.800248 | 1.819945 | 1.831173 | 1.840781 |
| L9 | 1.834807 | 1.828975 | 1.848520 | 1.859547 | 1.868911 |
| L6 | 1.816000 | 1.810749 | 1.828252 | 1.837996 | 1.846185 |
| L7 | 1.693501 | 1.689548 | 1.702582 | 1.709715 | 1.715662 |
| L10 | 1.696797 | 1.692974 | 1.705522 | 1.712339 | 1.718005 |
| L11 | 2.000690 | 1.989410 | 2.028720 | 2.052834 | 2.074603 |

### Example 5

Unit mm
Surface data

| Surface no. | r | d | nd | νd |
|---|---|---|---|---|
| Object plane | ∞ | ∞ | | |
| 1 | 27.4196 | 3.3739 | 1.65160 | 58.55 |
| 2 | 291.1713 | 0.2000 | | |
| 3 | 130.0000 | 0.1000 | 1.63494 | 23.22 |
| 4* | 35.0000 | 2.0000 | 1.69680 | 55.53 |
| 5 | 178.5735 | Variable | | |
| 6* | 26.2243 | 0.8400 | 1.83481 | 42.71 |
| 7 | 5.7000 | 4.0000 | | |
| 8* | −61.0455 | 1.5990 | 1.63494 | 23.22 |
| 9 | −8.0221 | 0.7000 | 1.53071 | 55.69 |
| 10* | 44.1633 | Variable | | |
| 11(Stop) | ∞ | Variable | | |
| 12* | 5.9795 | 2.3320 | 1.63000 | 64.00 |
| 13* | −18.6459 | 0.1000 | | |
| 14 | 7.4112 | 1.6000 | 1.80440 | 39.59 |
| 15 | −7.374E+05 | 0.6500 | 1.80518 | 25.42 |
| 16 | 3.6952 | Variable | | |
| 17* | 8.3966 | 2.2078 | 1.53071 | 55.69 |
| 18* | 20.2640 | Variable | | |
| 19 | ∞ | 0.4000 | 1.54771 | 62.84 |
| 20 | ∞ | 0.5000 | | |
| 21 | ∞ | 0.5000 | 1.51633 | 64.14 |
| 22 | ∞ | 0.5503 | | |
| Image plane | ∞ | | | |

Aspherical surface data

4th surface
κ = 0.,
A2 = 0.0000E+00, A4 = −3.0716E−05, A6 = 0.0000E+00,
A8 = 0.0000E+00, A10 = 0.0000E+00
6th surface
κ = 0.,
A2 = 0.0000E+00, A4 = 1.4369E−05, A6 = −8.9630E−07,
A8 = 0.0000E+00, A10 = 0.0000E+00
8th surface
κ = 0.,
A2 = 0.0000E+00, A4 = −4.9225E−04, A6 = 0.0000E+00,
A8 = 0.0000E+00, A10 = 0.0000E+00
10th surface
κ = 0.,
A2 = 0.0000E+00, A4 = −8.0665E−04, A6 = 2.7109E−06,
A8 = −1.8713E−07, A10 = 0.0000E+00
12th surface
κ = 0.,
A2 = 0.0000E+00, A4 = −6.0868E−04, A6 = 6.7552E−06,
A8 = 0.0000E+00, A10 = 0.0000E+00
13th surface
κ = 0.,
A2 = 0.0000E+00, A4 = 2.9001E−04, A6 = 1.7975E−05,
A8 = 0.0000E+00, A10 = 0.0000E+00
17th surface
κ = 0.,
A2 = 0.0000E+00, A4 = −1.1508E−03, A6 = −1.6526E−05,
A8 = 0.0000E+00, A10 = 0.0000E+00
18th surface
κ = 0.,
A2 = 0.0000E+00, A4 = −2.8523E−03, A6 = 2.6043E−05,
A8 = 0.0000E+00, A10 = 0.0000E+00

Numerical data

| | | |
|---|---|---|
| Wide angle | Inter mediate | Telephoto |

Zoom ratio

| | | | |
|---|---|---|---|
| Focal length | 4.96645 | 13.32333 | 35.51685 |
| Fno. | 3.1079 | 3.7323 | 5.0760 |
| Angle of field | 39.4° | 16.0° | 6.3° |

Image height

| | | | |
|---|---|---|---|
| Lens total length | 44.2002 | 47.7406 | 56.0159 |
| BF | 0.55033 | 0.59565 | 0.92544 |
| d5 | 0.06572 | 8.90974 | 16.35935 |
| d10 | 12.52858 | 2.48211 | 0.30000 |
| d11 | 3.46018 | 3.87003 | 0.30000 |
| d16 | 5.84018 | 9.42789 | 15.67270 |
| d18 | 0.65259 | 1.35255 | 1.35580 |

Zoom lens group data

| Group | Initial | Focal length |
|---|---|---|
| 1 | 1 | 41.03289 |
| 2 | 6 | −7.90604 |
| 3 | 12 | 9.64222 |
| 4 | 17 | 25.37883 |

Table of index
List of index per wavelength of medium
of glass material used in the present embodiment

| GLA | 587.56 | 656.27 | 486.13 | 435.84 | 404.66 |
|---|---|---|---|---|---|
| L7 | 1.629999 | 1.627002 | 1.636844 | 1.642180 | 1.646586 |
| L11 | 1.547710 | 1.545046 | 1.553762 | 1.558427 | 1.562262 |
| L2, L5 | 1.634940 | 1.627290 | 1.654640 | 1.671600 | 1.687050 |
| L6, L10 | 1.530710 | 1.527870 | 1.537400 | 1.542740 | 1.547272 |
| L12 | 1.516330 | 1.513855 | 1.521905 | 1.526213 | 1.529768 |
| L4 | 1.834807 | 1.828975 | 1.848520 | 1.859547 | 1.868911 |
| L8 | 1.804398 | 1.798376 | 1.818696 | 1.830336 | 1.840332 |
| L3 | 1.696797 | 1.692974 | 1.705522 | 1.712339 | 1.718005 |
| L1 | 1.651597 | 1.648207 | 1.659336 | 1.665373 | 1.670384 |
| L9 | 1.805181 | 1.796106 | 1.827775 | 1.847283 | 1.864939 |

### Example 6

Unit mm
Surface data

| Surface no. | r | d | nd | νd |
|---|---|---|---|---|
| Object plane | ∞ | ∞ | | |
| 1 | 44.3954 | 4.5000 | 1.60311 | 60.64 |
| 2 | −201.7721 | 0.1000 | 1.73000 | 18.00 |
| 3* | −480.0324 | Variable | | |
| 4 | 144.9385 | 0.8000 | 1.88300 | 40.76 |
| 5 | 12.4326 | 2.3000 | | |
| 6 | ∞ | 10.0000 | 1.90366 | 31.32 |
| 7 | ∞ | 0.8000 | | |
| 8* | −37.0329 | 1.0000 | 1.53071 | 55.69 |
| 9 | 16.5163 | 1.0000 | 1.73000 | 18.00 |
| 10* | 56.8066 | Variable | | |
| 11(Stop) | ∞ | 0.5000 | | |
| 12* | 34.8704 | 2.7000 | 1.83481 | 42.71 |
| 13 | −34.9455 | 0.1500 | | |
| 14 | 7.5599 | 2.7000 | 1.77250 | 49.60 |
| 15 | 27.1437 | 0.5000 | 1.80810 | 22.76 |
| 16 | 6.0778 | Variable | | |
| 17 | 24.0928 | 2.0000 | 1.69680 | 55.53 |
| 18 | 348.3996 | Variable | | |
| 19 | 9.7340 | 2.0000 | 1.69350 | 53.21 |
| 20* | 14.9068 | 1.4000 | | |
| 21 | ∞ | 1.2000 | 1.51633 | 64.14 |
| 22 | ∞ | 1.5000 | | |
| Image plane | ∞ | | | |

Aspherical surface data

3rd surface
κ = 10.4077,
A2 = 0.0000E+00, A4 = 5.3023E−07, A6 = −1.4349E−09,
A8 = 0.0000E+00, A10 = 0.0000E+00
8th surface
κ = 0.1788,
A2 = 0.0000E+00, A4 = −6.2307E−05, A6 = −4.8485E−06,
A8 = 1.3504E−07, A10 = 0.0000E+00
10th surface
κ = 0.2734,
A2 = 0.0000E+00, A4 = −5.6928E−05, A6 = −3.0969E−06,
A8 = 1.2158E−07, A10 = 0.0000E+00
12th surface
κ = 0.,
A2 = 0.0000E+00, A4 = −3.0368E−05, A6 = −1.2884E−07,
A8 = 3.2428E−09, A10 = 0.0000E+00
20th surface
κ = −0.7492,
A2 = 0.0000E+00, A4 = 7.6830E−06, A6 = −1.1962E−06,
A8 = 0.0000E+00, A10 = 0.0000E+00

Numerical data

| | | |
|---|---|---|
| Wide angle | Inter mediate | Telephoto |

Zoom ratio

| | | | |
|---|---|---|---|
| Focal length | 6.19931 | 13.86342 | 30.99985 |
| Fno. | 2.8000 | 3.5653 | 4.7945 |
| Angle of field | 33.5° | 14.4° | 6.6° |

Image height

| | | | |
|---|---|---|---|
| Lens total length | 70.8087 | 87.1053 | 90.6636 |
| BF | 1.49999 | 1.49754 | 1.49959 |
| d3 | 0.79959 | 17.10053 | 20.65486 |
| d10 | 23.09101 | 14.32111 | 1.80023 |
| d16 | 4.37455 | 13.15211 | 10.01234 |
| d18 | 7.39356 | 7.38400 | 23.04653 |

Zoom lens group data

| Group | Initial | Focal length |
|---|---|---|
| 1 | 1 | 69.24373 |
| 2 | 4 | −11.29384 |
| 3 | 12 | 18.80401 |
| 4 | 17 | 37.05142 |
| 5 | 19 | 34.91985 |

Table of index
List of index per wavelength of medium
of glass material used in the present embodiment

| GLA | 587.56 | 656.27 | 486.13 | 435.83 | 404.66 |
|---|---|---|---|---|---|
| L2, L6 | 1.729996 | 1.718951 | 1.759502 | 1.785560 | 1.810041 |
| L5 | 1.530710 | 1.527870 | 1.537400 | 1.542740 | 1.547272 |
| L12 | 1.516330 | 1.513855 | 1.521905 | 1.526214 | 1.529768 |
| L1 | 1.603112 | 1.600079 | 1.610024 | 1.615409 | 1.619870 |
| L7 | 1.834807 | 1.828975 | 1.848520 | 1.859548 | 1.868911 |
| L3 | 1.882997 | 1.876560 | 1.898221 | 1.910497 | 1.920919 |
| L8 | 1.772499 | 1.767798 | 1.783374 | 1.791972 | 1.799174 |
| L11 | 1.693501 | 1.689548 | 1.702582 | 1.709715 | 1.715662 |
| L10 | 1.696797 | 1.692974 | 1.705522 | 1.712340 | 1.718005 |
| L9 | 1.808095 | 1.798009 | 1.833513 | 1.855904 | 1.876580 |
| L4 | 1.903660 | 1.895260 | 1.924120 | 1.941280 | 1.956430 |

### Example 7

Unit mm
Surface data

| Surface no. | r | d | nd | νd |
|---|---|---|---|---|
| Object plane | ∞ | ∞ | | |
| 1* | 46.9569 | 2.5000 | 1.74320 | 49.34 |
| 2* | −27.8314 | 0.1000 | 1.70999 | 15.00 |
| 3* | −49.6126 | Variable | | |
| 4 | 18.9563 | 0.6000 | 1.88300 | 40.76 |
| 5 | 8.2025 | 2.5000 | | |
| 6* | −17.7265 | 0.7500 | 1.70999 | 15.00 |
| 7* | −8.0940 | 0.7000 | 1.74320 | 49.34 |
| 8* | 78.0187 | Variable | | |
| 9(Stop) | ∞ | Variable | | |
| 10* | −1165.2363 | 1.8000 | 1.74250 | 49.20 |
| 11* | −10.9181 | 0.1500 | | |
| 12 | 5.5456 | 2.7000 | 1.69680 | 55.53 |
| 13 | 20.1924 | 0.6000 | 1.84666 | 23.78 |
| 14 | 4.4884 | 4.0000 | | |
| 15 | ∞ | Variable | | |
| 16* | 7.2960 | 2.7000 | 1.58313 | 59.46 |
| 17 | 31.3979 | Variable | | |
| 18 | ∞ | 0.5000 | 1.51633 | 64.14 |
| 19 | ∞ | 1.6759 | | |
| Image plane | ∞ | | | |

Aspherical surface data

1st surface
κ = −0.6400,
A2 = 0.0000E+00, A4 = 1.8031E−05, A6 = −5.2509E−08,
A8 = 0.0000E+00, A10 = 0.0000E+00
2nd surface
κ = 0.5932,
A2 = 0.0000E+00, A4 = 5.8900E−05, A6 = −1.1620E−08,
A8 = 0.0000E+00, A10 = 0.0000E+00
3rd surface
κ = −1.9040,
A2 = 0.0000E+00, A4 = 2.6901E−05, A6 = −8.3532E−08,
A8 = 0.0000E+00, A10 = 0.0000E+00
6th surface
κ = −0.7439,
A2 = 0.0000E+00, A4 = −1.2287E−03, A6 = 2.7601E−05,
A8 = 0.0000E+00, A10 = 0.0000E+00
7th surface
κ = −1.3463,
A2 = 0.0000E+00, A4 = −1.4902E−03, A6 = 4.9724E−05,
A8 = 0.0000E+00, A10 = 0.0000E+00
8th surface
κ = −7.5249,
A2 = 0.0000E+00, A4 = −1.1186E−03, A6 = 3.1342E−05,
A8 = 0.0000E+00, A10 = 0.0000E+00
10th surface
κ = 8.3231,
A2 = 0.0000E+00, A4 = −8.5879E−04, A6 = −4.5376E−05,
A8 = 0.0000E+00, A10 = 0.0000E+00
11th surface
κ = −1.0299,
A2 = 0.0000E+00, A4 = −6.7496E−04, A6 = −3.3358E−05,
A8 = 0.0000E+00, A10 = 0.0000E+00
16th surface
κ = −1.0066,
A2 = 0.0000E+00, A4 = 3.8831E−05, A6 = 3.0882E−06,
A8 = 0.0000E+00, A10 = 0.0000E+00

Numerical data

| | | |
|---|---|---|
| Wide angle | Inter mediate | Telephoto |

Zoom ratio

| | | | |
|---|---|---|---|
| Focal length | 6.99699 | 15.65442 | 34.99900 |
| Fno. | 2.8272 | 3.1965 | 3.7165 |
| Angle of field | 28.4° | 12.6° | 5.6° |

Image height

| | | | |
|---|---|---|---|
| Lens total length | 43.8578 | 47.5962 | 54.5318 |
| BF | 1.67590 | 1.66757 | 1.67552 |
| d3 | 0.50000 | 7.81786 | 14.22857 |
| d8 | 14.22195 | 6.22436 | 1.50067 |
| d9 | 0.80000 | 0.79787 | 0.79787 |
| d15 | 4.17155 | 6.18924 | 12.10125 |
| d17 | 2.88837 | 5.29926 | 4.62795 |
| d19 | 1.67590 | 1.66757 | 1.67552 |

Zoom lens group data

| Group | Initial | Focal length |
|---|---|---|
| 1 | 1 | 32.29465 |
| 2 | 4 | −8.23834 |
| 4 | 10 | 12.53540 |
| 5 | 16 | 15.65338 |

Table of index
List of index per wavelength of medium
of glass material used in the present embodiment

| GLA | 587.56 | 656.27 | 486.13 | 435.84 | 404.66 |
|---|---|---|---|---|---|
| L6 | 1.742499 | 1.737967 | 1.753057 | 1.761415 | 1.768384 |
| L2, L4 | 1.709995 | 1.696485 | 1.743813 | 1.771618 | 1.795992 |
| L9 | 1.583130 | 1.580140 | 1.589950 | 1.595245 | 1.599635 |
| L10 | 1.516330 | 1.513855 | 1.521905 | 1.526213 | 1.529768 |
| L3 | 1.882997 | 1.876560 | 1.898221 | 1.910495 | 1.920919 |
| L7 | 1.696797 | 1.692974 | 1.705522 | 1.712339 | 1.718005 |
| L1, L5 | 1.743198 | 1.738653 | 1.753716 | 1.762046 | 1.769040 |
| L8 | 1.846660 | 1.836488 | 1.872096 | 1.894186 | 1.914294 |

### Example 8

Unit mm
Surface data

| Surface no. | r | d | nd | νd |
|---|---|---|---|---|
| Object plane | ∞ | ∞ | | |
| 1 | 91.3445 | 5.0062 | 1.48749 | 70.23 |
| 2 | −130.2672 | 0.1000 | 1.63594 | 19.03 |
| 3 | −709.4779 | 2.0025 | 1.72047 | 34.71 |
| 4 | 872.8615 | 0.0751 | | |
| 5 | 36.6924 | 4.5557 | 1.48749 | 70.23 |
| 6 | 106.5132 | 27.4442 | | |
| 7 | 23.7895 | 2.2178 | 1.58913 | 61.14 |
| 8 | 23.8290 | 7.4192 | | |
| 9(Stop) | ∞ | 1.0914 | | |
| 10 | 20.2372 | 2.4030 | 1.59270 | 35.31 |
| 11 | 113.0884 | 1.0012 | | |
| 12 | −182.9717 | 0.8511 | 1.77250 | 49.60 |
| 13 | 18.5628 | 15.2690 | | |
| 14 | ∞ | 1.0012 | 1.51633 | 64.14 |
| 15 | ∞ | 38.2848 | | |
| Image plane | ∞ | | | |

Numerical data
Zoom ratio

| | |
|---|---|
| Focal length | 148.00034 |
| Fno. | 4.5000 |
| Angle of field | 4.1° |

Image height

| | |
|---|---|
| Lens total length | 109.9740 |
| BF | 38.28478 |

Table of index
List of index per wavelength of medium
of glass material used in the present embodiment

| GLA | 587.56 | 656.27 | 486.13 | 435.84 | 404.66 |
|---|---|---|---|---|---|
| L2 | 1.635937 | 1.625875 | 1.659289 | 1.678415 | 1.694608 |
| L5 | 1.589130 | 1.586188 | 1.595824 | 1.601033 | 1.605348 |
| L8 | 1.516330 | 1.513855 | 1.521905 | 1.526213 | 1.529768 |
| L1, L4 | 1.487490 | 1.485344 | 1.492285 | 1.495963 | 1.498983 |
| L6 | 1.592701 | 1.587795 | 1.604580 | 1.614538 | 1.623339 |
| L7 | 1.772499 | 1.767798 | 1.783374 | 1.791971 | 1.799174 |
| L3 | 1.720467 | 1.714365 | 1.735123 | 1.747233 | 1.757768 |

### Example 9

Unit mm
Surface data

| Surface no. | r | d | nd | νd |
|---|---|---|---|---|
| Object plane | ∞ | ∞ | | |
| 1 | 34.5751 | 0.9000 | 1.92286 | 20.88 |
| 2 | 29.1913 | 0.1000 | 1.74999 | 16.50 |
| 3* | 25.4815 | 6.0000 | 1.58313 | 59.38 |
| 4* | 314.0004 | 0.0601 | | |
| 5 | 25.9845 | 2.2228 | 1.62299 | 58.16 |
| 6 | 40.7367 | Variable | | |
| 7* | 69.4607 | 0.6007 | 1.83481 | 42.71 |
| 8 | 7.3935 | 2.8285 | | |
| 9* | −16.0072 | 0.3004 | 1.74999 | 16.50 |
| 10* | −13.2262 | 0.5006 | 1.83481 | 42.71 |
| 11* | 28.5653 | 0.0601 | | |
| 12 | 16.6514 | 2.2628 | 1.75520 | 27.51 |
| 13 | −10.6512 | 0.3004 | | |
| 14 | −8.8917 | 0.4506 | 1.77250 | 49.60 |
| 15 | −44.1207 | Variable | | |
| 16(Stop) | ∞ | 0.4706 | | |
| 17 | 22.0202 | 2.0425 | 1.48749 | 70.23 |
| 18 | −14.8470 | 0.0751 | | |
| 19 | 14.4981 | 4.0701 | 1.48749 | 70.23 |
| 20 | −11.6584 | 0.4506 | 1.80518 | 25.42 |
| 21 | −35.2537 | Variable | | |
| 22 | −22.1310 | 2.3479 | 1.74077 | 27.79 |
| 23 | −8.8529 | 0.4506 | 1.88300 | 40.76 |
| 24 | 274.3842 | Variable | | |
| 25 | 38.4687 | 2.6083 | 1.58313 | 59.38 |
| 26* | −11.4364 | 4.4055 | | |
| 27* | −8.7631 | 0.7509 | 1.68893 | 31.07 |
| 28* | −8.4343 | 0.5056 | 1.74999 | 16.50 |
| 29 | −7.7861 | 0.7509 | 1.80518 | 25.42 |
| 30 | −14.3542 | 20.1971 | | |
| Image plane | ∞ | | | |

Aspherical surface data

3rd surface
κ = 0.,
A2 = 0.0000E+00, A4 = 4.3295E−07, A6 = −2.4938E−09,
A8 = −1.5264E−12, A10 = 0.0000E+00
4th surface
κ = 0.,
A2 = 0.0000E+00, A4 = −1.5609E−07, A6 = 1.3443E−09,
A8 = −1.4925E−12, A10 = 0.0000E+00
7th surface
κ = 0.,
A2 = 0.0000E+00, A4 = 1.8249E−05, A6 = −3.5016E−07,
A8 = 2.5792E−08, A10 = −2.0653E−10*
9th surface
κ = 0.,
A2 = 0.0000E+00, A4 = 8.6804E−05, A6 = −7.3599E−06,
A8 = 1.1061E−07, A10 = 0.0000E+00
10th surface
κ = 0.,
A2 = 0.0000E+00, A4 = 9.8201E−05, A6 = −2.4212E−05,
A8 = 8.3911E−07, A10 = 0.0000E+00
11th surface
κ = 0.,
A2 = 0.0000E+00, A4 = 8.0050E−05, A6 = −8.9121E−06,
A8 = 2.4583E−07, A10 = 0.0000E+00
26th surface
κ = 0.,
A2 = 0.0000E+00, A4 = 5.3591E−05, A6 = 1.7802E−06,
A8 = −7.8715E−08, A10 = 9.5111E−10*
27th surface
κ = 0.,
A2 = 0.0000E+00, A4 = 6.5272E−06, A6 = 2.9134E−07,
A8 = −2.8230E−08, A10 = 0.0000E+00
28th surface
κ = 0.,
A2 = 0.0000E+00, A4 = −1.3364E−04, A6 = 7.8279E−06,
A8 = −2.6447E−08, A10 = 0.0000E+00

Numerical data

| | | |
|---|---|---|
| Wide angle | Inter mediate | Telephoto |

Zoom ratio

| | | | |
|---|---|---|---|
| Focal length | 14.43206 | 37.43593 | 96.99385 |
| Fno. | 3.6303 | 4.6026 | 5.2236 |
| Angle of field | 40.7° | 16.2° | 6.3° |

Image height

| | | | |
|---|---|---|---|
| Lens total length | 70.6005 | 86.2912 | 95.6551 |
| BF | 20.19707 | 26.88791 | 29.91850 |
| d6 | 0.69926 | 14.66186 | 24.50799 |
| d15 | 9.50650 | 5.13587 | 0.99195 |
| d21 | 0.60773 | 2.30578 | 3.92617 |
| d24 | 4.07442 | 1.78422 | 0.79499 |
| d30 | 20.19707 | 26.88791 | 29.91850 |

Zoom lens group data

| Group | Initial | Focal length |
|---|---|---|
| 1 | 1 | 46.57576 |
| 2 | 7 | −6.94370 |
| 3 | 17 | 12.07063 |
| 4 | 22 | −18.63407 |
| 5 | 25 | 25.52708 |

Table of index
List of index per wavelength of medium
of glass material used in the present embodiment

| GLA | 587.56 | 656.27 | 486.13 | 435.83 | 404.66 |
|---|---|---|---|---|---|
| L2, L6, L17 | 1.749986 | 1.737732 | 1.783180 | 1.811426 | 1.837231 |
| L1 | 1.922860 | 1.910380 | 1.954570 | 1.982810 | 2.009190 |
| L3, L15 | 1.583126 | 1.580139 | 1.589960 | 1.595297 | 1.599721 |
| L4 | 1.622992 | 1.619739 | 1.630450 | 1.636296 | 1.641162 |
| L10, L11 | 1.487490 | 1.485344 | 1.492285 | 1.495964 | 1.498983 |
| L5 | 1.834807 | 1.828975 | 1.848520 | 1.859548 | 1.868911 |
| L14 | 1.882997 | 1.876560 | 1.898221 | 1.910497 | 1.920919 |
| L7, L9, | 1.772499 | 1.767798 | 1.783374 | 1.791972 | 1.799174 |
| L13 | 1.740769 | 1.733089 | 1.759746 | 1.775994 | 1.790587 |
| L8 | 1.755199 | 1.747295 | 1.774745 | 1.791497 | 1.806556 |
| L12, L18 | 1.805181 | 1.796106 | 1.827775 | 1.847286 | 1.864939 |
| L16 | 1.688931 | 1.682495 | 1.704665 | 1.717975 | 1.729809 |

### Example 10

Unit mm
Surface data

| Surface no. | r | d | nd | νd |
|---|---|---|---|---|
| Object plane | ∞ | ∞ | | |
| 1 | 90.0725 | 2.5000 | 1.62000 | 62.19 |
| 2 | −314.2911 | 0.1500 | | |
| 3 | 28.6778 | 1.2000 | 1.63259 | 23.27 |
| 4 | 20.1975 | 0.3000 | | |
| 5 | 20.1324 | 3.3000 | 1.53071 | 55.69 |
| 6 | 45.8315 | Variable | | |
| 7 | −35.1010 | 0.8000 | 1.83400 | 37.16 |
| 8 | 20.2195 | 1.7000 | | |
| 9 | 26.2024 | 1.8000 | 1.84666 | 23.78 |
| 10 | −116.8918 | Variable | | |
| 11(Stop) | ∞ | 2.5181 | | |
| 12 | −549.7641 | 0.8000 | 1.84666 | 23.78 |
| 13 | 42.5758 | 1.3000 | | |
| 14 | 45.5198 | 2.5000 | 1.60311 | 60.64 |
| 15 | −22.5935 | Variable | | |
| 16 | 33.2835 | 2.8000 | 1.48749 | 70.23 |
| 17 | −23.4195 | 0.8000 | 1.88300 | 40.76 |
| 18 | −343.4582 | 0.1001 | | |
| 19 | 45.2325 | 1.8000 | 1.57099 | 50.80 |
| 20 | −59.4597 | Variable | | |
| 21 | −112.0854 | 0.6000 | 1.83481 | 42.71 |
| 22 | 39.1648 | 1.0000 | | |
| 23 | −41.1664 | 0.6000 | 1.83481 | 42.71 |
| 24 | 15.6850 | 1.6020 | 1.80810 | 22.76 |
| 25 | 246.6331 | 17.3433 | | |
| Image plane | ∞ | | | |

Numerical data

| | | |
|---|---|---|
| Wide angle | Inter mediate | Telephoto |

Zoom ratio

| | | | |
|---|---|---|---|
| Focal length | 50.99882 | 86.99466 | 146.98168 |
| Fno. | 4.3502 | 5.3966 | 6.5000 |
| Angle of field | 12.0° | 7.0° | 4.2° |

Image height

| | | | |
|---|---|---|---|
| Lens total length | 77.2305 | 92.0223 | 105.9900 |
| BF | 17.34326 | 24.71477 | 36.64391 |
| d6 | 1.59994 | 14.14277 | 25.90088 |
| d10 | 14.52984 | 6.64525 | 1.30021 |
| d15 | 1.59994 | 10.34567 | 13.07461 |
| d20 | 13.98725 | 8.00354 | 0.90013 |
| d25 | 17.34326 | 24.71477 | 36.64391 |

Zoom lens group data

| Group | Initial | Focal length |
|---|---|---|
| 1 | 1 | 65.34020 |
| 2 | 7 | −47.93128 |
| 3 | 11 | 50.07675 |
| 4 | 16 | 45.02105 |
| 5 | 21 | −18.15101 |

Table of index
List of index per wavelength of medium
of glass material used in the present embodiment

| GLA | 587.56 | 656.27 | 486.13 | 435.84 | 404.66 |
|---|---|---|---|---|---|
| L1 | 1.620000 | 1.616980 | 1.626940 | 1.632378 | 1.636893 |
| L3 | 1.530710 | 1.527870 | 1.537400 | 1.542740 | 1.547272 |
| L2 | 1.632590 | 1.624740 | 1.651920 | 1.668310 | 1.682930 |
| L10 | 1.570989 | 1.567616 | 1.578856 | 1.585136 | 1.590445 |
| L7 | 1.603112 | 1.600079 | 1.610024 | 1.615408 | 1.619870 |
| L8 | 1.487490 | 1.485344 | 1.492285 | 1.495963 | 1.498983 |
| L11, L12 | 1.834807 | 1.828975 | 1.848520 | 1.859547 | 1.868911 |
| L9 | 1.882997 | 1.876560 | 1.898221 | 1.910495 | 1.920919 |
| L4 | 1.834000 | 1.827376 | 1.849819 | 1.862779 | 1.873964 |
| L13 | 1.808095 | 1.798009 | 1.833513 | 1.855902 | 1.876580 |
| L5, L6 | 1.846660 | 1.836488 | 1.872096 | 1.894186 | 1.914294 |

### Example 11

Unit mm
Surface data

| Surface no. | r | d | nd | νd |
|---|---|---|---|---|
| Object plane | ∞ | ∞ | | |
| 1 | 85.6703 | 2.5000 | 1.62000 | 62.19 |
| 2 | −320.5653 | 0.1500 | | |
| 3 | 27.8938 | 1.2000 | 1.58364 | 30.30 |
| 4 | 23.1118 | 0.1000 | 1.74999 | 16.50 |
| 5* | 20.7692 | 3.3000 | 1.53071 | 55.69 |
| 6* | 42.1712 | Variable | | |
| 7 | −35.2632 | 0.8000 | 1.83400 | 37.16 |
| 8 | 20.7524 | 1.7000 | | |
| 9 | 26.4616 | 1.8000 | 1.84666 | 23.78 |
| 10 | −118.0708 | Variable | | |
| 11(Stop) | ∞ | 2.5181 | | |
| 12 | −328.7522 | 0.8000 | 1.84666 | 23.78 |
| 13 | 42.8249 | 1.3000 | | |
| 14 | 44.1743 | 2.5000 | 1.60311 | 60.64 |
| 15 | −23.0854 | Variable | | |
| 16 | 32.4415 | 2.8000 | 1.48749 | 70.23 |
| 17 | −24.4761 | 0.8000 | 1.88300 | 40.76 |
| 18 | −234.4812 | 0.1001 | | |
| 19 | 45.9225 | 1.8000 | 1.57099 | 50.80 |
| 20 | −71.2028 | Variable | | |
| 21 | −85.6670 | 0.6000 | 1.83481 | 42.71 |
| 22 | 42.3352 | 1.0000 | | |
| 23 | −47.8824 | 0.6000 | 1.83481 | 42.71 |
| 24 | 15.2033 | 1.6020 | 1.80810 | 22.76 |
| 25 | 175.6499 | 17.0487 | | |
| Image plane | ∞ | | | |

Aspherical surface data

5th surface
K = 0.,
A2 = 0.0000E+00, A4 = 9.8045E−08, A6 = −1.6155E−08,
A8 = 6.9006E−11, A10 = 0.0000E+00
6th surface
K = 0.,
A2 = 0.0000E+00, A4 = 4.4388E−08, A6 = 7.0544E−09,
A8 = −3.6551E−11, A10 = 0.0000E+00

Numerical data

| | | |
|---|---|---|
| Wide angle | Inter mediate | Telephoto |

Zoom ratio

| | | | |
|---|---|---|---|
| Focal length | 51.00234 | 86.99187 | 147.00024 |
| Fno. | 4.3502 | 5.3966 | 6.5000 |
| Angle of field | 12.0° | 7.0° | 4.2° |

Image height

| | | | |
|---|---|---|---|
| Lens total length | 76.9054 | 91.6503 | 105.9896 |
| BF | 17.04872 | 24.58948 | 36.83090 |
| d6 | 1.60009 | 14.27915 | 25.89887 |
| d10 | 14.70700 | 6.57313 | 1.30002 |
| d15 | 1.60014 | 10.23608 | 13.08939 |
| d20 | 13.97922 | 8.00216 | 0.90012 |
| d25 | 17.04872 | 24.58948 | 36.83090 |

Zoom lens group data

| Group | Initial | Focal length |
|---|---|---|
| 1 | 1 | 65.80677 |
| 2 | 7 | −49.49068 |
| 3 | 12 | 52.77069 |
| 4 | 16 | 44.01222 |
| 5 | 21 | −18.38333 |

Table of index
List of index per wavelength of medium
of glass material used in the present embodiment

| GLA | 587.56 | 656.27 | 486.13 | 435.84 | 404.66 |
|---|---|---|---|---|---|
| L1 | 1.620000 | 1.616980 | 1.626940 | 1.632378 | 1.636893 |
| L3 | 1.749986 | 1.737132 | 1.782580 | 1.810826 | 1.836631 |
| L4 | 1.530710 | 1.527870 | 1.537400 | 1.542740 | 1.547272 |
| L2 | 1.583640 | 1.578100 | 1.597360 | 1.608900 | 1.619141 |
| L11 | 1.570989 | 1.567616 | 1.578856 | 1.585136 | 1.590445 |
| L8 | 1.603112 | 1.600079 | 1.610024 | 1.615408 | 1.619870 |
| L9 | 1.487490 | 1.485344 | 1.492285 | 1.495963 | 1.498983 |
| L12, L13 | 1.834807 | 1.828975 | 1.848520 | 1.859547 | 1.868911 |
| L10 | 1.882997 | 1.876560 | 1.898221 | 1.910495 | 1.920919 |
| L5 | 1.834000 | 1.827376 | 1.849819 | 1.862779 | 1.873964 |
| L14 | 1.808095 | 1.798009 | 1.833513 | 1.855902 | 1.876580 |
| L6, L7 | 1.846660 | 1.836488 | 1.872096 | 1.894186 | 1.914294 |

### Example 12

Unit mm
Surface data

| Surface no. | r | d | nd | νd |
|---|---|---|---|---|
| Object plane | ∞ | ∞ | | |
| 1 | 85.1981 | 2.5000 | 1.62000 | 62.19 |
| 2 | −328.3946 | 0.1500 | | |
| 3 | 28.0251 | 1.2000 | 1.58364 | 30.30 |
| 4 | 24.8387 | 0.1000 | 1.63494 | 23.22 |
| 5* | 19.3869 | 3.3000 | 1.53071 | 55.69 |
| 6* | 42.3908 | Variable | | |
| 7 | −35.5160 | 0.8000 | 1.83400 | 37.16 |
| 8 | 20.7714 | 1.7000 | | |
| 9 | 26.4117 | 1.8000 | 1.84666 | 23.78 |
| 10 | −115.9611 | Variable | | |
| 11(Stop) | ∞ | 2.5181 | | |
| 12 | −296.5349 | 0.8000 | 1.84666 | 23.78 |
| 13 | 42.6962 | 1.3000 | | |
| 14 | 44.1750 | 2.5000 | 1.60311 | 60.64 |
| 15 | −23.1116 | Variable | | |
| 16 | 32.4342 | 2.8000 | 1.48749 | 70.23 |
| 17 | −24.4722 | 0.8000 | 1.88300 | 40.76 |
| 18 | −230.5420 | 0.1001 | | |
| 19 | 45.9625 | 1.8000 | 1.57099 | 50.80 |
| 20 | −70.3355 | Variable | | |
| 21 | −85.5517 | 0.6000 | 1.83481 | 42.71 |
| 22 | 42.0489 | 1.0000 | | |
| 23 | −48.0636 | 0.6000 | 1.83481 | 42.71 |
| 24 | 15.0943 | 1.6020 | 1.80810 | 22.76 |
| 25 | 176.2681 | 16.6258 | | |
| Image plane | ∞ | | | |

Aspherical surface data

5th surface
K = 0.,
A2 = 0.0000E+00, A4 = 4.2631E−08, A6 = −3.7770E−08,
A8 = 1.5162E−10, A10 = 0.0000E+00
6th surface
K = 0.,
A2 = 0.0000E+00, A4 = 4.9623E−08, A6 = 7.3153E−09,
A8 = −3.7446E−11, A10 = 0.0000E+00

Numerical data

| | | |
|---|---|---|
| Wide angle | Inter mediate | Telephoto |

Zoom ratio

| | | | |
|---|---|---|---|
| Focal length | 51.00063 | 86.99849 | 147.00115 |
| Fno. | 4.3502 | 5.3966 | 6.5000 |
| Angle of field | 12.0° | 7.0° | 4.2° |

Image height

| | | | |
|---|---|---|---|
| Lens total length | 76.8876 | 91.6039 | 106.0020 |
| BF | 16.62584 | 24.54302 | 36.83888 |
| d6 | 1.99951 | 14.27069 | 25.90043 |
| d10 | 14.70383 | 6.60343 | 1.30000 |
| d15 | 1.59970 | 10.22865 | 13.09119 |
| d20 | 13.98846 | 7.98787 | 0.90125 |
| d25 | 16.62584 | 24.54302 | 36.83888 |

Zoom lens group data

| Group | Initial | Focal length |
|---|---|---|
| 1 | 1 | 65.86299 |
| 2 | 7 | −50.50789 |
| 3 | 12 | 53.72604 |
| 4 | 16 | 43.73003 |
| 5 | 21 | −18.35637 |

Table of index
List of index per wavelength of medium
of glass material used in the present embodiment

| GLA | 587.56 | 656.27 | 486.13 | 435.84 | 404.66 |
|---|---|---|---|---|---|
| L1 | 1.620000 | 1.616980 | 1.626940 | 1.632378 | 1.636893 |
| L3 | 1.634940 | 1.626990 | 1.654340 | 1.671081 | 1.686175 |
| L4 | 1.530710 | 1.527870 | 1.537400 | 1.542740 | 1.547272 |
| L2 | 1.583640 | 1.578100 | 1.597360 | 1.608900 | 1.619141 |
| L11 | 1.570989 | 1.567616 | 1.578856 | 1.585136 | 1.590445 |
| L8 | 1.603112 | 1.600079 | 1.610024 | 1.615408 | 1.619870 |
| L9 | 1.487490 | 1.485344 | 1.492285 | 1.495963 | 1.498983 |
| L12, L13 | 1.834807 | 1.828975 | 1.848520 | 1.859547 | 1.868911 |
| L10 | 1.882997 | 1.876560 | 1.898221 | 1.910495 | 1.920919 |
| L5 | 1.834000 | 1.827376 | 1.849819 | 1.862779 | 1.873964 |
| L14 | 1.808095 | 1.798009 | 1.833513 | 1.855902 | 1.876580 |
| L6, L7 | 1.846660 | 1.836488 | 1.872096 | 1.894186 | 1.914294 |

### Example 13

Unit mm
Surface data

| Surface no. | r | d | nd | νd |
|---|---|---|---|---|
| Object plane | ∞ | ∞ | | |
| 1 | 84.6725 | 2.3000 | 1.62000 | 62.19 |
| 2 | −320.2587 | 0.1500 | | |
| 3 | 28.0669 | 1.2000 | 1.53071 | 55.69 |
| 4 | 25.3647 | 0.1000 | 1.63494 | 23.22 |
| 5* | 19.0036 | 3.2000 | 1.53071 | 55.69 |
| 6* | 42.4721 | Variable | | |
| 7 | −36.2995 | 0.8000 | 1.83400 | 37.16 |
| 8 | 20.7815 | 1.7000 | | |
| 9 | 26.5113 | 2.2000 | 1.84666 | 23.78 |
| 10 | −116.2094 | Variable | | |
| 11(Stop) | ∞ | 2.5181 | | |
| 12 | −295.5886 | 0.8000 | 1.84666 | 23.78 |
| 13 | 42.9032 | 1.3000 | | |
| 14 | 44.3236 | 2.8000 | 1.60311 | 60.64 |
| 15 | −23.2596 | Variable | | |
| 16 | 32.5764 | 2.7000 | 1.48749 | 70.23 |
| 17 | −24.5531 | 0.8000 | 1.88300 | 40.76 |
| 18 | −232.3460 | 0.1001 | | |
| 19 | 46.3540 | 1.8000 | 1.57099 | 50.80 |
| 20 | −69.3559 | Variable | | |
| 21 | −85.2917 | 0.6000 | 1.83481 | 42.71 |
| 22 | 41.6213 | 1.0000 | | |
| 23 | −47.5731 | 0.6000 | 1.83481 | 42.71 |
| 24 | 15.1028 | 1.6020 | 1.80810 | 22.76 |
| 25 | 172.2812 | 16.5598 | | |
| Image plane | ∞ | | | |

Aspherical surface data

5th surface
K = 0.,
A2 = 0.0000E+00, A4 = −1.3954E−07, A6 = −3.8597E−08,
A8 = 1.4632E−10, A10 = 0.0000E+00
6th surface
K = 0.,
A2 = 0.0000E+00, A4 = 5.6726E−08, A6 = 7.1276E−09,
A8 = −3.6072E−11, A10 = 0.0000E+00

Numerical data

| | | |
|---|---|---|
| Wide angle | Inter mediate | Telephoto |

Zoom ratio

| | | | |
|---|---|---|---|
| Focal length | 51.00072 | 87.00024 | 147.00177 |
| Fno. | 4.2504 | 5.3434 | 6.5000 |
| Angle of field | 12.0° | 7.0° | 4.1° |

Image height

| | | | |
|---|---|---|---|
| Lens total length | 77.1113 | 91.7951 | 106.0524 |
| BF | 16.55976 | 24.45136 | 36.58753 |
| d6 | 1.99996 | 14.26558 | 25.90162 |
| d10 | 14.68569 | 6.60512 | 1.29970 |
| d15 | 1.59990 | 10.22681 | 13.09215 |
| d20 | 13.99574 | 7.97600 | 0.90111 |
| d25 | 16.55976 | 24.45136 | 36.58753 |

Zoom lens group data

| Group | Initial | Focal length |
|---|---|---|
| 1 | 1 | 65.57269 |
| 2 | 7 | −51.49579 |
| 3 | 12 | 54.01050 |
| 4 | 16 | 43.77634 |
| 5 | 21 | −18.17524 |

Table of index
List of index per wavelength of medium
of glass material used in the present embodiment

| GLA | 587.56 | 656.27 | 486.13 | 435.84 | 404.66 |
|---|---|---|---|---|---|
| L1 | 1.620000 | 1.616980 | 1.626940 | 1.632378 | 1.636893 |
| L3 | 1.634940 | 1.626990 | 1.654340 | 1.671081 | 1.686175 |
| L4, L2 | 1.530710 | 1.527870 | 1.537400 | 1.542740 | 1.547272 |
| L11 | 1.570989 | 1.567616 | 1.578856 | 1.585136 | 1.590445 |
| L8 | 1.603112 | 1.600079 | 1.610024 | 1.615408 | 1.619870 |
| L9 | 1.487490 | 1.485344 | 1.492285 | 1.495963 | 1.498983 |
| L12, L13 | 1.834807 | 1.828975 | 1.848520 | 1.859547 | 1.868911 |
| L10 | 1.882997 | 1.876560 | 1.898221 | 1.910495 | 1.920919 |
| L5 | 1.834000 | 1.827376 | 1.849819 | 1.862779 | 1.873964 |
| L14 | 1.808095 | 1.798009 | 1.833513 | 1.855902 | 1.876580 |
| L6, L7 | 1.846660 | 1.836488 | 1.872096 | 1.894186 | 1.914294 |

Values corresponded to conditional expressions in each of the embodiments are described below, where symbol *** denotes value which satisfies the conditional expression is not exist:

| | Example 1 | Example 2 | Example 3 | Example 4 |
|---|---|---|---|---|
| νd1 | 23.22 | 20.00 | 21.70 | 24.70 |
| nd1 | 1.63494 | 1.70000 | 1.69000 | 1.62000 |
| b1 | 2.25491 | 2.23400 | 2.26939 | 2.27949 |
| θgF1 | 0.6099 | 0.6213 | 0.6242 | 0.5423 |
| βgF1 | 0.7413 | 0.7345 | 0.7470 | 0.6821 |
| θhg1 | 0.5484 | 0.5675 | 0.5724 | 0.4488 |
| βhg1 | 0.7421 | 0.7343 | 0.7534 | 0.6548 |
| νd2 | 55.53 | 40.76 | 49.34 | 40.92 |
| θgF2 | 0.5434 | 0.5669 | 0.5528 | 0.5703 |
| βgF2 | 0.8577 | 0.7976 | 0.8321 | 0.8019 |
| θhg2 | 0.4510 | 0.4811 | 0.4638 | 0.4881 |
| βhg2 | 0.9141 | 0.8210 | 0.8753 | 0.8294 |
| νd1 − νd2 | −32.31 | −20.76 | −27.64 | −16.22 |
| θgF1 − θgF2 | 0.0665 | 0.0544 | 0.0714 | −0.0280 |
| θhg1 − θhg2 | 0.0974 | 0.0864 | 0.1086 | −0.0393 |
| νd3 | *** | *** | *** | 16.50 |
| nd3 | *** | *** | *** | 1.73000 |
| b3 | *** | *** | *** | 2.17055 |
| θgF3 | *** | *** | *** | 0.6307 |
| βgF3 | *** | *** | *** | 0.7241 |
| θhg3 | *** | *** | *** | 0.5835 |
| βhg3 | *** | *** | *** | 0.7211 |
| νd4 | *** | *** | *** | 53.21 |
| θgF4 | *** | *** | *** | 0.5480 |
| βgF4 | *** | *** | *** | 0.8492 |
| θhg4 | *** | *** | *** | 0.4559 |
| βhg4 | *** | *** | *** | 0.8997 |
| νd3 − νd4 | *** | *** | *** | −36.71 |
| θgF3 − θgF4 | *** | *** | *** | 0.0827 |
| θhg3 − θhg4 | *** | *** | *** | 0.1276 |

| | Example 5 | Example 6 | Example 7 |
|---|---|---|---|
| νd1 | 23.22 | 18.00 | 15.00 |
| nd1 | 1.63494 | 1.73000 | 1.70999 |
| b1 | 2.25491 | 2.21060 | 2.11049 |
| θgF1 | 0.6201 | 0.6426 | 0.5875 |
| βgF1 | 0.7515 | 0.7445 | 0.6724 |
| θhg1 | 0.5649 | 0.6037 | 0.5150 |
| βhg1 | 0.7586 | 0.7538 | 0.6401 |
| νd2 | 55.53 | 60.64 | 49.34 |
| θgF2 | 0.5434 | 0.5423 | 0.5528 |
| βgF2 | 0.8577 | 0.8855 | 0.8321 |
| θhg2 | 0.4510 | 0.4487 | 0.4638 |
| βhg2 | 0.9141 | 0.9544 | 0.8753 |
| νd1 − νd2 | −32.31 | −42.64 | −34.34 |
| θgF1 − θgF2 | 0.0767 | 0.1003 | 0.0347 |
| θhg1 − θhg2 | 0.1139 | 0.1550 | 0.0512 |
| νd3 | 23.22 | 18.00 | 15.00 |
| nd3 | 1.63494 | 1.73000 | 1.70999 |
| b3 | 2.25491 | 2.21060 | 2.11049 |
| θgF3 | 0.6201 | 0.6426 | 0.5875 |
| βgF3 | 0.7515 | 0.7445 | 0.6724 |
| θhg3 | 0.5649 | 0.6037 | 0.5150 |
| βhg3 | 0.7586 | 0.7538 | 0.6401 |
| νd4 | 55.69 | 55.69 | 49.34 |
| θgF4 | 0.5603 | 0.5603 | 0.5528 |
| βgF4 | 0.8755 | 0.8755 | 0.8321 |
| θhg4 | 0.4756 | 0.4756 | 0.4638 |
| βhg4 | 0.9401 | 0.9401 | 0.8753 |
| νd3 − νd4 | −32.47 | −37.69 | −34.34 |
| θgF3 − θgF4 | 0.0598 | 0.0823 | 0.0347 |
| θhg3 − θhg4 | 0.0893 | 0.1281 | 0.0512 |
| | Example 8 | Example 9 | Example 10 |
| νd1 | 19.03 | 16.50 | 23.27 |
| nd1 | 1.63594 | 1.74999 | 1.63259 |
| b1 | 2.14404 | 2.19054 | 2.25390 |
| θgF1 | 0.5724 | 0.6215 | 0.6030 |
| βgF1 | 0.6801 | 0.7149 | 0.7347 |
| θhg1 | 0.4846 | 0.5678 | 0.5379 |
| βhg1 | 0.6433 | 0.7054 | 0.7320 |
| νd2 | 70.23 | 59.38 | *** |
| θgF2 | 0.5302 | 0.5438 | *** |
| βgF2 | 0.9277 | 0.8799 | *** |
| θhg2 | 0.4351 | 0.4501 | *** |
| βhg2 | 1.0208 | 0.9453 | *** |
| νd1 − νd2 | −51.20 | −42.88 | *** |
| θgF1 − θgF2 | 0.0422 | 0.0777 | *** |
| θhg1 − θhg2 | 0.0495 | 0.1178 | *** |
| νd3 | *** | 16.50 | *** |
| nd3 | *** | 1.74999 | *** |
| b3 | *** | 2.19054 | *** |
| θgF3 | *** | 0.6215 | *** |
| βgF3 | *** | 0.7149 | *** |
| θhg3 | *** | 0.5678 | *** |
| βhg3 | *** | 0.7054 | *** |
| νd4 | *** | 42.71 | *** |
| θgF4 | *** | 0.5645 | *** |
| βgF4 | *** | 0.8062 | *** |
| θhg4 | *** | 0.4790 | *** |
| βhg4 | *** | 0.8352 | *** |
| νd3 − νd4 | *** | −26.21 | *** |
| θgF3 − θgF4 | *** | 0.0570 | *** |
| θhg3 − θhg4 | *** | 0.0888 | *** |

| | Example 11 | Example 12 | Example 13 |
|---|---|---|---|
| νd1 | 16.50 | 23.22 | 23.22 |
| nd1 | 1.74999 | 1.63494 | 1.63494 |
| b1 | 2.19054 | 2.25491 | 2.25491 |
| θgF1 | 0.6215 | 0.6121 | 0.6121 |
| βgF1 | 0.7149 | 0.7435 | 0.7435 |
| θhg1 | 0.5678 | 0.5519 | 0.5519 |
| βhg1 | 0.7054 | 0.7456 | 0.7456 |
| νd2 | 55.69 | 55.69 | 55.69 |
| θgF2 | 0.5603 | 0.5603 | 0.5603 |
| βgF2 | 0.8755 | 0.8755 | 0.8755 |
| θhg2 | 0.4756 | 0.4756 | 0.4756 |
| βhg2 | 0.9401 | 0.9401 | 0.9401 |
| νd1 − νd2 | −39.19 | −32.47 | −32.47 |
| θgF1 − θgF2 | 0.0612 | 0.0518 | 0.0518 |
| θhg1 − θhg2 | 0.0922 | 0.0763 | 0.0763 |
| νd3 | *** | *** | *** |
| nd3 | *** | *** | *** |
| b3 | *** | *** | *** |
| θgF3 | *** | *** | *** |
| βgF3 | *** | *** | *** |
| θhg3 | *** | *** | *** |
| βhg3 | *** | *** | *** |
| νd4 | *** | *** | *** |
| θgF4 | *** | *** | *** |
| βgF4 | *** | *** | *** |
| θhg4 | *** | *** | *** |
| βhg4 | *** | *** | *** |
| νd3 − νd4 | *** | *** | *** |
| θgF3 − θgF4 | *** | *** | *** |
| θhg3 − θhg4 | *** | *** | *** |

Values corresponded to conditional expressions in each of the embodiments are described below, where symbol *** denotes value which satisfies the conditional expression is not exist:

| | Example 1 | Example 2 | Example 3 | Example 4 |
|---|---|---|---|---|
| νd1 | 23.22 | 20.00 | 21.70 | 24.70 |
| nd1 | 1.63494 | 1.70000 | 1.69000 | 1.62000 |
| b1 | 2.25491 | 2.23400 | 2.26939 | 2.27949 |
| θgF1 | 0.6099 | 0.6213 | 0.6242 | 0.5423 |
| βgF1 | 0.6712 | 0.6741 | 0.6815 | 0.6075 |
| θhg1 | 0.5484 | 0.5675 | 0.5724 | 0.4488 |
| βhg1 | 0.6385 | 0.6451 | 0.6566 | 0.5446 |
| νd2 | 55.53 | 40.76 | 49.34 | 40.92 |
| θgF2 | 0.5434 | 0.5669 | 0.5528 | 0.5703 |
| βgF2 | 0.6900 | 0.6745 | 0.6831 | 0.6783 |
| θhg2 | 0.4510 | 0.4811 | 0.4638 | 0.4881 |
| βhg2 | 0.6665 | 0.6392 | 0.6552 | 0.6469 |
| νd1 − νd2 | −32.31 | −20.76 | −27.64 | −16.22 |
| θgF1 − θgF2 | 0.0665 | 0.0544 | 0.0714 | −0.0280 |
| θhg1 − θhg2 | 0.0974 | 0.0864 | 0.1086 | −0.0393 |
| νd3 | *** | *** | *** | 16.50 |
| nd3 | *** | *** | *** | 1.73000 |
| b3 | *** | *** | *** | 2.17055 |
| θgF3 | *** | *** | *** | 0.6307 |
| βgF3 | *** | *** | *** | 0.6743 |
| θhg3 | *** | *** | *** | 0.5835 |
| βhg3 | *** | *** | *** | 0.6475 |
| νd4 | *** | *** | *** | 53.21 |
| θgF4 | *** | *** | *** | 0.5480 |
| βgF4 | *** | *** | *** | 0.6885 |
| θhg4 | *** | *** | *** | 0.4559 |
| βhg4 | *** | *** | *** | 0.6624 |
| νd3 − νd4 | *** | *** | *** | −36.71 |
| θgF3 − θgF4 | *** | *** | *** | 0.0827 |
| θhg3 − θhg4 | *** | *** | *** | 0.1276 |

| | Example 5 | Example 6 | Example 7 |
|---|---|---|---|
| νd1 | 23.22 | 18.00 | 15.00 |
| nd1 | 1.63494 | 1.73000 | 1.70999 |
| b1 | 2.25491 | 2.21060 | 2.11049 |
| θgF1 | 0.6201 | 0.6426 | 0.5875 |
| βgF1 | 0.6814 | 0.6901 | 0.6271 |
| θhg1 | 0.5649 | 0.6037 | 0.5150 |
| βhg1 | 0.6550 | 0.6735 | 0.5732 |
| νd2 | 55.53 | 60.64 | 49.34 |
| θgF2 | 0.5434 | 0.5423 | 0.5528 |
| βgF2 | 0.6900 | 0.7023 | 0.6831 |
| θhg2 | 0.4510 | 0.4487 | 0.4638 |
| βhg2 | 0.6665 | 0.6840 | 0.6552 |
| νd1 − νd2 | −32.31 | −42.64 | −34.34 |
| θgF1 − θgF2 | 0.0767 | 0.1003 | 0.0347 |
| θhg1 − θhg2 | 0.1139 | 0.1550 | 0.0512 |
| νd3 | 23.22 | 18.00 | 15.00 |
| nd3 | 1.63494 | 1.73000 | 1.70999 |
| b3 | 2.25491 | 2.21060 | 2.11049 |
| θgF3 | 0.6201 | 0.6426 | 0.5875 |
| βgF3 | 0.6814 | 0.6901 | 0.6271 |
| θhg3 | 0.5649 | 0.6037 | 0.5150 |
| βhg3 | 0.6550 | 0.6735 | 0.5732 |
| νd4 | 55.69 | 55.69 | 49.34 |
| θgF4 | 0.5603 | 0.5603 | 0.5528 |
| βgF4 | 0.7073 | 0.7073 | 0.6831 |
| θhg4 | 0.4756 | 0.4756 | 0.4638 |
| βhg4 | 0.6917 | 0.6917 | 0.6552 |
| νd3 − νd4 | −32.47 | −37.69 | −34.34 |
| θgF3 − θgF4 | 0.0598 | 0.0823 | 0.0347 |
| θhg3 − θhg4 | 0.0893 | 0.1281 | 0.0512 |
| | Example 8 | Example 9 | Example 10 |
| νd1 | 19.03 | 16.50 | 23.27 |
| nd1 | 1.63594 | 1.74999 | 1.63259 |
| b1 | 2.14404 | 2.19054 | 2.25390 |
| θgF1 | 0.5724 | 0.6215 | 0.6030 |
| βgF1 | 0.6226 | 0.6651 | 0.6644 |
| θhg1 | 0.4846 | 0.5678 | 0.5379 |
| βhg1 | 0.5584 | 0.6318 | 0.6282 |
| νd2 | 70.23 | 59.38 | *** |
| θgF2 | 0.5302 | 0.5438 | *** |
| βgF2 | 0.7156 | 0.7006 | *** |
| θhg2 | 0.4351 | 0.4501 | *** |
| βhg2 | 0.7076 | 0.6805 | *** |
| νd1 − νd2 | −51.20 | −42.88 | *** |
| θgF1 − θgF2 | 0.0422 | 0.0777 | *** |
| θhg1 − θhg2 | 0.0495 | 0.1178 | *** |
| νd3 | *** | 16.50 | *** |
| nd3 | *** | 1.74999 | *** |
| b3 | *** | 2.19054 | *** |
| θgF3 | *** | 0.6215 | *** |
| βgF3 | *** | 0.6651 | *** |
| θhg3 | *** | 0.5678 | *** |
| βhg3 | *** | 0.6318 | *** |
| νd4 | *** | 42.71 | *** |
| θgF4 | *** | 0.5645 | *** |
| βgF4 | *** | 0.6081 | *** |
| θhg4 | *** | 0.4790 | *** |
| βhg4 | *** | 0.6447 | *** |
| νd3 − νd4 | *** | −26.21 | *** |
| θgF3 − θgF4 | *** | 0.0570 | *** |
| θhg3 − θhg4 | *** | 0.0888 | *** |

| | Example 11 | Example 12 | Example 13 |
|---|---|---|---|
| νd1 | 16.50 | 23.22 | 23.22 |
| nd1 | 1.74999 | 1.63494 | 1.63494 |
| b1 | 2.19054 | 2.25491 | 2.25491 |
| θgF1 | 0.6215 | 0.6121 | 0.6121 |
| βgF1 | 0.6651 | 0.6734 | 0.6734 |
| θhg1 | 0.5678 | 0.5519 | 0.5519 |
| βhg1 | 0.6318 | 0.6420 | 0.6420 |
| νd2 | 55.69 | 55.69 | 55.69 |
| θgF2 | 0.5603 | 0.5603 | 0.5603 |
| βgF2 | 0.7073 | 0.7073 | 0.7073 |
| θhg2 | 0.4756 | 0.4756 | 0.4756 |
| βhg2 | 0.6917 | 0.6917 | 0.6917 |
| νd1 − νd2 | −39.19 | −32.47 | −32.47 |
| θgF1 − θgF2 | 0.0612 | 0.0518 | 0.0518 |
| θhg1 − θhg2 | 0.0922 | 0.0763 | 0.0763 |
| νd3 | *** | *** | *** |
| nd3 | *** | *** | *** |
| b3 | *** | *** | *** |
| θgF3 | *** | *** | *** |
| βgF3 | *** | *** | *** |
| θhg3 | *** | *** | *** |
| βhg3 | *** | *** | *** |
| νd4 | *** | *** | *** |
| θgF4 | *** | *** | *** |
| βgF4 | *** | *** | *** |
| θhg4 | *** | *** | *** |
| βhg4 | *** | *** | *** |
| νd3 − νd4 | *** | *** | *** |
| θgF3 − θgF4 | *** | *** | *** |
| θhg3 − θhg4 | *** | *** | *** |

Thus, it is possible to use such image forming optical system of the present invention in a photographic apparatus in which an image of an object is photographed by an electronic image pickup element such as a CCD and a CMOS, particularly a digital camera and a video camera, a personal computer, a telephone, and a portable terminal which are examples of an information processing unit, particularly a portable telephone which is easy to carry. Embodiments thereof will be exemplified below.

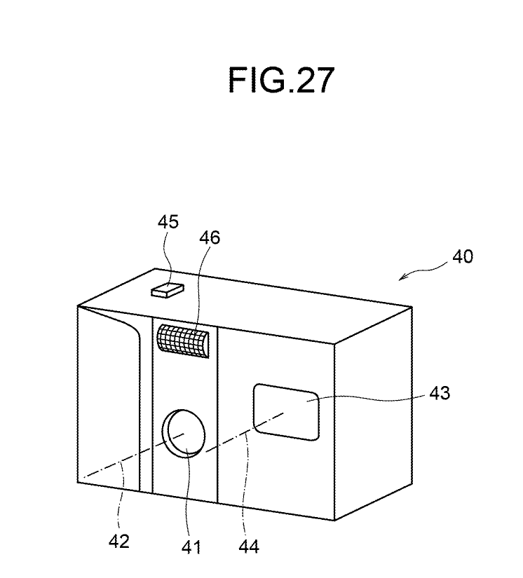

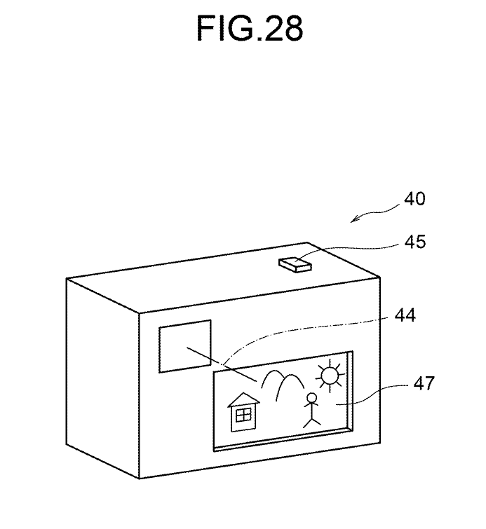

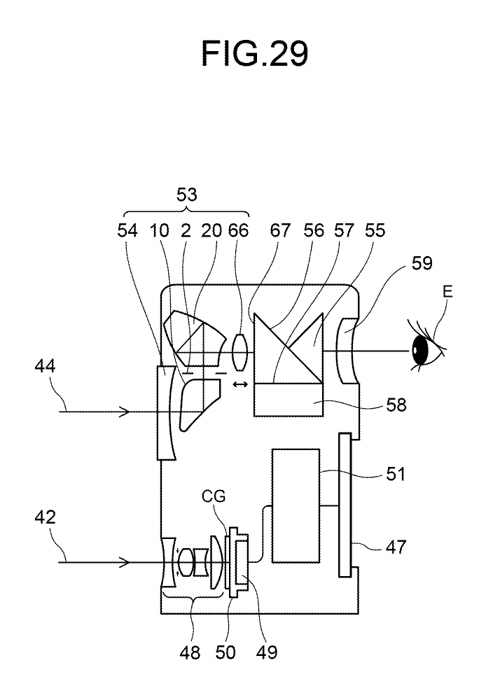

In FIG. 27 to FIG. 29 show conceptual diagrams of structures in which the image forming optical system according to the present invention is incorporated in a photographic optical system 41 of a digital camera. FIG. 27 is a frontward perspective view showing an appearance of a digital camera 40, FIG. 28 is a rearward perspective view of the same, and FIG. 29 is a cross-sectional view showing an optical arrangement of the digital camera 40.

The digital camera 40, in a case of this example, includes the photographic optical system 41 (an objective optical system for photography 48) having an optical path for photography 42, a finder optical system 43 having an optical path for finder 44, a shutter 45, a flash 46, and a liquid-crystal display monitor 47. Moreover, when the shutter 45 disposed at an upper portion of the camera 40 is pressed, in conjugation with this, a photograph is taken through the photographic optical system 41 (objective optical system for photography 48) such as the zoom lens in the first embodiment.

An object image formed by the photographic optical system 41 (photographic objective optical system 48) is formed on an image pickup surface 50 of a CCD 49. The object image photo received at the CCD 49 is displayed on the liquid-crystal display monitor 47 which is provided on a camera rear surface as an electronic image, via an image processing means 51. Moreover, a memory etc. is disposed in the image processing means 51, and it is possible to record the electronic image photographed. This memory may be provided separately from the image processing means 51, or may be formed by carrying out by writing by recording (recorded writing) electronically by a floppy (registered trademark) disc, memory card, or an MO etc.

Furthermore, an objective optical system for finder 53 is disposed in the optical path for finder 44. This objective optical system for finder 53 includes a cover lens 54, a first prism 10, an aperture stop 2, a second prism 20, and a lens for focusing 66. An object image is formed on an image forming surface 67 by this objective optical system for finder 53. This object image is formed in a field frame of a Porro prism which is an image erecting member equipped with a first reflecting surface 56 and a second reflecting surface 58. On a rear side of this Porro prism, an eyepiece optical system 59 which guides an image formed as an erected normal image is disposed.

In the digital camera 40 having the above-described configuration, an electronic image pickup apparatus equipped with a small and slim zoom lens having a decreased number of lenses in the image pickup optical system 41 is embodied. The present invention can be applied not only to digital cameras having a collapsible lens as described above but also digital cameras having a folded optical system.

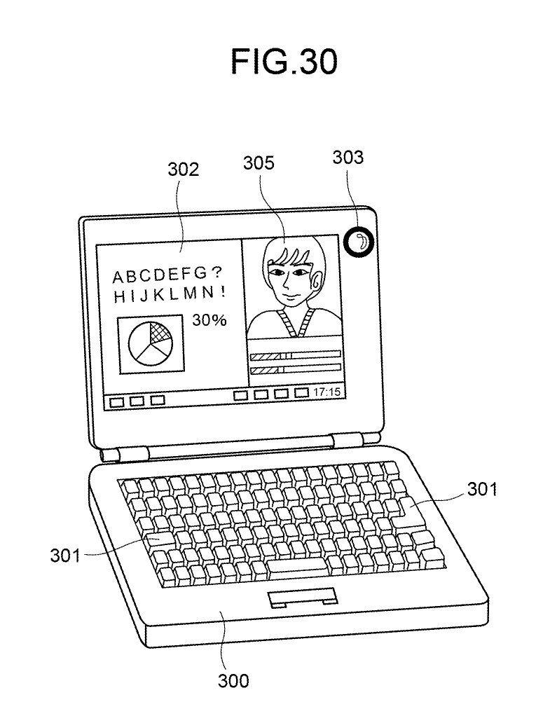

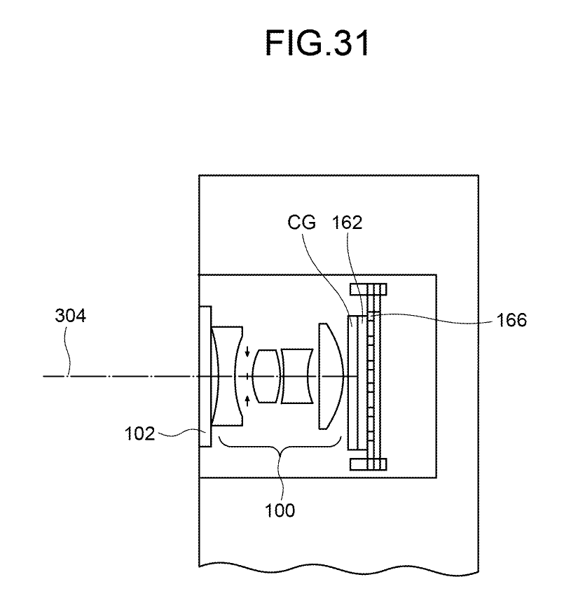

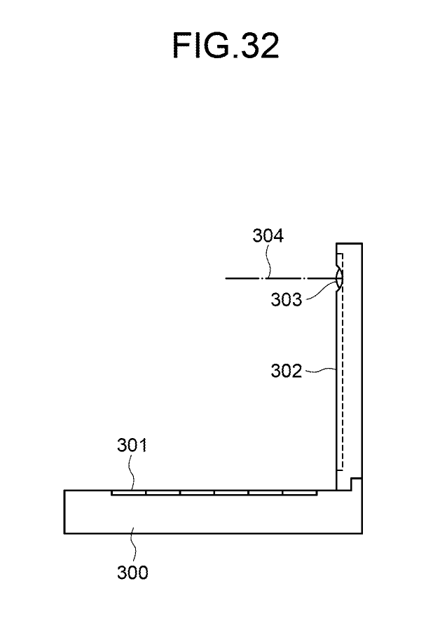

Next, a personal computer which is an example of an information processing apparatus with a built-in image forming system as an objective optical system is shown in FIG. 30 to FIG. 32. FIG. 30 is a frontward perspective view of a personal computer 300 with its cover opened, FIG. 31 is a cross-sectional view of a photographic optical system 303 of the personal computer 300, and FIG. 32 is a side view of FIG. 30. As it is shown in FIG. 80 to FIG. 82, the personal computer 300 has a keyboard 301, an information processing means and a recording means, a monitor 302, and a photographic optical system 303.

Here, the keyboard 301 is for an operator to input information from an outside. The information processing means and the recording means are omitted in the diagram. The monitor 302 is for displaying the information to the operator. The photographic optical system 303 is for photographing an image of the operator or a surrounding. The monitor 302 may be a display such as a liquid-crystal display or a CRT display. As the liquid-crystal display, a transmission liquid-crystal display device which illuminates from a rear surface by a backlight not shown in the diagram, and a reflection liquid-crystal display device which displays by reflecting light from a front surface are available. Moreover, in the diagram, the photographic optical system 303 is built-in at a right side of the monitor 302, but without restricting to this location, the photographic optical system 303 may be anywhere around the monitor 302 and the keyboard 301.

This photographic optical system 303 has an objective optical system 100 which includes the zoom lens in the first embodiment for example, and an electronic image pickup element chip 162 which receives an image. These are built into the personal computer 300.

At a front end of a mirror frame, a cover glass 102 for protecting the objective optical system 100 is disposed.

An object image received at the electronic image pickup element chip 162 is input to a processing means of the personal computer 300 via a terminal 166. Further, the object image is displayed as an electronic image on the monitor 302. In FIG. 30, an image 305 photographed by the user is displayed as an example of the electronic image. Moreover, it is also possible to display the image 305 on a personal computer of a communication counterpart from a remote location via a processing means. For transmitting the image to the remote location, the Internet and telephone are used.

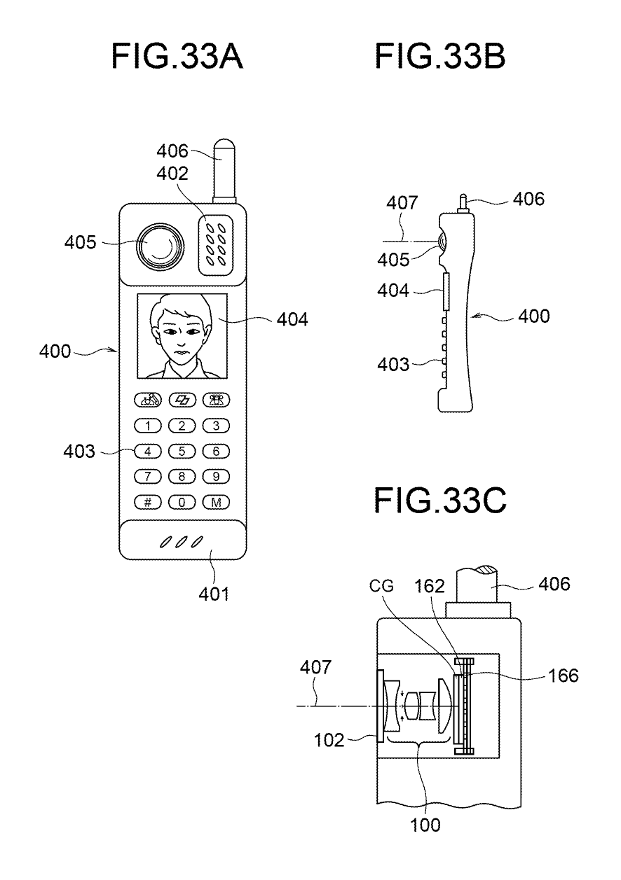

Next, a telephone which is an example of an information processing apparatus in which the image forming optical system of the present invention is built-in as a photographic optical system, particularly a portable telephone which is easy to carry is shown in FIG. 33A, FIG. 33B, and FIG. 33C. FIG. 33A is a front view of a portable telephone 400, FIG. 33B is a side view of the portable telephone 400, and FIG. 33C is a cross-sectional view of a photographic optical system 405. As shown in FIG. 83A to FIG. 83C, the portable telephone 400 includes a microphone section 401, a speaker section 402, an input dial 403, a monitor 404, the photographic optical system 405, an antenna 406, and a processing means.

Here, the microphone section 401 is for inputting a voice of the operator as information. The speaker section 402 is for outputting a voice of the communication counterpart. The input dial 403 is for the operator to input information. The monitor 404 is for displaying a photographic image of the operator himself and the communication counterpart, and information such as a telephone number. The antenna 406 is for carrying out a transmission and a reception of communication electric waves. The processing means (not shown in the diagram) is for carrying out processing of image information, communication information, and input signal etc.

Here, the monitor 404 is a liquid-crystal display device. Moreover, in the diagram, a position of disposing each structural element is not restricted in particular to a position in the diagram. This photographic optical system 405 has an objective optical system 100 which is disposed in a photographic optical path 407 and an image pickup element chip 162 which receives an object image. As the objective optical system 100, the zoom lens in the first embodiment for example, is used. These are built into the portable telephone 400.

At a front end of a mirror frame, a cover glass 102 for protecting the objective optical system 100 is disposed.

An object image received at the electronic image pickup element chip 162 is input to an image processing means which is not shown in the diagram, via a terminal 166. Further, the object image finally displayed as an electronic image on the monitor 404 or a monitor of the communication counterpart, or both. Moreover, a signal processing function is included in the processing means. In a case of transmitting an image to the communication counterpart, according to this function, information of the object image received at the electronic image pickup element chip 162 is converted to a signal which can be transmitted.

Various modifications can be made to the present invention without departing from its essence.

1. An image forming optical system comprising:
a positive lens group;
a negative lens group; and
an aperture stop, wherein
the positive lens group is disposed closer to the object side than the aperture stop, and
the value of θgF1, the value of nd1, and the value of νd1 of at least one lens LA included in the positive lens group fall within the following three ranges: the range in an orthogonal coordinate system having a horizontal axis representing νd1 and a vertical axis representing θgF1 that is bounded by the straight line given by the equation θgF1=α1×νd1+βgF1 (where α1=−0.00566) into which the lowest value in the range defined by the following conditional expression (1-1) is substituted and the straight line given by the equation θgF1=α1×νd1+βgF1 (where α1=−0.00566) into which the highest value in the range defined by the following conditional expression (1-1) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (1-2) is substituted and the straight line given by the equation nd1=a1×νd1+b1 (where a1=−0.0267) into which the highest value in the range defined by the following conditional expression (1-2) is substituted; and the range defined by the following conditional expression (1-3):
0.6520<βgF1<0.7620 (1-1),
2.0<b1<2.4 (where nd1>1.3) (1-2),
10<νd1<35 (1-3),
where θgF1 is the relative partial dispersion (ng1−nF1)/(nF1−nC1) of the lens LA, and νd1 is the Abbe constant (nd1−1)/(nF1−nC1) of the lens LA, where nd1, nC1, nF1, and ng1 are refractive indices of the lens LA for the d-line, C-line, F-line, and g-line respectively.

2. The image forming optical system according to claim 1, wherein the value of θhg1, the value of nd1, and the value of νd1 of the lens LA fall within the following three ranges: the range in an orthogonal coordinate system, which is different from the aforementioned orthogonal coordinate system, having a horizontal axis representing νd1 and a vertical axis representing θhg1 that is bounded by the straight line given by the equation θhg1=αhg1×νd1+βhg1 (where αhg1=−0.00834) into which the lowest value in the range defined by the following conditional expression (1-4) is substituted and the straight line given by the equation θhg1=αhg1×νd1+βhg1 (where αhg1=−0.00834) into which the highest value in the range defined by the following conditional expression (1-4) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (1-2) is substituted and the straight line given by the equation nd1=a1×νd1+b1 (where a1=−0.0267) into which the highest value in the range defined by the following conditional expression (1-2) is substituted; and the range defined by the following conditional expression (1-3):
0.6000<βhg1<0.7800 (1-4),
2.0<b1<2.4 (where nd1>1.3) (1-2),
10<νd1<35 (1-3),
where θhg1 is the relative partial dispersion (nh1−ng1)/(nF1−nC1) of the lens LA, and nh1 is the refractive index of the lens LA for the h-line.

3. The image forming optical system according to claim 1, wherein the lens LA is a lens that makes up a cemented lens.

4. The image forming optical system according to claim 3, wherein a cemented side surface (cemented surface) of the lens LA is an aspheric surface.

5. The image forming optical system according to claim 1, wherein when a negative lens is defined to be a lens having a negative paraxial focal length, the lens LA is a negative lens, where a positive lens and a negative lens refer to a lens having a positive paraxial focal length and a lens having a negative paraxial focal length respectively.

6. The image forming optical system according to claim 5, wherein when a positive lens is defined to be a lens having a positive paraxial focal length, a lens LB to which the lens LA is cemented is a positive lens, and the following condition is satisfied:
νd1−νd2≦−10 (1-5),
where νd1 is the Abbe constant (nd1−1)/(nF1−nC1) of the lens LA, and νd2 is the Abbe constant (nd2−1)/(nF2−nC2) of the lens LB.

7. The image forming optical system according to claim 1, wherein the image forming optical system is a zoom lens consisting of four or five lens groups in total, and relative distances of the lens groups on the optical axis change during zooming.

8. The image forming optical system according to claim 7, wherein the negative lens group is disposed closer to the object side than the aperture stop, and the value of θgF3, the value of nd3, and the value of νd3 of at least one lens LC included in the negative lens group fall within the following three ranges: the range in an orthogonal coordinate system having a horizontal axis representing νd3 and a vertical axis representing θgF3 that is bounded by the straight line given by the equation θgF3=α3×νd3+βgF3 (where α3=−0.00566) into which the lowest value in the range defined by the following conditional expression (1-8) is substituted and the straight line given by the equation θgF3=α3×νd3+βgF3 (where α3=−0.00566) into which the highest value in the range defined by the following conditional expression (1-8) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (1-9) is substituted and the straight line given by the equation nd3=a3×νd3+b3 (where a3=−0.0267) into which the highest value in the range defined by the following conditional expression (1-9) is substituted; and the range defined by the following conditional expression (1-10):
0.6520<βgF3<0.7620 (1-8),
2.0<b3<2.4 (where nd3>1.3) (1-9),
10<νd3<35 (1-10),
where θgF3 is the relative partial dispersion (ng3−nF3)/(nF3−nC3) of the lens LC, and νd3 is the Abbe constant (nd3−1)/(nF3−nC3) of the lens LC, where nd3, nC3, nF3, and ng3 are refractive indices of the lens LC for the d-line, C-line, F-line, and g-line respectively.

9. The image forming optical system according to claim 8, wherein when a positive lens is defined to be a lens having a positive paraxial focal length, the lens LC is a positive lens.

10. An image forming optical system comprising:
a positive lens group;
a negative lens group; and
an aperture stop, wherein
the positive lens group is disposed closer to the object side than the aperture stop, and
the value of θgF1, the value of nd1, and the value of νd1 of at least one lens LA included in the positive lens group fall within the following three ranges: the range in an orthogonal coordinate system having a horizontal axis representing νd1 and a vertical axis representing θgF1 that is bounded by the straight line given by the equation θgF1=α1×νd1+βgF1 (where α1=−0.00264) into which the lowest value in the range defined by the following conditional expression (2-1) is substituted and the straight line given by the equation θgF1=α1×νd1+βgF1 (where α1=−0.00264) into which the highest value in the range defined by the following conditional expression (2-1) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (2-2) is substituted and the straight line given by the equation nd1=a1×νd1+b1 (where a1=−0.0267) into which the highest value in the range defined by the following conditional expression (2-2) is substituted; and the range defined by the following conditional expression (2-3):
0.6050<βgF1<0.7150 (2-1),
2.0<b1<2.4 (where nd1>1.3) (2-2),
10<νd1<28 (2-3),
where θgF1 is the relative partial dispersion (ng1−nF1)/(nF1−nC1) of the lens LA, and νd1 is the Abbe constant (nd1−1)/(nF1−nC1) of the lens LA, where nd1, nC1, nF1, and ng1 are refractive indices of the lens LA for the d-line, C-line, F-line, and g-line respectively.

11. The image forming optical system according to claim 1, wherein the value of θhg1, the value of nd1, and the value of νd1 of the lens LA fall within the following three ranges: the range in an orthogonal coordinate system, which is different from the aforementioned orthogonal coordinate system, having a horizontal axis representing νd1 and a vertical axis representing θhg1 that is bounded by the straight line given by the equation θhg1=αhg1×νd1+βhg1 (where αhg1=−0.00388) into which the lowest value in the range defined by the following conditional expression (2-4) is substituted and the straight line given by the equation θhg1=αhg1×νd1+βhg1 (where αhg1=−0.00388) into which the highest value in the range defined by the following conditional expression (2-4) is substituted; the range in an orthogonal coordinate system having a horizontal axis representing νd1 and a vertical axis representing nd1 that is bounded by the straight line given by the equation nd1=a1×νd1+b1 (where a1=−0.0267) into which the lowest value in the range defined by the following conditional expression (2-2) is substituted and the straight line given by the equation nd1=a1×νd1+b1 (where a1=−0.0267) into which the highest value in the range defined by the following conditional expression (2-2) is substituted; and the range defined by the following conditional expression (2-3):
0.5000<βhg1<0.6750 (2-4),
2.0<b1<2.4 (where nd1>1.3) (2-2),
10<νd1<28 (2-3),
where θhg1 is the relative partial dispersion (nh1−ng1)/(nF1−nC1) of the lens LA, and nh1 is the refractive index of the lens LA for the h-line.

12. The image forming optical system according to claim 1, wherein the lens LA is a lens that makes up a cemented lens.

13. The image forming optical system according to claim 12, wherein the cemented side surface (cemented surface) of the lens LA is an aspheric surface.

14. The image forming optical system according to claim 1, wherein when a negative lens is defined to be a lens having a negative paraxial focal length, the lens LA is a negative lens.

15. The image forming optical system according to claim 14, wherein when a positive lens is defined to be a lens having a positive paraxial focal length, a lens LB to which the lens LA is cemented is a positive lens, and the following conditional expression (2-5) is satisfied:
νd1−νd2≦−10 (2-5),
where νd1 is the Abbe constant (nd1−1)/(nF1−nC1) of the lens LA, and νd2 is the Abbe constant (nd2−1)/(nF2−nC2) of the lens LB.

16. The image forming optical system according to claim 10, wherein the image forming optical system is a zoom lens consisting of four or five lens groups in total, and relative distances of the lens groups on the optical axis change during zooming.

17. The image forming optical system according to claim 16, wherein the value of θgF3, the value of nd3, and the value of νd3 of at least one lens LC included in the negative lens group fall within the following three ranges: the range in an orthogonal coordinate system having a horizontal axis representing νd3 and a vertical axis representing θgF3 that is bounded by the straight line given by the equation θgF3=α3×νd3+βgF3 (where α3=−0.00264) into which the lowest value in the range defined by the following conditional expression (2-8) is substituted and the straight line given by the equation θgF3=α3×νd3+βgF3 (where α3=−0.00264) into which the highest value in the range defined by the following conditional expression (2-8) is substituted; the range in an orthogonal coordinate system having a horizontal axis representing νd3 and a vertical axis representing nd3 that is bounded by the straight line given by the equation nd3=a3×νd3+b3 (where a3=−0.0267) into which the lowest value in the range defined by the following conditional expression (2-9) is substituted and the straight line given by the equation nd3=a3×νd3+b3 (where a3=−0.0267) into which the highest value in the range defined by the following conditional expression (2-9) is substituted; and the range defined by the following conditional expression (2-10):
0.6050<βgF3<0.7150 (2-8),
2.0<b3<2.4 (where nd3>1.3) (2-9),
10<νd3<28 (2-10),
where θgF3 is the relative partial dispersion (ng3−nF3)/(nF3−nC3) of the lens LC, and νd3 is the Abbe constant (nd3−1)/(nF3−nC3) of the lens LC, where nd3, nC3, nF3, and ng3 are refractive indices of the lens LC for the d-line, C-line, F-line, and g-line respectively.

18. The image forming optical system according to claim 17, wherein when a positive lens is defined to be a lens having a positive paraxial focal length, the lens LC is a positive lens.

19. An image pickup apparatus comprising:
an image forming optical system according to claim 1;
an image pickup element; and
an image processing section that processes image data obtained by picking up an image formed through the image forming optical system by the electronic image pickup element and outputs image data in which the shape of the image is deformed, wherein
the image forming optical system is a zoom lens, and
the zoom lens satisfied the following conditional expression (3-1) in a state in which the zoom lens is focused on an object point at infinity:
0.7<y₀₇/(f_{W}·tan ω_{07w})<0.96 (3-1),
where y₀₇ is expressed by equation y₀₇=0.7y₁₀, y₁₀ being the distance from the center of an effective image pickup area (in which an image can be picked up) of the electronic image pickup element to the farthest point in the image pickup area (i.e. the maximum image height), ω_{07w} is the angle of the direction toward an object point corresponding to an image point formed at a position at distance y₀₇ from the center of the image pickup surface at the wide angle end with respect to the optical axis, and fw is the focal length of the entire image forming system at the wide angle end.
